(19) United States
(12) Patent Application Publication
(10) Pub. No.: US 2011/0295722 A1
(43) Pub. Date: Dec. 1, 2011

(54) Methods, Apparatus, and Systems for Enabling Feedback-Dependent Transactions

(76) Inventor: Richard R. Reisman, New York, NY (US)

(21) Appl. No.: 13/113,678

(22) Filed: May 23, 2011

Related U.S. Application Data
(60) Provisional application No. 61/353,143, filed on Jun. 9, 2010.

(51) Int. Cl. G06Q 30/00

(52) U.S. Cl. 705/27.1; 705/26.1

(57) ABSTRACT

Systems, apparatus, and methods for facilitating feedback-dependent transactions are provided. For example, feedback is collected on transactions involving particular buyers, with respect to the buyer, and then used to facilitate the process of pricing future transactions involving that buyer, selectively leading to further sales. In some embodiments, offers are made to buyers on behalf of sellers on the basis that the buyer may is permitted to set the price for the product/service after taking delivery of the item and then determining its actual value to the buyer. In such embodiments, the offer terms can optionally specify that the price setting will be tracked with respect to the buyer and reported through the computer network system, and specify that that information, with attribution to that buyer, can later be used by the seller (and/or other sellers) to determine whether to extend and fulfill other similar offers in the future.

### CROSS-REFERENCE

Applicant hereby claims priority under 35 USC §119 for U.S. provisional patent application Ser. No. 61/353,143 filed Jun. 9, 2010, entitled “METHOD AND APPARATUS FOR ENABLING FEEDBACK-DEPENDENT TRANSACTIONS.” The entire contents of the aforementioned application are herein expressly incorporated by reference.

### BACKGROUND

The present application is directed generally to computer network-based methods and architectures for enabling purchase/sale transactions and the like, and more particularly to non-fixed-price payment models.

Note that the points discussed below may reflect the hindsight gained from the disclosed inventions, and are not necessarily admitted to be prior art.

Recent developments in mass production and distribution, especially for products/services with near-zero marginal cost, have occurred with particular prominence to the media industry. Aggregators selling digital media products, such as songs, movies, TV programs, and electronic books include companies such as Apple, Amazon, and Netflix. Producers of digital media include companies such as News Corp, the New York Times, and Disney. Digital media products produced/sold by these and other companies in the media industry are available to consumers electronically, for example, in the form of websites, streaming media, and digital downloads, and in brick and mortar stores, for example, in the form of CDs and DVDs.

### SUMMARY

The present application discloses new computer-implemented methods and architectures for enabling sales or other exchanges of products or services. The method comprises collecting a report of a sale transaction between a consumer and a seller in which a sale price is not set at the time of the sale transaction. The sale price for the sale transaction is collected after the price is set, and the report of the sale price is entered into an electronic database. The information from the electronic database is used by a seller to subsequently decide whether to make a subsequent sale offer to the consumer. The subsequent sale offer is provided to the consumer based on the use of the information in the electronic database and results in a subsequent sale and delivery to the consumer. A subsequent sale price is entered in the electronic database.

### BRIEF DESCRIPTION OF THE DRAWINGS

Further aspects of the instant invention will be more readily appreciated upon review of the detailed description of the embodiments included below when taken in conjunction with the accompanying drawings, which show important sample embodiments of the invention and which are incorporated in the specification hereof by reference, wherein:

FIG. 1 is a block diagram which schematically shows a non-limiting exemplary network of computers linking consumers (buyers), sellers, and other market participants in one embodiment of the present invention;

FIG. 2A is a diagram and flow chart that illustrates a non-limiting exemplary set of interactions, data processing, and flows in one embodiment of the present invention;

FIG. 2B is a diagram and flow chart that illustrates a non-limiting exemplary set of interactions, data processing, and flows in another embodiment of the present invention;

FIG. 3 is a flow chart that illustrates a non-limiting exemplary process for collecting feedback and applying it to facilitate feedback-dependent transactions according to certain embodiments of the present invention;

FIG. 4 is a block diagram that illustrates non-limiting exemplary components of computing devices used to support buyers, sellers, and other systems involved in the marketplace activity according to certain embodiments of the present invention;

FIG. 5A is a flow chart that illustrates a non-limiting exemplary process illustrating selected details of an offer management process and related data processing according to certain embodiments of the present invention;

FIG. 5B is a sample user interface form that illustrates a non-limiting exemplary process illustrating selected details of an offer management process according to certain embodiments of the present invention;

FIG. 6A is a flow chart that illustrates a non-limiting exemplary process illustrating selected details of a price-setting request process and related data processing according to certain embodiments of the present invention.

FIG. 6B is a sample user interface form that illustrates a non-limiting exemplary process illustrating selected details of a price-setting request process according to certain embodiments of the present invention.

FIG. 7 is a flow chart that illustrates a non-limiting exemplary process illustrating selected details of a price data collection process and related data processing according to certain embodiments of the present invention.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

### DEFINITIONS

As used herein, the terms “product” and “service” (or “product/service”) are meant to be understood broadly as including any product or service, unless otherwise indicated or clear in context. Either of those terms may be used alone, interchangeably, and are meant to include the other, unless otherwise indicated or clear in context. The term “item” is also used herein to include both products and services. Those terms are also meant to include broad concepts of products and services, such as those identified as experiences or transformations of a buyer as facilitated by a seller.

As used herein, references to parties to a transaction and/or in support of transactions are meant to refer to respective system elements and the interaction roles they take on, working as agents and/or facilitators under user-specified rules and potentially subject to user review, which cooperate and interact in a computer-facilitated marketplace context, unless otherwise indicated or clear in context. For example, references to “sellers” generally refer to seller systems, as they embody a seller role in a system, and references to “buyers” generally refer to buyer systems as they embody the counter-party role of buyer. It should be understood that such system elements can be highly or entirely automated, operating under defined rules and/or algorithms, and with respect to system databases and other data sources, but can also have interfaces for human intervention, direction, and/or control, in degrees that can vary depending on the embodiment and the role. For ease of exposition, references to roles and system elements may simply be referred to as “buyers” and/or “sellers” and/or the like, without meaning, unless otherwise indicated or clear from context, to refer specifically to the humans who may be participants in such system elements, and on whose behalf such system elements may operate. Similarly, for simplicity, “his” (and/or similar) may be used in such contexts as possessive adjective (and/or similar personalization), with the understanding that it does not refer to a person as opposed to a machine, but should be understood as synonymous to “its” as possessive adjective (and/or similar), generally relating to a system operating as agent/facilitator on behalf of a role.

As used herein, references to “buyers” and “consumers,” are meant to be interchangeable, as are references to “sellers,” “merchants,” “vendors,” and “producers,” and these terms are meant to include both business-to-consumer markets (B2C), and business-to-business (B2B) markets, unless otherwise indicated or clear in context. It should be understood that, in various embodiments, seller roles can also be on behalf of individuals, and/or buyer roles can be on behalf of businesses, and/or further that a single entity can at times be a buyer with regard to some transactions and seller with regard to other transactions. The term “user” or “buyer/user,” in the context of the user of a product or service, is also meant to be synonymous with any buyer, unless otherwise indicated or clear in context, and in such contexts again should be understood as a reference to a role that can be embodied by a system element working on behalf of a human user. The term “user” is also used, in the context of user interfaces, to refer to any human interfacing with any of the system elements in support of a role. Unless otherwise indicated or clear in context, the term “seller” is meant to refer to any and all entities that may cooperate on the seller side of a transaction, including any third-party information services or other support services or agents. With respect to B2B markets, it should be understood that “buyer,” “consumer” and/or “user” are meant to apply to the individual user and/or the buyer business entity of whatever kind, as a collective “buyer”/“user,” as may be appropriate to the context. Where the details of embodiments that can particularly serve such collective buyers are not specifically addressed, it should be understood that suitable variations/enhancements to the methods described are intended to be appropriately applied.

As referred to herein, “markets” can include any mixture of individual and business entities and their support systems, as taking the roles of buyers/consumers or sellers/producers and/or supporting services. The global market might include all such entities, and particular marketplaces might also include all such kinds of entities on both buy and sell sides of transactions. These entities are further meant to be unrestricted in that they might include governmental entities, non-profits, or any other marketplace/marketspace participant. Again, these entities should generally be understood as being comprised by system elements that take on respective interacting roles in a marketplace context applying the processes as described herein.

As used herein, the term “FairPay” (and its abbreviation, “FP”) is meant as a term of convenience to refer inclusively to all embodiments, and unless otherwise indicated or clear in context, is not meant to require any particular concept of fairness, or to even require that fairness be a criterion at all. It is to be understood that prices are set using various embodiments of the methods described, and fairness may or may not be a relevant descriptor of the intent or effect of those methods in a given embodiment and usage context. Similarly, when used in combined forms, such as “FairPay reputation” or “FairPay transaction,” this is for convenience of exposition, and similar breadth of meaning is to be understood. The present application describes a number of ideas which are applicable to indeterminate-value architectures and/or participative pricing systems and/or dynamic pricing systems and/or feedback-dependent transactions and/or the like generally, and many of these ideas are not limited to fair-pay or “FairPay” or “pay what you want” systems. Accordingly, the term “FP” can generally be interpreted herein to refer to indeterminate-value architectures and/or participative pricing systems and/or dynamic pricing systems and/or feedback-dependent transactions and/or the like and/or hybrids thereof generally.

Similarly, as used herein, “fairness” is meant as a term of convenience to be inclusive of all criteria that might be useful in determining whether to make a sale offer according to the methods described, being illustrative of a range of criteria or aspects that characterize a buyer's pricing, payment, and/or fairness history, and unless otherwise indicated or clear in context, is meant to be understood broadly as including any characteristic that a seller might find relevant to deciding whether to extend an offer for sale. Such criteria might include predictability, satisfiability, dependability, honesty, need, and/or any other characteristic desired to be used in determining whether to make an offer.

The terms “pay” and “payment” and related forms, as used herein may refer to either or both of the setting of prices (in the sense of how well a buyer pays) and the transfer of funds (in the sense of effecting a payment), unless otherwise indicated or clear in context. These terms are meant to also to be inclusive of any suitable form of value transfer in exchange for a product or service, including credits/debits in any currency or any other form, virtual currency, barter/exchange of goods and/or services, perks/rewards/points/badges, and/or the like.

Introduction

Aspects of the present invention may be described, in various embodiments, as a system and method for facilitating feedback-dependent computer-mediated transactions. As described below, feedback is collected by systems on transactions involving particular buyers, with respect to the buyer and the item, and used by systems to facilitate the process of pricing future transactions involving that buyer and/or that item and/or similar items, selectively leading to further sales involving that buyer and/or that item and/or similar items. In various embodiments, offers are made to buyers on behalf of sellers on the basis that the buyer can set the price for the product/service, and in some embodiments price-setting can be done after taking delivery of the item and then determining its actual value to the buyer. In such embodiments, the offer terms can specify that the price setting will be tracked with respect to the buyer and reported through the computer network system, and specify that this information, with attribution to that buyer, can later be used by the seller system (and/or other sellers) to determine whether to extend other similar offers in the future.

In various embodiments, a system of a prospective seller considering an offer to a prospective buyer can use the feedback information collected on prior sales to characterize the buyer's pricing history, and use that data-based characterization as at least one factor when deciding whether to extend new sale offers to that buyer. In some embodiments, such a characterization of pricing history can include an algorithmic, data-based characterization in regard to what might be considered the fairness of the prices set by the buyer, in any or all relevant aspects. Alternative embodiments can use different or supplementary algorithmic data-based characterizations, including, but not limited to, predictability, satisfiability, dependability, honesty, need, or any other characteristic of the buyer desired to be used in determining whether to make an offer. Some embodiments can use statistically-based characterizations that can be fully automated, while other embodiments can draw on descriptive information, whether analyzed and characterized entirely by machine or with some human input, as a supplement and/or replacement for purely quantitative statistical methods.

Correspondingly, in some embodiments, a prospective buyer might understand that the level at which he sets a price in a given transaction might affect what offers may be extended to him in the future, and embodiments can optionally be designed to develop and/or exploit that understanding. For example, to the extent that his pricing is characterized by a seller as being fair, similar offers might be extended in the future, and to the extent it is characterized as not fair, few, if any, similar offers might be extended.

In one embodiment, knowledge of the buyer's history of pricing in various transactions, as derived from pricing history databases, can effectively serve as a reputation of the buyer, and in particular, a reputation for fairness in pricing behavior. Thus, for expository convenience, these methods are often referred to herein as “FairPay” or “FP.” As noted above, unless otherwise indicated or clear in context, references herein to FairPay or FP are meant to be inclusive of embodiments based on feedback criteria other than fairness, as well.

Some embodiments might be broadly discussed as including two features. One is that the buyer side role can be provided with an option to set the price, and can optionally be permitted to do so at its sole discretion. The other is that the seller side role can be provided with an option to manage the offers, including the decision whether to continue to make them, and can optionally be permitted to do so at its sole discretion. These two features can thus be built into the respective buyer and seller FP support components and/or processes to provide distinct and complementary controls to each of the two players via respective components and/or services. These controls can operate at different time segments in the ongoing cycles of transactions, but feed into one another in an adaptive cycle of dialog between buyer and seller regarding the ongoing cycles of value exchange. In such a case, each party has a different means of control, but each depends on and balances the other in the context of the FP system to maintain a virtuous cycle. The FP system-facilitated process will thus tend to converge on an ongoing fair exchange of value that adapts as conditions change. Some embodiments of this type can make these two means of control exclusive to each of the two players. Other embodiments of FP system facilitation that put limits on the discretion of buyer or seller in each of these decisions can also be useful, depending on circumstances and objectives. As to timing, some embodiments of this type can optionally also vary as to whether a price is set at the initiation of a purchase/use action, or at some time after a purchase is effected, possibly after a period of use.

As more fully described below, some of the many advantages of such embodiments over traditional PWYW (Pay What You Want) and other pricing schemes are that the buyer side is given additional motivation to price fairly to compensate the seller, and the seller side (and/or other seller participants sharing in the FP processes and systems) can determine when and whether to make any additional offers to that buyer based on specific feedback information relevant to that buyer's reputation through FP system facilitation.

It is noted that this disclosure describes the computer system elements and associated databases and the associated data processing and decision analyses that embody this computer-mediated marketplace, working under specifications and optional oversight provided by users via computer user interfaces. At the same time, the FP feedback systems and the buyer-seller roles embodied in these computer systems are in many respects radical departures from conventional market roles, both as to the features/functionality facilitated by the system and provided to the respective buyer-seller roles, and as to the addition of pricing history feedback data (and in other respects as disclosed herein).

Figures

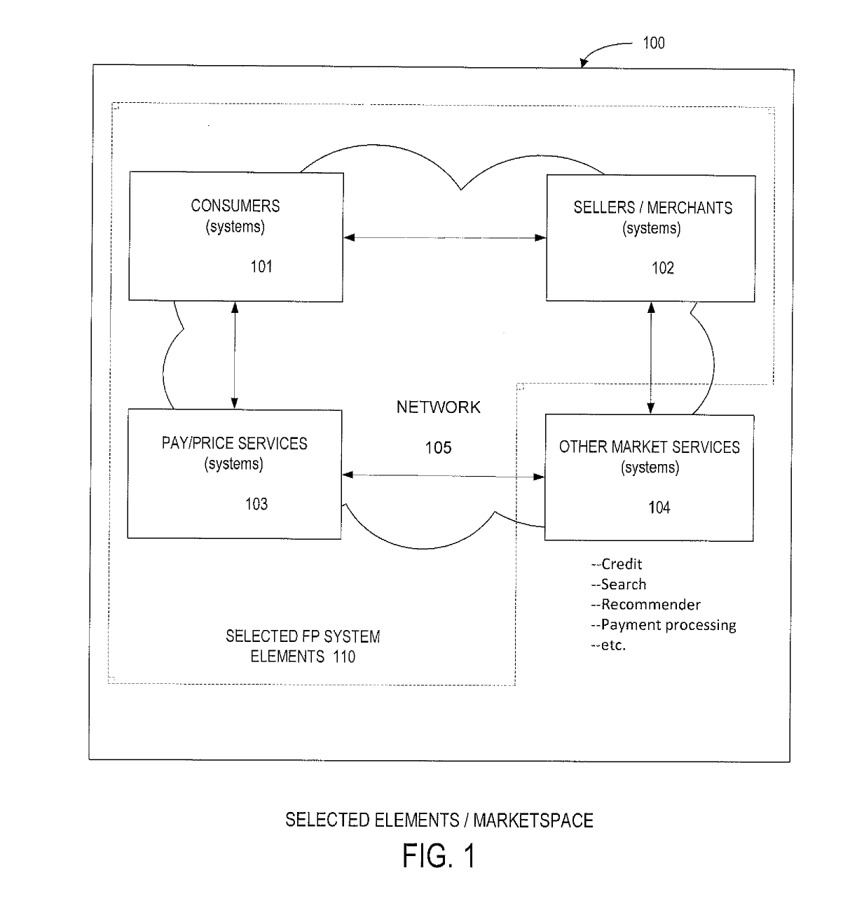

Referring now to FIGS. 1-7, wherein similar components are referenced in like manner, various features for methods, systems and apparatuses for facilitating feedback-dependent transactions are disclosed.

Turning now to FIG. 1, there is depicted an exemplary view of selected marketspace component systems, linked by the Internet or other network(s). Consumers 101 (or Buyers) interact with Sellers/Merchants/Merchandising 102 (or Producers). These systems both interact with the systems of Pay/Pricing Services 103, and with Other Market Services 104, which include an unlimited range of current and future services, which can optionally be seller-affiliated or controlled by independent third-parties, including Credit Reporting and Rating Services, Payment Processing Services, Search Services, Recommender Services, and/or the like. Consumer systems 101 can optionally at times interact directly with Pay/Price Services 103 and Other Market Services 104, but these interactions can be through and mediated by the Sellers/Merchants 102. Selected FP System Elements 110 highlight an exemplary grouping of the systems that can optionally cooperate to facilitate FP transactions in some embodiments, but it is noted that other embodiments can optionally include more or fewer of such elements. Network 105 can optionally include the Internet, and can optionally link all system elements, but alternatives can involve other networks or combinations of networks, including combinations of public and private networks, to provide useful connectivity in varied environments. Rich embodiments can optionally apply across multiple tiers/levels of buyers and sellers comprising a value chain. For example, this can optionally include consumer-facing retailers, intermediary distributors/aggregators, aggregators of compound products/services (including mashups), and/or authors/artists or other content creators, as well as rights clearing services (such as for example Copyright Clearing Clearance Center, BMI, ASCAP, and the like). In the discussion that follows, it should be understood that various embodiments can optionally include any combination of Seller/Merchant and Other Market Services, whether under common management or as cooperating entities in a commerce ecosystem, using any combination of distinct or integrated computer and database services. Non-limiting examples of combinations that can optionally be employed include various forms of syndication and/or co-branding, as well as less visible forms of combination.

As noted earlier, these role-descriptor terms (such as Consumer/Buyer and Seller/Merchant/Merchandising and the like) just above, and throughout, should be understood to generally refer to the systems elements that take on and perform these respective market roles and interactions in the context of FP-based transactions. It is to be understood that these interactions are facilitated by various FP system modules and/or components and, as described in greater detail below, can be implemented via a variety of networked implementations.

In some embodiments, as described below, Seller/Merchant/Merchandising and Other Market Services systems can optionally be highly or entirely automated, operating under defined rules and/or algorithms and in communication to the buyer system and other systems, but can optionally also have interfaces for seller-side human intervention, direction, and/or control, in degrees that can optionally vary depending on the embodiment and the role. Advanced levels of automation are contemplated as useful to be included in some embodiments not only for operational efficiency, but also to facilitate effective application of advanced and intensive data access and processing and decision/analytical methods to optimize FP pricing analysis and other processes based on a wide range of timely data and algorithmic/rule-based multifactor analysis/decision methods, and with real-time dynamic customization to the current buyer-seller-product/service and shopping context and history, in the many ways described herein, that would not be feasible in manually-enabled transactions.

Similarly, Consumer/Buyer systems can optionally also be highly or entirely automated, algorithmic and rule-based, again with the possible option of interfaces for buyer-side human intervention, direction and/or control. In embodiments with advanced computer automation, the marketplace might be understood as being implemented by interacting smart agents or bots that include advanced support for the relevant FP processes and data analysis/decision methods described herein. Again, such automation is contemplated as useful to be included in some embodiments not only for operational efficiency, but also to facilitate effective application of advanced and intensive data access and processing and decision/analytical methods to optimize FP pricing analysis and other processes based on a wide range of timely data and algorithmic/rule-based multifactor analysis/decision methods, and with real-time dynamic customization to the current buyer-seller-product/service and shopping context and history, in the many ways described herein, that would not be feasible in manually-enabled transactions.

In other embodiments, some of these roles can optionally have lower degrees of automated support, especially in the case of consumer roles which can optionally rely in part on automated support for FP processes that is provided by sellers/merchants (or other service providers), such as to provide interface services on behalf of the consumer. For example, as described further below, consumers can optionally use personal computers or equivalent devices that interact with seller systems, and such consumer systems can optionally rely on the seller systems to provide much or even all of the significant functionality of the FP processes.

Note that these methods can be used in electronic marketplaces, and selected components can use computer-based methods for collecting, analyzing, and using data, but these methods can be applied to brick and mortar shopping environments as well, relying on computers and databases to facilitate the offer/sale/payment process. In such embodiments, consumer users can optionally use mobile devices to interact with seller systems, or can optionally rely on seller systems providing consumer system support services, whether by interacting directly, such as through kiosks, or indirectly, with the intermediation of human sales representatives or other facilitators.

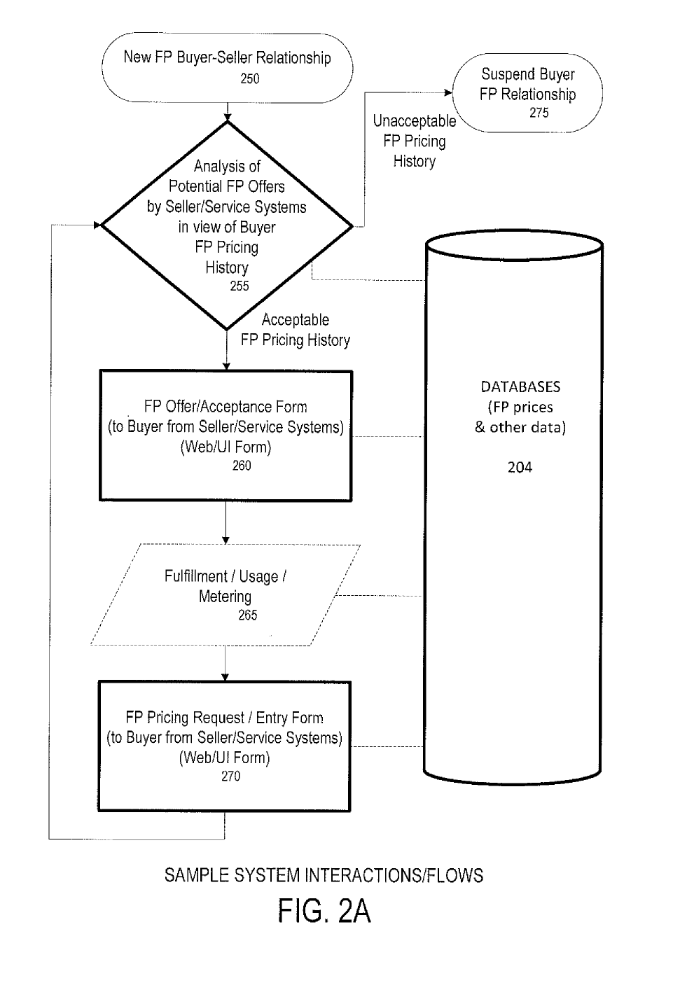

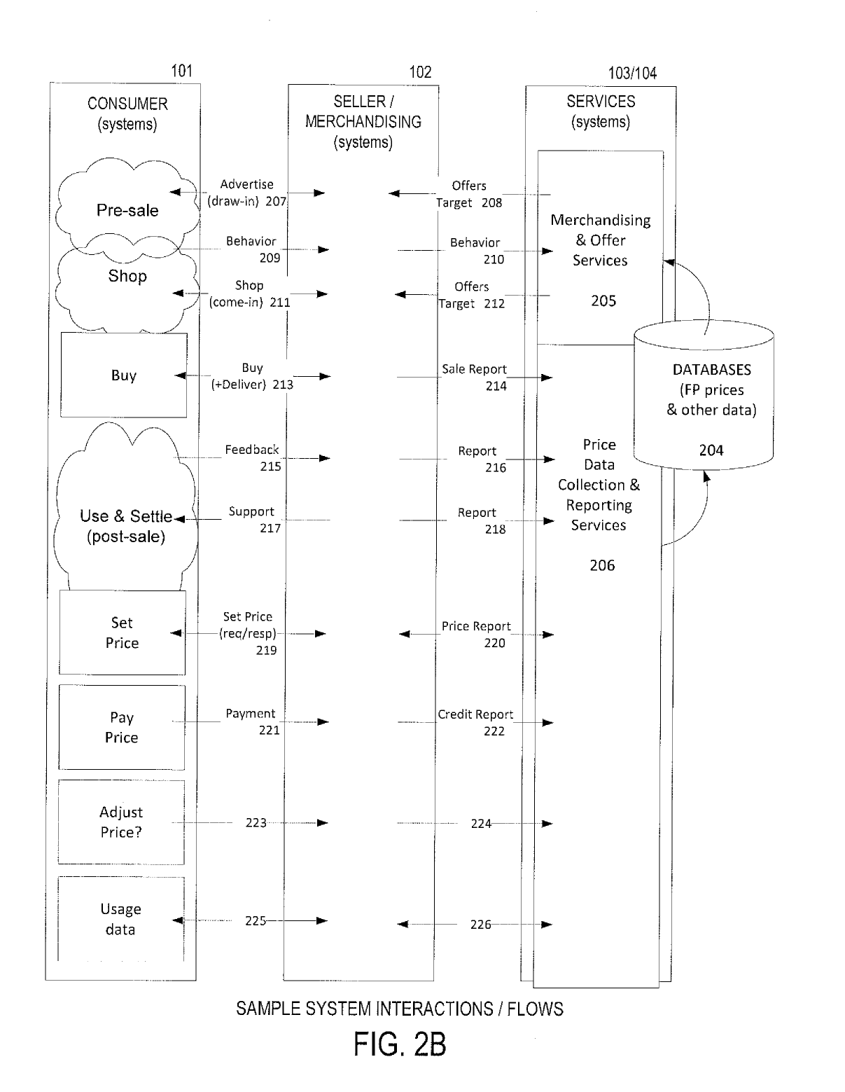

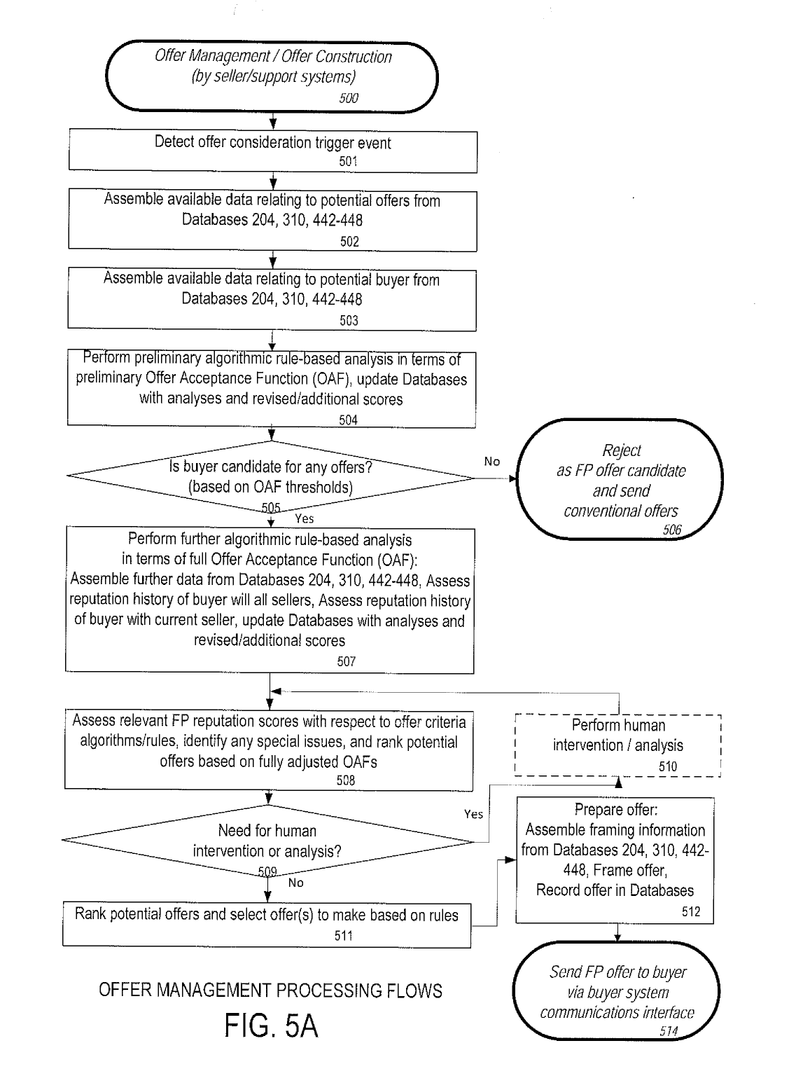

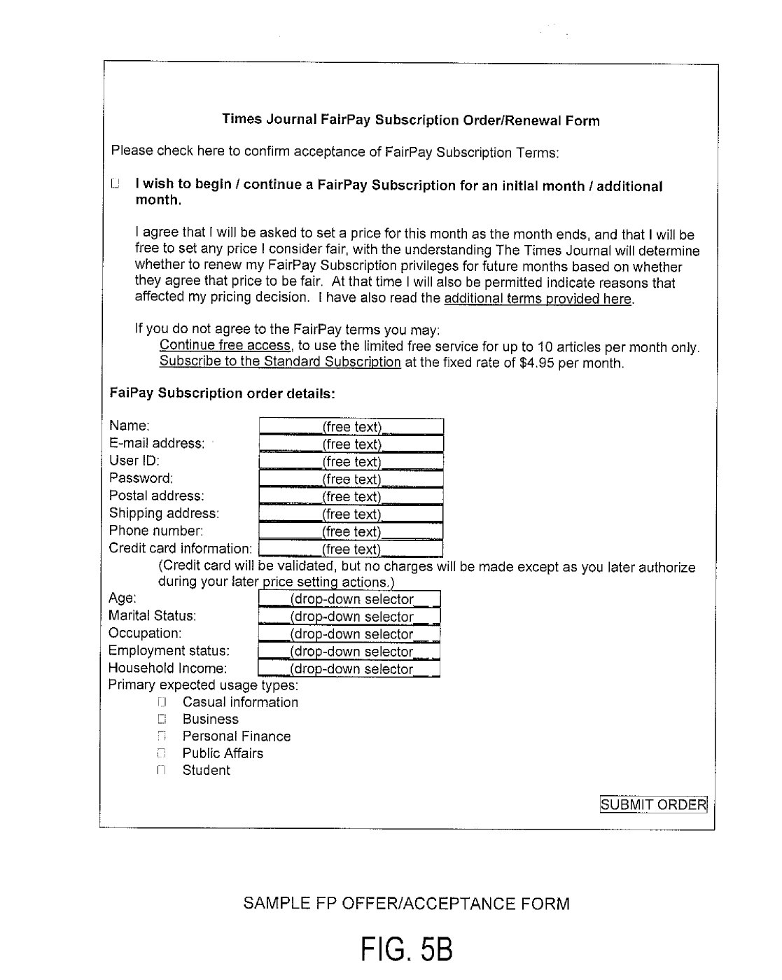

Turning now to FIG. 2A, there is depicted an exemplary view of interactions and market and data flows, and associated data processing and decision analyses, among the participant roles and systems as effected by the FP system processes in some embodiments. As shown, there may be a new buyer-seller relationship 250 for FP transactions. An algorithmic and/or rule-based analysis 255 of potential FP offers can be performed by the seller/service systems, made in view of available data on buyer FP pricing history and/or other factors from databases 204 and/or other sources. See FIG. 5A for additional details. If the buyer FP pricing history is determined to be acceptable, a corresponding offer is extended by transmission of an offer extension and acceptance form 260 to the consumer system. This can optionally be a Web form, or some other equivalent UI format, or in advanced embodiments can optionally be a program-to-program request. See FIG. 5B for additional details. The offer is accepted by the consumer system (as noted, this can optionally allow for human intervention, or can optionally be entirely automated in some embodiments), and the acceptance form transmitted back to the seller system for processing and recording, including recording of tracking data in databases 204. Various fulfillment, usage, and metering activities 265 follow, again with tracking in databases 204.

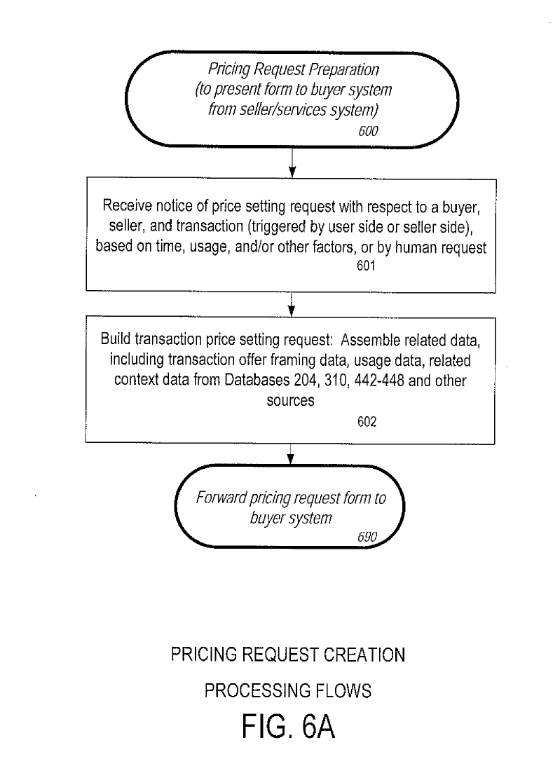

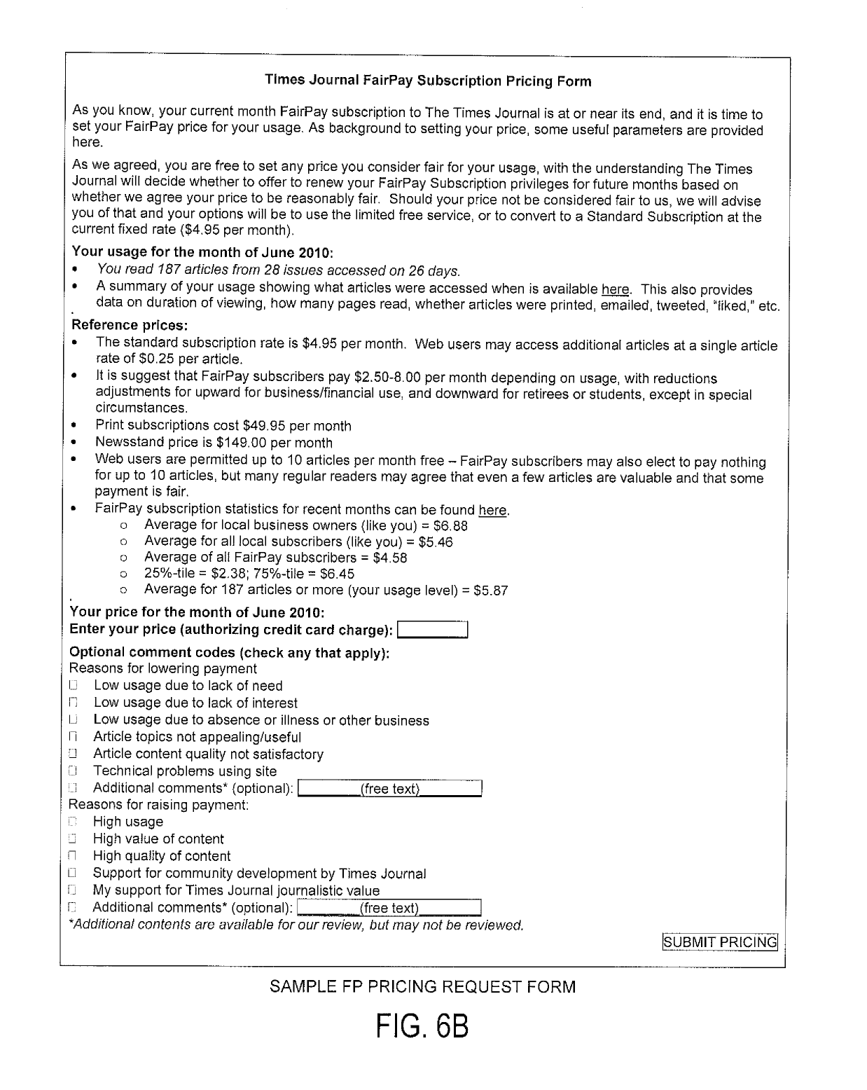

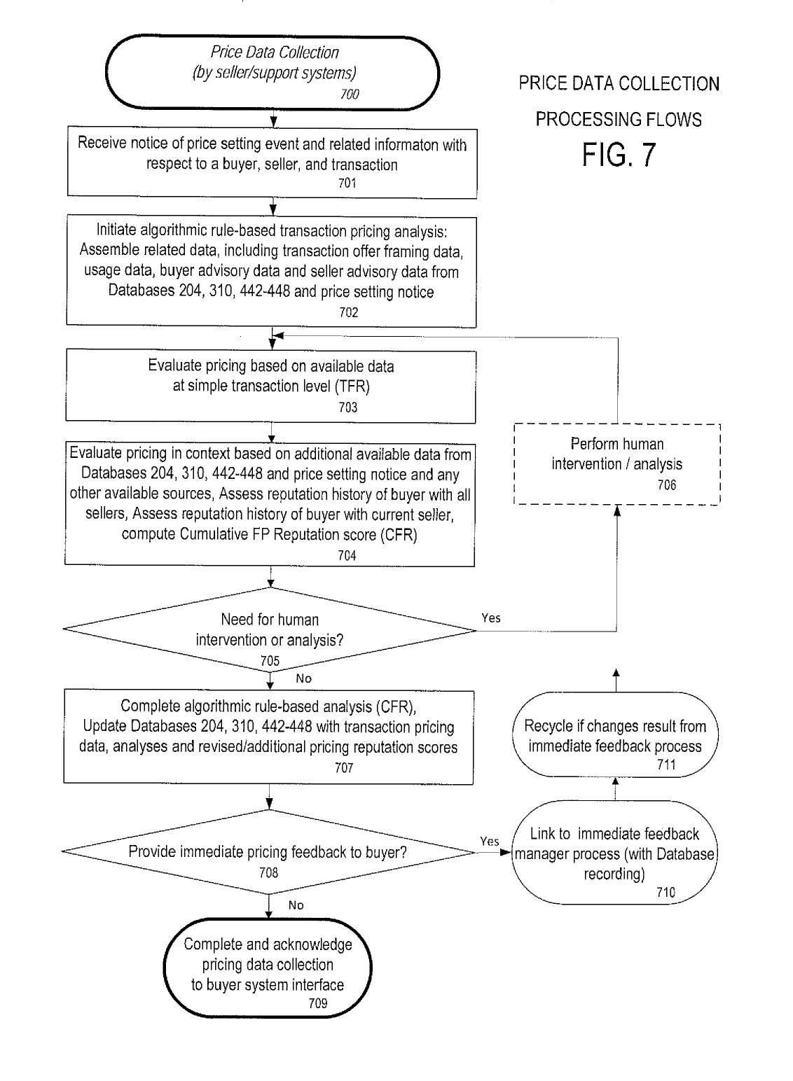

Following an initial period of use intended to be sufficient to permit an assessment (e.g., a day, a week, or a month, or more or less, possibly depending on the product/service and context) an FP pricing request/entry form is triggered to be presented to the buyer system 270. This can optionally be triggered by the buyer or seller systems, based on time, usage, user input, and/or other factors, and provide relevant information from databases 204 and/or other sources to facilitate price-setting by the consumer system. Again this can optionally be a Web form, a program-to-program request, and/or the like. (Further detail on these data processing and decision analyses is provided in FIGS. 6A and 6B.) The price and related data is transmitted back to the seller/service systems for processing and tracking in databases 204. Feedback can optionally be provided to close the cycle, returning to an algorithmic and/or rule-based analysis 255 to determine whether and on what basis the FP relationship will continue. The details of the analysis can optionally vary and become richer as such feedback accumulates. (Further detail on these data processing and decision analyses is provided in FIG. 7.) On each cycle, including the first, the FP relationship can optionally be suspended for a given buyer 275 based on rules for determining when prior pricing behavior is unacceptable, whether for a single seller, or across multiple sellers. Note that this figure, as depicted, does not differentiate services that can optionally be divided among multiple seller-side and support entities, and depending on embodiment, those entities can optionally be within a seller or external to the seller.

Turning now to FIG. 2B, there is depicted another non-limiting exemplary view of typical interactions and market and data flows among the participant roles and systems as effected by the FP system processes in some embodiments. The components/roles from FIG. 1 are shown as columns, Consumer 101, Seller/Merchants/Merchandising 102, and a combined column for Pay/Pricing Services and Other Market Services 103/104. The Services are shown to include both Merchandising and Offer Services 205, and Price Data Collection and Reporting Services 206, both of which are supported by one or more Databases 204. This figure, as depicted, does not differentiate services that can optionally be divided among multiple entities, and depending on embodiment, those entities can optionally be within a seller or external to the seller. Again these elements refer in general to system elements and their interfaces to one another, as supported by FP system processes and databases, along with the user interfaces for facilitating human control and management/supervision.

Selected stages in shopping and use flow downward in an exemplary time sequence (but need not be limited to that sequence—alternative embodiments can optionally vary any of the sequence details presented here, as may be useful to accommodate different market contexts). Selected FP system interaction and data flows are shown across the components, but additional flows can optionally be applied as well. These flows are shown as going from Consumers 101 to Seller 102 to Services 103/104, but as noted above, these can optionally also go directly between Consumers 101 and the Services 103/104, with or without visibility to Seller/Merchandising 102. Conversely, system elements shown as within Services 103/104 can optionally, in many embodiments, be largely or entirely done using system elements within the control of Seller 102, so that some or all of elements shown as part of Services 103/104 might be understood alternatively as additional system elements that can optionally be associated with Seller 102. These selected flows are described in more detail below. Note that arrowheads denote exemplary typical directions of selected information flows, but are meant only to be suggestive and not to exclude reverse flows as may be appropriate and are not meant to require flows in the direction(s) shown). Dotted lines are used to denote actions and flows that might be more likely to be optional.

It is to be understood that in various embodiments any or all of the data processing, flows and interactions described herein can optionally be richly structured and be recorded in rich detail in the Databases 204, thus facilitating automatic processing and analysis and maintaining rich history trails, for use in subsequent decision processes by the FP systems on behalf of the various parties, even if such recording is not specifically noted in the discussion below. See Appendix A for additional details. It should also be understood, unless otherwise indicated or clear from context herein, that FP-related interactions between buyer and seller roles are facilitated via system communications—whether such interactions are entirely computer driven, or involve human buyer user interfaces that communicate these FP interactions through buyer systems (or through buyer-side user interfaces to seller systems) to seller systems and/or other systems.

Note that much of the description herein relates to embodiments in which FP transactions can optionally take place in any shopping/transaction environment in which that is mutually desired. Thus these methods can optionally be fully embedded in any kind of shopping infrastructures and systems, with pre-sale activities and those that follow occurring in any such environment. It should be understood that in such environments, even where buyers may not have sought or been involved in any prior FP transactions, data about them that can be relevant to their potential qualification for FP offers might be available (such as for example demographic, psychographic, behavioral, and/or other such data, as described below), just as massive amounts of consumer data are widely available and used for conventional advertising/marketing purposes. In alternative embodiments, these methods can be applied in dedicated FP shopping services and/or environments. In either case, a FP buyer signup process can optionally be provided to obtain desired qualification data and establish a buyer identity in the FP systems, whether before significant pre-sale activity or at any suitable time thereafter. Such signup activities can optionally be a distinct step, or can also be more or less integrated with other shopping processes. In other embodiments, a new buyer can be permitted to conduct a FP transaction with no special signup actions other than acceptance of an offer. Thus in various embodiments sellers can optionally make multiple concurrently open offers for a buyer to select among, including any desired mix of conventional and FP offers, optionally including mixtures of basic offer tiers and/or premium offer tiers, in any number of gradations and/or variations, whether for the same, similar, and/or diverse items. As described further below, the composition of such offer mixes can optionally depend on FP reputation in any of its varied forms, and/or on any other desired criteria. For example, such a multiplicity of mixed FP and/or other offers can take a form similar to that of conventional Web shopping, in which one or more Web pages (and/or equivalents in app user interfaces, etc.) can include a multiplicity of offers presented to a potential buyer at once and/or in succession, or similar to Web (and/or equivalent) advertising, in which a multiplicity of offers, and/or advertisements that might lead to offers, are presented.

During a pre-sale period, Consumers 101 are exposed to and can optionally interact with Advertising 207 from Sellers directly or via third parties, potentially including both conventional advertising, and FP-related advertising. As will be described below, these advertising messages (meant to be inclusive of marketing messaging of any kind) can optionally be based on data related to desirable targeting of Offers 208, including price history information from the Merchandising and Offer Services 205 that can optionally be used to determine what products to offer on a FP basis. Behavioral and other data on the consumers, including clickstream details (or similar brick-and-mortar flow information), and any other obtainable data relevant to merchandising, can optionally flow back to the Sellers 209 and/or to the Services 210. This data can optionally be used to adapt current marketing efforts and also saved for future use, e.g. with respect to market research and analysis, formulating marketing strategies, and/or any other suitable use.

Once the consumer decides to actively shop for a product/service, they can seek products, whether in response to advertising or spontaneously. This can optionally be done directly with a seller, or via a shopping intermediary service, including search services, recommenders, and/or the like. In some embodiments, such shopping processes can optionally be entirely automated and even automatically initiated, subject to predefined rules and data processing and decision analysis processes specified by the consumer. In one embodiment, product Offers 211 are sent to the consumer system (such as, for example, in the automated Web offer forms described below, or an agent-to-agent Web service equivalent) for more or less immediate presentation as actionable. In another embodiment, product Offers 211 (in similar forms) can optionally be pre-stored on the consumer's computer to be presented to the consumer agent and/or human user as actionable at some future time. Similar to the advertisements, product Offers 211 can optionally be based on data related to desirable targeting of Offers 212, including price history information from the Merchandising and Offer Services 205 that can optionally be used to determine what products to offer on a FP basis. Again, behavior and other data on the Consumers, including clickstream details and/or the like can optionally flow back to the sellers 209 and/or to the services 210. This data can optionally be used to adapt current marketing behavior and can also be saved for future use. In one embodiment, potential buyers can optionally initiate requests for FP pricing offers, even where not proactively offered by sellers. Extending such offers need not be at seller initiative. In such cases, a buyer can optionally request initiation of a merchandising review process of the kind described above (such as, for example, using a Web form, possibly by clicking a “Can I buy using FairPay?” button, which can be selectively included and/or enabled on any page of a shopping-related Web site and/or app) to determine if such an offer is to be extended in response to such a request.

Prior to the sale, the consumer can optionally be given background information on typical or expected prices that might be sought (from the seller-side FP systems to the buyer-side FP systems and/or to buyer user interfaces). This can optionally include one or more of the following and/or other data:
a minimum price;
a suggested reference price;
a conventional fixed price (meaning a seller-set price) as an alternative, or as may be offered in other contexts;
a statistical presentation of actual PWYW prices for this and/or similar products/services as actually set by other consumers (from this seller and/or from other sellers); and/or
a reminder of prices previously paid by the consumer.

Such data can optionally come from the seller, from other sellers, from the buyer's database, or from an external service, or a combination thereof. Such background data can possibly be provided in fuzzy/nuanced form, such as by suggesting how acceptable prices might vary under some relevant hypothetical conditions of usage and satisfaction, but, alternatively, can be left more or less open-ended.

Consumers can decide to buy a product or service. This can be a conventional set-price sale, a conventional free transaction, or a FP transaction, or any other kind of transaction pricing. Data on a committed buy transaction 213 is collected via the buyer system (whether automated or via buyer human user interfaces, applied to obtain data of the kind described below) by the seller system and also passed to the Price Data Collection and Reporting Services 206 as a Sale Report 214. In the case of an FP transaction, in some embodiments an agreement can be that after some initial use period the buyer will assess the value received and advise the seller of the PWYW price they consider fair. Alternative FP embodiments can include other price-setting processes, including setting price at the time of offer acceptance/sale, and/or placing constraints on buyer price setting.

Based on a sale commitment, the product/service is delivered. During usage and settlement, interactions can optionally include feedback from the Consumer 215 (whether explicit, similar to the data outlined for FIG. 6B, below, for example, and/or in the course of other customer service or other product/usage related interactions and/or instrumentation of any kind), which can optionally be passed to the Services 216, relating to usage context and results, problems, etc. Also during usage and settlement, support can be provided to aid in initial use and address any problems, and this too can be reported to Seller 217 and Service 218. Depending on the selling context, the period prior to price setting can optionally be for a fixed time, a set amount of use, other set criterion, based on dynamic conditions, such as further activity, left to the consumer's discretion, and/or the like. Reported feedback can periodically include data on time and usage of the product/service prior to a price setting action by the consumer and/or actual end user. This time/usage data, which can include any variety of factors, such as, for example, any of those listed in Appendix A under Objective Usage Data and/or Subjective User Feedback/Rating Data, or otherwise, whether explicit or implicit, can be tracked/metered/recorded, analyzed, and used as a factor in assessing consumer fairness and what offers to make in the future, in addition to the price that may ultimately be set. Sales can be for aggregations of items, for example, such as in use of a Web content, music, or video service, and in such cases the data can include details by item, aggregate usage data, and/or the like. Depending on the nature of the product/services, transaction fulfillment by the seller can be considered to occur on delivery of all or substantial part of the product/service, or on acceptance by the buyer, or at some other appropriate stage.

The consumer determines what price to set and reports that (e.g., via the buyer system, whether automated or via buyer human user interfaces, to the seller system), so that information can be provided to Seller in 219 and to the Service in 220. This price-setting action might typically be prompted by a pricing request from the seller (or support service), with reminders as necessary. This pricing request can optionally occur upon delivery or fulfillment, or at another time, possibly after a reasonable interval allowing for initial use (possibly based on tracking of use). This buyer-set price can optionally be stored in the FP system (Price Data Collection and Reporting Services 206, stored in one or more Databases 204). In one embodiment, feedback of this price into the Merchandise and Offer Services 205, can be used in considering future advertising and selling offers to this and/or other consumers.

This price setting can be coincident with the actual payment of the set price or not. The Payment 221 can be reported to seller, and directly or can indirectly be passed as a Credit Report 222 which goes to credit reporting services, e.g., to develop credit ratings that can optionally be used to qualify for future credit offers. Once a price is agreed to, billing can optionally be done as for conventional sales.

Also shown in FIG. 2B are some exemplary actions and flows that may be more likely to be optional. An FP system can optionally facilitate consumers to Adjust 223 a previously specified price (passed to service as 224). This might be useful if after setting the price, the consumer has reason to reconsider what the fair price should be, based on further use and/or reflection, and to elect to make such an adjustment. Negative adjustments can optionally be allowed depending on a variety of factors. Also shown is optional Usage Data 225 which can be reported to seller, and/or collected by the services 226. Such data can be relevant to assessment of the context of a price setting action and its fairness.

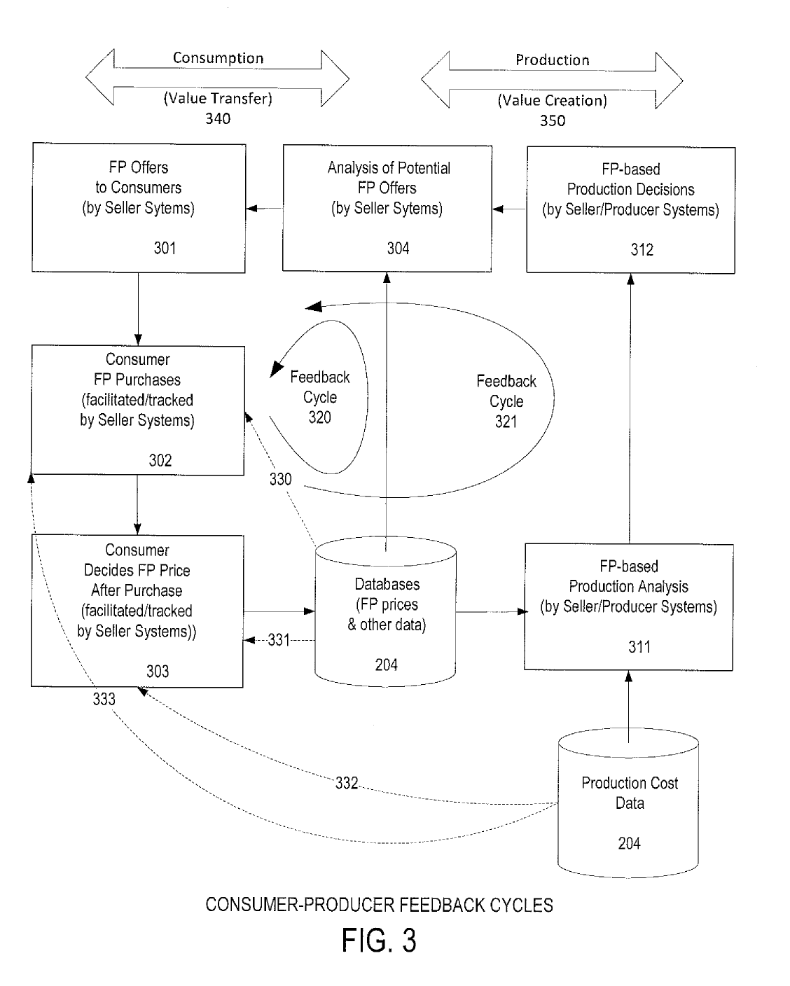

Turning now to FIG. 3, there is depicted an exemplary view of selected elements of FP system information flows in the form of consumer-producer feedback for some embodiments, as supported by FP system/data processes, databases and interfaces. FP Offers are presented to consumers from seller/support systems, 301. See FIG. 5B for additional details. The consumer elects to make a FP Purchase, 302, facilitated and tracked by seller/support systems. The consumer Decides on the FP Price after purchase, 303, which is transmitted to seller/support systems for recording, data processing and tracking The consumer's FP price is Analyzed by seller/support systems, 304. One or more Databases 204 that can be used to support consumer-producer feedback of FP prices, and to contain other relevant data or be used in conjunction with other databases containing such data are also shown. Note that other external data sources (not shown) can also be applied. That analysis can optionally be used by seller/support systems to decide on future FP Offers to consumers, 301, based on algorithmic, rule-based data processing, analysis and decision procedures. See FIG. 5A for additional details. Thus, in such an embodiment, the consumer can be free to make any PWYW payment, but might be expected to have knowledge that the process for consideration of potential future offers will be able to take that price into account, drawing on any or all of the FP systems, processes, and databases available. This assessment of prior pricing behavior can be made with respect to considerations relating to the fairness of that price, in the context of that buyer's purchase. This effectively takes what is usually just an intangible “social cost” and makes it more tangible and direct (within the context of similar actions). It develops a quantifiable history that sellers/support systems can access via the FP system and used to characterize the consumer's reputation, such as for fairness. The consumer might expect FP system transaction facilitation and assessment to lead more or less directly to being rewarded for maintaining a good reputation and punished for cheapness and/or free-riding and/or any other aspects of unfairness and/or any other aspect of undesirability.

Turning to Production-side (generally relating to value creation/addition) on the right side of FIG. 3, it can be seen how the FP pricing can in some embodiments provide new kinds of data useful in optimizing production to most efficiently and profitably meet demand. The data from the FP price Database 204 is useful in FP-based Production Analysis 311, in which alternative products or services are considered. See FIG. 5A for additional details. For example, FP pricing data can reflect price sensitivities and value perceptions for individual buyers and/or populations of buyers that enable sellers/producers to determine, again based on algorithmic, rule-based data processing, analysis and decision procedures, which products and/or feature sets offer high perceived value and/or low cost of production, thus being in demand and desirable and profitable to produce and offer, and which do not. That analysis leads to FP-based Production Decisions 312. Also useful in this analysis and the decision process is Production Cost Data 310. Many other factors can optionally also enter into such decisions. These decisions feed into the analysis of potential FP offers 304, which feeds the Consumer-side (generally relating to value transfer) on the left side of FIG. 3. Thus the two Feedback Cycles 320 and 321 work together to match supply and demand. More particularly, the Value Transfer side Feedback Cycle 320 can help set pricing and generate sales (managing demand with respect to supply), and the Value Creation side Feedback Cycle 321 can link the Value Transfer side 340 (demand) with the Value Creation side 350 (managing supply with respect to demand).

FIG. 3 shows flows of these feedback cycles with the solid arrows linking the selected elements. Additional system information flows might be useful as well, and some representative but non-limiting examples of these are shown with dashed arrows. Flows 330 and 331 illustrate that the FP data can be made available to buyers to aid in their decisions at the time of purchase 302 (such as, for example, to evaluate what range of pricing might be expected by a seller and thus decide whether a product might be economically desirable to them at all), and at price setting 303 (such as to aid in making a specific price-setting decision that the seller might be expected to agree can be considered fair). Flows 332 and 333 show that production cost data can also be available and useful to buyers at those times as well. Knowing not only what others chose to pay for a product or service, but also what that product or service costs to produce can be useful in helping buyers determine if the product or service is likely to be economically desirable to them, and if they are likely to set an FP price (personal value) on the product or service that will not be out of line with its cost and its commonly perceived value (and thus presumably acceptable to the seller to maintain a favorable pricing reputation).

Having access to cost data (fixed and marginal) can also help influence buyers to pay a fair price by making it clear that paying less than the marginal cost may not support a sustainable business for the seller, and that such a price can only be fair if there was a significant issue with the value received. It will be understood that support of a sustainable business is in the buyer's interest if they wish to have future similar buying opportunities. Knowing that information prior to sale can help avoid cases of buying something that is clearly not economically justifiable. Under conventional pricing models, sellers often seek to hide cost information and often seek to maximize price and margin. Under FP, the incentive can be to be more open, and to be satisfied with smaller margins for many sales, in order to expand the market to more sales and to maximize volume at a fair price, possibly generating higher total profit than would be gained with fewer sales at higher margins. Such cost data can be expressed to show raw costs (including fixed and/or variable and/or marginal costs, including overhead, etc.) plus identification of value added elements (with the value add being perhaps more subjective and more in need of supportive information, which can optionally also be provided as appropriate). Again, such data can be provided by buyer and seller systems, or by any combination of third parties, not shown here.

It will be apparent that the consumer-producer feedback flows shown in FIG. 3 can provide new and powerful methods for both consumers and producers to cooperate and adapt so that they continually move toward behaviors that maximize their mutual economic well-being. Consumers might seek to buy items and set prices that provide maximum utility to them, and producers might seek to produce, offer, and sell items that deliver maximum utility per unit of input cost, and thus might provide maximum profitability to them. Both at micro and macro levels, these adaptive processes and feedback cycles might be expected to tend toward global and local economic optima for consumers, producers, and society at large. In this respect, FP prices might serve as a metric of utility far closer to the ideals of economic market theory than conventional prices or other existing metrics.

It is also noted that the elements of Production Decisions 312 and Analysis of potential Offers 304 can optionally not be performed as distinct elements as illustrated, but can be integrated. This might be particularly applicable in cases where production is customized so that a one-off production and sale offer can be made as a single decision with regard to a single buyer. More generally, it should be understood that the elements shown are illustrative, and need not reflect the actual implementation structure of specific embodiments.

Computer Network Components

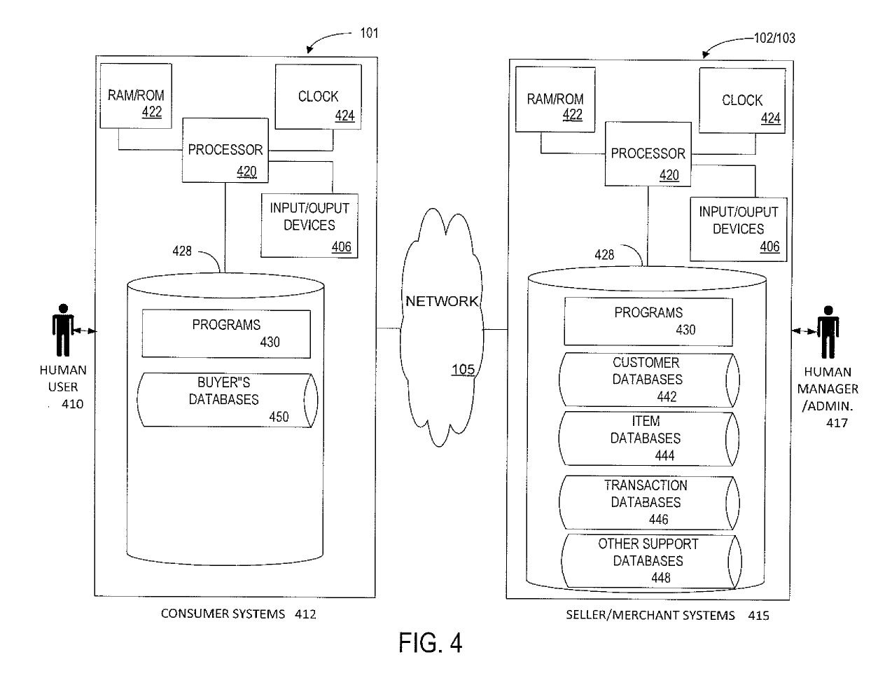

Turning now to FIG. 4, displayed therein are exemplary components of computing devices used to support consumers, sellers/merchants, and other systems. It should be understood that any of consumers 101, sellers/merchants 102, pay/price services 103, and other market services 104 (again referring to their respective systems) can optionally share similar configurations. However, for sake of brevity, the discussion immediately below will refer to the consumers 101 and sellers/merchants 102 only. As noted previously, it will also be understood that consumers 101 represent systems elements that can optionally be directed by participant human consumer/buyer users 410 working with their supporting consumer systems 412 (including databases) through user interfaces. Sellers/merchants 102 or other systems 103 and/or 104 may similarly represent system elements that can optionally consist of seller/merchant systems 415 (including databases) or other systems, as directed by associated management/support staff personnel 417 through user interfaces.

As noted earlier, these role-descriptor terms (such as Consumer/Buyer and Seller/Merchant/Merchandising and the like) just above, and throughout, should be understood to generally refer to the systems elements that take on and perform these respective market roles and interactions in the context of FP-based transactions, such as, for example, in a role of smart agents. It is to be understood that these interactions are facilitated by various FP system modules and/or components and can optionally be implemented via a variety of networked implementations. Again, in many embodiments, as described below, Seller/Merchant/Merchandising and Other Market Services systems can be highly or entirely automated, operating under defined rules and/or algorithms and in communication to the buyer system and other systems, but can also have user interfaces for seller-side human intervention, direction, and/or control, in degrees that can vary depending on the embodiment and the role. Similar levels of automation can optionally be applied to Consumer systems. Thus, in the context of some embodiments, it might be helpful to think of the roles of consumers, sellers/merchants, and other systems services as being carried out by man-machine systems, comprising both participant human users and their respective supporting systems (as overseen by human users/managers and any supporting staff) working in concert. Such human oversight can optionally include specification roles in setting generally applied rules, algorithms, criteria, and the like for automated decision processes effected by the FP systems, and possibly also transaction-related roles of review and/or intervention in specific decisions.

One component of consumer system 412, seller/merchant system 415, and other systems is a processor 420, which can optionally be any commonly available microprocessor, such as those manufactured by INTEL CORP. The processor 420 can be operatively connected to further exemplary components, such as RAM/ROM memory 422, a clock 424, input/output devices 406, and a mass memory 428 which, in turn, stores one or more computer programs 430, and databases (comprising databases 204 and/or other data), such as customer database 442, item database 444, transaction database 446, and other support databases 448, as well as buyer's database 450. These databases can optionally be integrated with one another or further subdivided.

The processor 420 operates in conjunction with random access memory and read-only memory (RAM and ROM) in a manner well known in the art. The input/output device(s) 406 can be one or more commonly known devices used for receiving system operator inputs, network data, and the like and transmitting outputs resulting therefrom. Accordingly, exemplary input devices can include a keyboard, a mouse, a touchscreen, a voice recognition unit and the like for receiving system operator inputs. Output devices can include any commonly known devices used to present data to a system operator. Accordingly, suitable output devices can include a display, a printer and a voice synthesizer connected to a speaker. Other input/output devices 406 can include a telephonic or network connection device, such as a telephone modem, a cable modem, a T-1, T-2 or T-3 connection, a digital subscriber line or a network card, wireless transceiver, or the like for communicating data to and from other computer devices over the computer network 105.

The mass memory 428 can optionally be an internal or external large capacity device for storing computer processing instructions, computer-readable data, and the like. The storage capacity of the mass memory 428 is typically measured in megabytes or gigabytes. Accordingly, the mass memory 428 can be one or more of the following: a floppy disk in conjunction with a floppy disk drive, a hard disk drive, a CD-ROM disk and reader/writer, a DVD disk and reader/writer, a removable disk and drive, a smart card or other flash memory device, and/or any other computer readable medium that can be encoded with data and/or processing instructions in a read-only or read-write format. Further functions of and available devices for mass memory 428 will be apparent.

The mass memory 428 preferably stores, inter alia, a plurality of programs 430 which can optionally be any one or more of an operating system such as WINDOWS 7 by MICROSOFT CORP, and one or more application programs, such as a web hosting program and a database management program such as of the type manufactured by ORACLE, each of which may be appropriate to implement the embodiments of the present invention. The programs 430 preferably also include processing instructions for effecting communication of data with and between the various systems, as described herein. Accordingly, the programs 430 can optionally include a web hosting application. The web hosting software can include functionality sufficient to read JAVASCRIPT, Hypertext Markup Language (HTML), Extensible Markup Language (XML) and other similar programming languages typically used in conjunction with hard-wired or wireless Internet applications.

The programs 430 can optionally also use advanced Internet application integration (IAI) methods based on Web services, Simple Object Access Protocol (SOAP), Java Message Services (JMS), or other application program interfaces (APIs) or remote messaging and method invocation middleware techniques, or Agent Control Languages (ACLs). The programs 430 preferably also include a database management program, such as of the type commonly manufactured by ORACLE CORP. or SAP CORP. to save, retrieve and analyze data. The programs 430 can also include other applications, such as C++ or JAVA applications, to allow an operator to program specific functions to be performed as described herein. The programs 430 thus cooperate to form a system which operates in the manner described further below. Participant system programs 430 can also include Web browsers and/or other participant support programs.

The mass memory 428 preferably also stores a plurality of relational, object-oriented, XML, or other databases, and the databases 442, 444, 446, 448, 450 and others described herein can optionally be configured into any number of relational, non-relational, or other databases. In addition, configurations other than traditional database formats, including use of XML formats or other standard and/or self-describing formats can optionally be used to store the data maintained in exemplary databases 442, 444, 446, 448, and 450. As used herein, unless otherwise indicated or clear from context, the terms “database” and/or or “information base” and/or the like are meant to be understood broadly as inclusive of any database, data structure, information base, knowledge base, data warehouse, data mart, and/or any other temporary, persistent, and/or permanent collection of information in any form, including data and/or metadata, and including structured, unstructured and/or semi-structured data, unless otherwise indicated or clear from context. Given the volumes of data and attendant processing that might be involved in large scale application of the methods described herein, it is suggested that a variety of emerging “big data” techniques for the processing of such data, including those based on cloud computing and distributed systems/processing/databases can optionally be applied, and all such techniques are meant to be included. It is further to be understood that related elements, such as for example databases, may be shown as distinct elements in one or more of exemplary FIGS. 1-4, but that is not intended to require that such elements actually be distinct, nor to preclude alternative decompositions or integrations or distributions of such elements.

The exemplary databases, customer database 442, item database 444, transaction database 446, and other support databases 448, as well as buyer's database 450, are meant to be non-limiting, but suggestive of useful collections of data elements in exemplary embodiments. Customer database 442 can organize information with respect to individual customers, item database 444 can organize information with respect to items, and transaction database 446 can organize information, including pricing, with respect to particular transactions and transaction groups, but it will be understood that these can optionally be integrated into a single database or distributed in any desired manner. Buyer's database 450 can be used to organize all of a buyer's information relating to FP offers, as well as possibly other shopping information.

Given the sensitivity of much of the data involved in these processes, it can be desired that strong security measures be applied to protect all data and to authenticate the identities of participating computer systems 412, seller/merchant systems 415, and databases 450, 442, 444, 446, and 448 and any other components, as well as the people using them, and all transmissions of data. Any and all users and systems can optionally be specifically authorized and/or authenticated using any conventional or future methods applicable to such protection. This can include use of identifiers and passwords, and/or any combination of something the user, or the systems, knows, has, or is. For example, identification and authentication of users can optionally be based on what they know (e.g.: passwords or keys or answers to various questions, etc.), what they have (e.g. a system ID or hardware address, a hardware token or key, etc.), or what they are (e.g.: biometric attributes, computed signatures, etc.). Similarly, systems can optionally use trusted systems and trusted computing methods and/or any similar protection methods. Database contents for any and all of the databases can optionally be encrypted using any desired method, and controlled using access control methods, including specifications of roles and privileges and methods for enforcement thereof. Any and all transmissions can be encrypted using any useful method. Encryption can optionally be done with hardware devices and/or software, using any desired cryptographic technology including checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), public key systems and/or the like. Measures for protection against fraudulent use are discussed further below.

Further exemplary detail on these databases is provided in Appendix A. This listing is intended to suggest non-limiting simplified examples of the kinds of data sets and elements that can be maintained in selected embodiments, as supplements to any other data conventionally maintained. Not shown are variations relating to item types, details of how elements explode in instances and hierarchies of elements for multiple transactions, items (including composite items), usage periods, etc. Summaries can optionally be maintained for any of these elements, with links to separate collections of details for any such elements (not only those so indicated). Data can optionally be maintained and used in terms of multiple metrics and/or aspects as well as composites. Databases can optionally include Network-wide data (in a multi-seller network) and/or Seller-specific data, in single databases and/or in distributed databases, and the databases can optionally be controlled by multiple business entities. This is not intended to represent a formal database structure showing all aspects of the databases or their relationships, linkages or other internal structures, and actual implementations can be expected to vary in details, as will be apparent to one skilled in the art based on the teachings herein and the particular business context/environment being addressed. The sub-databases as shown here can instead be embodied in different combinations.

Although the embodiment described herein involves components of typical computers and network servers, other existing or future technologies which perform similar functions can optionally be employed. One such variation is the blurring of server and enterprise boundaries involved in the use of so-called “Web services” in which functions typically performed by a single server complex operated by a single enterprise can optionally be “distributed” so as to integrate component services provided on remote servers operated by independent enterprises into a cohesive “virtual server” offered by the combined “virtual enterprise.” A similar variation is the use of “application service providers” (ASPs) and “cloud computing” to outsource such services. From that perspective, embodiments of the methods described herein might be understood as facilitating a new sub-category of “pricing as a service.”Also clearly intended is the use of multiple cooperating servers, as well as the use of multiple cooperating client systems, as well as the use of mobile agent technologies.

Variations can optionally include assemblages based on combinations of downloadable programs, thin clients, smart clients, rich clients, plug-ins, applets, aglets, AJAX, or other distributed hardware and/or software components and the use of removable components such as smart cards. Such assemblages can include elements controlled, managed and possessed by any combination of the buyer, seller, other market services, or any other party. Thus, for example, elements that can be implemented on consumer systems 412, can alternatively be provided to consumers in an ASP mode by seller/merchant systems 415 or by similar systems of services 103/104. Similarly, any element can alternatively be provided by independent cloud computing providers, and any element that can be controlled by a Seller/Merchant in some embodiments can be controlled by any combination of Seller/Merchants and Other Market Services in other embodiments. Alternative embodiments of consumer systems 412 can optionally be based on a wide spectrum of intelligent devices including cell phones, PDAs, wearable computers and sensors, and the like, and can involve mobile applications that move from device to device, as needed, as well as new user interfaces including gestural input, and the like. It will be understood that with such evolving forms of distributed processing and databases, which party controls the hardware and/or software may be less important with regard to FP processes than which party controls the rules and/or algorithms and any required/desired human interventions and decisions relating to these processes. As just noted, this might be viewed as “pricing as a service.” As a simple example, as noted earlier, a consumer in a store can optionally use a kiosk provided by a seller or support service, or even have entries made by seller agents or other facilitating agents, on the consumer's behalf and under their direction (subject to any desired and suitable controls) using no hardware or software under direct control of the buyer. For example, such services can be controlled by passwords, PINs, tokens, biometrics, or other user authorization and authentication measures, such as are similarly applied to credit card charges and other kinds of transactions to validate a party's authorization. Similarly, sellers/merchants can optionally not control the hardware and software that supports their roles directly, but can also obtain that as a service from others, under the seller's/merchant's direction.

It is also to be understood that while the discussion herein is in terms of conventional electronic digital computer systems, future equivalent technologies can optionally also be used. Such alternative technologies can optionally include optical, photonic, quantum, molecular, or organic computing systems, and the like. Accordingly, it will be understood that references herein to electronic computers, electronic marketplaces and electronic or computer-based support systems, and the like are meant to be inclusive of embodiments based on such future technologies as well.

Interactions of buyers, sellers and/or third parties can optionally range from fully automated to manual, and can optionally rely on user interfaces to facilitate human roles and control of the methods and the systems that facilitate the methods. Such user interfaces can optionally be facilitated by any combination of buyer, seller, and or third-party systems. Embodiments can optionally involve a range of levels of decision support systems, any of which can optionally support buyers and/or sellers and/or third-parties in any combination, and with any level of full and/or partial automation of decision processes. In many embodiments, the operational control of FP processes might generally be expected to be performed under program control, using defined, data-driven, data processing steps, rules and/or algorithms specified under the direction of the humans managing the particular roles of buyer or seller or other support service, and possibly providing clear criteria for human intervention and review under defined conditions and/or as desired. Such automation in support of any of the parties can optionally include any suitable methods, including heuristics and statistical methods, artificial intelligence and machine learning of any kind, expert systems, smart agents or bots, including mobile agents and open multi-agent systems (MASs), decision support systems, social decision support systems, or the like. Such methods can optionally include facilities for machine understanding and evaluation of human inputs, including but not limited to natural language understanding, voice understanding and the like, whether based on advanced methods or simple parsing and analysis. Such methods can optionally be applied, for example, in understanding and evaluating a buyer's reasons/factors/criteria for a payment decision, whether in free text, voice, and/or other formats/modalities. Some embodiments can include photos, video and/or other sensing of a buyer during use of a product, such as, for example, to recognize and evaluate positive and negative usage experiences. A variety of methods for automated data processing, analysis and decision processes for implementing these processes are described herein, with representative examples. Based on those teachings herein, additional similar methods for specifying arbitrarily rich and nuanced data interpretation, processing, and decision processes in the particular formats needed for automated processing using methods of the kind described herein will be apparent to those skilled in the art, to implement further variations on automated and/or largely automated systems embodying the full range of data processing, analysis and decision criteria and methods taught herein.

Such methods are described further herein with emphasis on merchandising and offer management, but similar methods can optionally be applied to buyer-side automation, and to support systems, as well. For example, once buyers become familiar with a given product/service category, they might wish to set prices or pricing rules, or even product search and purchase decision rules, to be applied automatically within defined contexts, possibly subject to human intervention or override when desired or as specified.

Embodiments can optionally employ any suitable form of buyer-seller communication and any appropriate buyer communications interface, which can, for example, take the form of Web pages, apps, e-mails, SMS/MMS, voice synthesis/recognition/response, facsimile transmissions, photographs, scans, OCR, tags, including RFID, bar codes, QR codes, and/or other coding, alerts of any kind, tactile and/or gestural interfaces, and/or any other forms and combinations of electronic and/or conventional messaging, including person to person communications, whether face to face or remote, and/or postal mail and/or messenger, and with any means of recording such messaging. Embodiments can optionally integrate all buyer-seller dialogs into one or more unified dialog management processes (possibly integrating with CRM), again using any combination of buyer, seller and third-party systems and support services, with any combination of human and/or automated and/or computer-mediated participation, to provide better coherence and consistency to such dialogs and the database trails relating to them, and other supplement and enhance them in any manner, across any or all stages and levels of these relationships. Any of a variety of customer self-care support tools, such as help systems, Frequently Asked Questions (FAQs), knowledge bases, and community-based help/support systems, such as those using bulletin boards, chat, and/or any other form of dialog can optionally be applied,

As noted above and elsewhere herein, some embodiments rely on user interfaces to the various system elements to facilitate human direction and control of the systems as they perform in the respective market roles. Such user interfaces can optionally take any suitable form. Computer interaction interface elements such as check boxes, selector boxes, entry boxes, cursors, menus, scrollers, pointing tools, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users. Some user interfaces, such as, for example, those that assemble a related set of controls might be referred to as dashboards.

A user interface module is stored program code that is executed by the CPU. The user interface can optionally be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface can optionally allow for the display, execution, interaction, manipulation, and/or operation of program modules and/or system facilities through textual and/or graphical facilities, and/or in richer modalities as noted elsewhere herein. The user interface provides a facility through which users can affect, interact, and/or operate a computer system. A user interface can optionally communicate to and/or with other modules in a module collection, including itself, and/or facilities of the like. Most frequently, the user interface communicates with operating systems, other program modules, and/or the like. The user interface can optionally contain, communicate, generate, obtain, and/or provide program module, system, user, and/or data communications, requests, and/or responses. Of course such user interfaces need not be limited to direct operational control, but can optionally also be used in more indirect fashion, as interfaces to program elements that create profiles, parameter settings, preferences, rule-sets, algorithms, specifications, and/or other kinds of data and/or metadata that set up, specify and/or control the operational functions of the computer systems. The term wizard is commonly used to refer to some types of user interfaces, especially in the case of user interfaces that facilitate set up, specification, and/or control tasks, and such wizards can optionally be applied to set up and/or specify rules and/or algorithms and/or the like for automated control of many FP system functions, such as, for example, offer management and/or pricing evaluation.

Among the forms a user interface can optionally take is a Web browser. A Web browser is stored program code that is executed by the CPU. The Web browser can be a conventional hypertext viewing application such as Microsoft Internet Explorer or Netscape Navigator, which commonly include the use of hyperlinks to Web pages, and/or Web forms, and/or other kinds or resources to provide rich, non-linear information browsing/navigation and/or information handling experiences that can incorporate multimedia, virtual reality, Web services, mash-ups, and other rich computer-augmented experiences. Secure Web browsing can optionally be supplied with 128 bit (or greater) encryption by way of HTTPS, SSL, and/or the like. Some Web browsers allow for the execution of program modules through facilities such as Java, JavaScript, ActiveX, AJAX, HTML5, and/or the like. Web browsers and like information access tools can optionally be integrated into PDAs, cellular telephones, and/or other mobile devices or appliances of any kind A Web browser can optionally communicate to and/or with other modules in a module collection, including itself, and/or facilities of the like. Most frequently, the Web browser communicates with information servers, operating systems, integrated program modules (e.g., plug-ins), and/or the like; e.g., it can contain, communicate, generate, obtain, and/or provide program module, system, user, and/or data communications, requests, and/or responses. Web browsers can optionally be general purpose user interface systems, possibly with any of various forms of customization to a specific application. Alternatively, in place of a Web browser and information server, a combined application can be developed to perform similar functions of both, providing any and all of the features of a browser, or an equivalent. The combined application can similarly affect the obtaining and the provision of information to users, user agents, and/or the like from participating FP system elements.

### Implementation Example

To more clearly illustrate how these methods can be applied in an embodiment, a non-limiting example is now reviewed.

A consumer is offered a product/service by a seller on an FP basis. The consumer can optionally be given alternative options to obtain the item on a conventional fixed price basis, or on other alternative terms. The consumer elects to obtain the product on an FP basis. This offer can optionally be detailed on a standard or customized basis. A standard offer basis can optionally provide for the consumer to try the product/service, see what value is obtained, decide on any (typically non-negative) price judged by the consumer to be “fair” in the full context of the sale, notify the seller of that price, and make the corresponding payment. As one example, the product might be a digital media product, such as a song, a movie, a TV program, or an electronic book. Such a product might be from a vendor such as iTunes or Amazon, or a smaller seller, and the FP transaction support services used to effect the sale can optionally be specific to the vendor, or common to many vendors (such as by using Web services or other ASP methods or the like, as described above). One non-limiting example of an FP offer is provided in Attachment B.

The price can optionally be set at the consumer's sole discretion, including a price of zero, as permitted. In such case, the consumer is free to pay nothing or very little, but does so with the expectation that his payment decision will be reported and might be expected to be reviewed by this and possibly other sellers. Thus for the digital media product, the consumer might be aware and/or informed by the FP offer process that iTunes songs conventionally are priced at $0.99, or that ebooks are conventionally priced at $9.99, thus providing a reference price for either item. As discussed more fully below with regard to Example 1, the consumer might elect to pay the same, more, or less than that reference price, depending on how he judged the value received (and possibly considering related factors such as feelings toward the seller, the author/artist, or other aspects of the product and its sale and use context).

This data can be collected by the FP systems and databases and made available in more or less detail for use by FP system offer management components in determining if and when other FP offers should be presented to that consumer (by the same or other sellers), and as reference data for evaluating other consumers' payment history. See FIG. 6A for additional details. In one embodiment, the data can optionally be proprietary to a given seller. In another embodiment, it can be widely accepted that such data is made available to and used by many sellers, much as credit ratings are. (Details of privacy issues and what controls can optionally apply are discussed below.)

Thus as the consumer builds a history of such FP transactions in the relevant databases, a pattern is developed that can optionally be used in merchandising offer management processes to develop inferences as to the consumer's likely response to future FP offers. A consumer with a FP system history (reputation) of paying at a good rate and being fair about occasional instances of lower payment rates (possibly citing reasons for dissatisfaction) can optionally be selected in the offer management process as a good candidate for future FP offers and benefit from numerous offers of varied and relatively valuable products/services, with the expectation that they will generally pay reasonably well unless they have good reason not to. One with a history of low FP price setting, and/or frequent FP responses of zero or no response at all, can optionally be evaluated by the offer management process to selected to be given few offers, with most of those offers being for low value products/services that might conventionally be free or advertising supported, or highly discounted. As a result, the “social cost” of being a deadbeat/free-rider or paying at unreasonably (or unfairly) low levels might be operationalized and becomes more tangible, an expectation of consequential direct cost in the form of diminished future buying prospects. The FP system thus might tend to motivate consumers to fully consider their conscience, not simply out of altruism or some vague sense of social repercussions, but more pragmatically in terms of more clear expectation of future incentives—using the FP system can facilitate fair pricing by consumers by providing subsequent FP offers to a consumer based on the consumer's FP pricing history. It can optionally be an established practice that subsequent FP offers are not tied to any single transaction but are reasonably clearly dependent on a buyer's overall price setting behavior history. This history can optionally be applied with a high level of sophistication and nuance, as further outlined. This might lead to buyer price setting at higher levels than just a simple balance of altruism and related social factors versus the economic self-interest that would otherwise push toward price minimization in a conventional PWYW pricing context.

To give further detail of an example of how such selective offers can be applied in a merchandising/offer management process, consider a category of products with various items considered by the FP system to have a range of values, where the products might be grouped by the seller to have a small number of high value products (A), a moderate number of medium value products (B), and a large number of low value products (C), all having low marginal cost. With conventional pricing the A's and B's might be offered at higher and lower set prices, and the C's might be offered as free and/or ad supported (and/or “freemium” and/or heavily discounted/loss-leaders). Consider also a population of potential buyers with a history of payments in that product category collected in the FP databases and analyzed and where the buyers are categorized by the seller, using FP processes as described below to include a well-paying group (1), an average-paying group (2), a low-paying group with a high frequency of not paying anything at all (3), and a low-paying group known to have limited means and a low frequency of not paying anything at all (4).

A possible rule-based merchandising strategy for such a case, to be applied by the FP offer management process might be as follows, showing which pricing method is used, for each product category and buyer category combination (referred to as Table 1, shown in simplified form for discussion here, and applied by the FP computation and decision processes as discussed further below):

| | Products | | |
|---|---|---|---|
| Consumers | A (high value) | B (medium value) | C (low value) |
| 1 high pay | FairPay | FairPay | FairPay |
| 2 average pay | Fixed price | FairPay | FairPay |
| | (or FairPay) | | |
| 3 low pay/high | Fixed price | Fixed price | Advertising |
| zeros | | | |
| 4 low pay/low zero | FairPay | FairPay | FairPay |
| and limited means | (or Fixed price) | | |
| 5 new/unknown user | Fixed price | Fixed price | FairPay |

The above decision table should be understood as an exemplary representation of a set of system decision rules that can be used by a seller system to drive an automated offer management process. Such a process can thus use prior buyer FP pricing reputation data and other inputs to determine whether and how to make future FP (and/or other) offers to specific buyers based on data specific to them. (As discussed below, far more sophisticated rule-sets, data inputs, and algorithms can optionally be applied in various embodiments.)

The above rules might compare to those for a conventional pricing model (which is not buyer-specific) as follows:

| | Products | | |
|---|---|---|---|
| Consumers | A (high value) | B (medium value) | C (low value) |
| All consumers | Fixed price | Fixed price | Advertising |
| | | | supported |

The expected benefit of this to the seller can be seen with respect to the total net revenue relative to the conventional model for each case, as follows:

| | Products | | |
|---|---|---|---|
| Consumers | A (high value) | B (medium value) | C (low value) |
| 1 high pay | Higher prices | Higher prices | Higher prices |
| | X more sales | X more sales | X more sales |
| 2 average pay | Approx. same | Approx. same | Higher prices |
| | price | price | X more sales |
| | X more sales | X more sales | |
| 3 low pay/high | No change | No change | No change |
| zeros | | | |
| 4 low pay/low zeros | More sales | More sales | Higher prices |
| and limited means | | | X more sales |
| 5 new/unknown user | No change | No change | Higher prices |
| | | | X more sales |

The category 1 and 2 consumers, granted the FairPay offers, may be more inclined to try the products, increasing sales, and can be expected to generally pay at a level comparable to fixed-price or higher, for an expected revenue (and profit) increase in most or all cases. The higher value products can optionally be offered on FairPay basis only to the category 1 consumers to minimize the risk of unfair pricing. The category 3 consumers, not offered FairPay terms, will pay on the conventional basis, as before. The category 4 consumers, granted FairPay offers, can be expected to buy products they would not otherwise buy. The category 5 consumers (granted FairPay offers for lower-value product categories) can also be expected to buy products they would not otherwise buy. Even though they might pay relatively low prices, for low marginal cost items that scenario still generates added net revenue, and thus added net profit. Thus, over a broad range of products and services, such a strategy might be expected to be beneficial in terms of both revenues and profit. In addition, on a total marketplace basis, it might serve to increase the total value of production and consumption over conventional schemes, possibly very significantly.

As suggested by this example, it can be useful to apply FP pricing as a complement, rather than a complete replacement, to conventional pricing alternatives. Such combined use can have the advantages of giving a ready reference for pricing, and of providing an alternative for those who fail to, or do not wish to, participate in the more participative and collaborative FairPay pricing process. It can optionally also be useful to permit buyers to shift from one pricing scheme to another at any time (subject to seller's option to impose constraints on buyers with undesirable FP reputation levels). Some embodiments can optionally also inform potential buyers of potential offers that they did not currently qualify for because of their reputation, such as for example to increase transparency, and/or to provide an incentive to the buyer to seek to set prices that will lead to an improved reputation and thus an expectation of eligibility for such offers. In further variations, some embodiments can permit a price set via an FP process to be applied to future purchases made on a set-price basis. In such cases, the FP process might give the effect of a new kind of price negotiation that effectively becomes the negotiated basis for one or more new set-price transactions. More generally, any evolving mixture of the inventive methods with conventional methods might be usefully applied over any series of transactions, depending on the market context.

Merchandising Considerations, Based on Feedback

The FP data collection/reporting and database services can categorize the products/services in more or less detail, which can optionally be used to consider whether a given consumer generally values certain categories highly and other categories less than other consumers. Thus a merchant can optionally draw on this data to determine not only whether the consumer generally pays well or poorly, but how that might vary from one product category to another, using the automated, rule-based processes as described in detail below. (Once again, reference to “a merchant,” as in the previous sentence, is meant to refer to a merchant as represented by system element 102, with the understanding that in many embodiments such determinations by “a merchant” are made by merchant computer systems 415 and/or other systems, using databases 204 and other data, generally applying automated rules, processes, and data access, and generally with little or no human intervention except in special cases. This same understanding should be recognized to carry through all discussion herein, unless otherwise indicated or clear from context.)

Similar sophistication can optionally be applied to other aspects of the context of a sale and the price-setting decision. The FP services can optionally collect various context data relating to the status of the consumer, the seller, the product/service, and the market environment that might give a context for a fair price for this product relative to the consumer and seller, and relative to other consumers and other more or less similar products. Such factors can, for example, include impulse vs. considered purchases, style/status/brand vs. function/economy as valuation components, consumer familiarity with the product, and/or other factors that affect the consumer's valuation/pricing decision. The consumer can optionally be permitted to provide feedback relating to the use and value of the product during the trial period and to characterize that, as it bears on the consideration of the FP price, and explain why the consumer considers that fair, reflecting positive and/or negative influences/factors as deemed appropriate. The FP system can optionally provide various input forms for such feedback, including simple categories to check or rate, and potentially allowing free text comments to be interpreted by computers and/or humans. Such feedback can optionally be provided to the seller and/or to other sellers and/or to other market services. Again, a non-limiting example, including such a pricing explanation form, is provided in FIG. 6B. As noted previously, in some embodiments, such a form can optionally be filled out by a human buyer, via the buyer's system to be input to the seller system and associated databases. In other embodiments, such information can optionally be automatically assembled and provided by the buyer system, operating under defined rules, to the seller system, such as, for example, in the form of a smart, rule-based “shopping bot/agent” system, as described below.

In a well-developed embodiment of FP data-based offer management decision systems, consumers may come to feel confidence that richly variable price-setting behaviors can be applied and that the reported data can be analyzed in ways that fully reflect such richness and nuance. Cases of zero payment might be infrequent, and given explanatory feedback, can optionally be recognized to present little risk to vendors (and to the consumer's reputation for fair pricing). Consumers with limited wealth and conservative buying patterns can optionally be recognized as such, and be considered good risks for paying modest, but reasonable, prices for products in categories they typically find valuable. Sellers can optionally exploit such information to make offers expected to earn low, but not unfair, prices from consumers who would otherwise not be able buy their products, thus adding to net revenue. At the other end of the payment spectrum, sellers can optionally make a wider variety of offers to consumers known to generally pay well, thus encouraging maximum sampling. Thus at both ends of the FairPay pricing level spectrum (excluding bad actors) this can increase revenues—providing larger “share of wallet” from those who would otherwise not buy at all, and from those who might pay more than the conventional fixed price.

One aspect of buyer reputation in some embodiments can optionally relate to the quality of the explanations the buyer provides for his pricing actions. Such quality attributes can, for example, include factors relating to clarity, honesty, objectivity, reasonableness, consistency, and the like. Such data can optionally be inferred from a variety of inputs, and measured and evaluated in conjunction with related data on pricing levels and other factors. How such data are obtained, used in inferences and applied to FP decision processes is discussed below.

Many other factors can optionally weigh into the evaluation of FP history by offer management systems, in accordance with seller-defined rules. For example, time-weighting can be useful to weigh recent behavior more highly than older behavior, using any suitable weighting algorithm, such as for example use of exponential smoothing to compute a time-weighted average that discounts the contribution of older values, as well as anomalous extremes, to the smoothed value. This might, possibly in conjunction with other factors, allow for discrimination of cases where a buyer has learned to behave more appropriately, or, such as in a sampling situation, might have reason to want to try again, with an expectation of a more positive response, or simply to allow for a chance at correction of false negatives. Similarly, this can optionally allow discrimination of cases where a buyer has stopped paying fair prices. Numerous additional data items and analysis considerations that can optionally be applied in FP offer management systems are described below. Such factors can optionally be applied as additive, multiplicative, exponential, or other factors that adjust the raw price data.

Reflecting the many aspects and dimensions of reputation factors outlined herein, some embodiments of FP methods can optionally treat FP reputation as a richly multidimensional family of parameters and metrics. For example, FP reputation can optionally be divided at high level into dimensions related to liberality of pricing, consistency of pricing, fairness with regard to relationships, thoroughness of explanations/justifications, objectivity, honesty, and the like, with sub-categories and/or sub-dimensions for more particular aspects, as well as for cross-cutting dimensions, such as variations by product/service type, relative price levels and/or cost levels, levels of usage, familiarity/proficiency, and the like.

As this data feeds back to the advertising and merchandising flows of future purchases, it facilitates merchandising decisions by sellers to be based on an understanding of the consumer's willingness to pay a fair price, as shown, for example, in the table above. That makes the social cost of good or bad actions real and timely enough to be a significant factor in the pricing decision.

Further Details of Feedback Processes and System/Database Support

Referring now to FIG. 5A, and with reference to the above and Appendix A, there is depicted a further non-limiting exemplary view of selected aspects of an embodiment of an offer management process 500. This process can optionally be performed on any combination of seller, support service and/or buyer systems. Consideration of an offer can optionally begin with a detection of any suitable trigger event 501, including events triggered by buyer action of any kind, such as browsing of a Web site, such as any Web site offering products/services, and/or one simply suggestive of potential interest in products/services (or physical store, such as by sensing presence in the vicinity of the store, and identity from a phone, credit card, smart card, and/or the like), seller action, such as advertising or marketing messaging, or third party actions, such as search of the Web or a shopping service, or the like. Such advertising/marketing messaging can optionally be triggered in any manner, whether based on inferred interest or blindly, much as is done conventionally with any current or future marketing/advertising methods, and/or as can be supplemented by additional inferences of interest and qualification using the new forms of FP-related data described herein. All references to database access are meant to refer, in varying embodiments to any combination of databases specific to the seller/merchandiser and/or those across multiple sellers/merchandisers unless specifically indicated otherwise or clear from context, and the databases can optionally be accessed and stored in any appropriate manner, as described elsewhere herein. Such processes can optionally be triggered at varying levels of detail at pre-sale, shopping, and buying stages, or at any other time. It is also noted that while this figure presents the process primarily from a seller/merchandising and/or support service perspective, similar system and database support can also be provided to support the buyer aspects of offer solicitation, receipt, and analysis, drawing on any of the databases, including buyer-side versions and/or extensions of such databases, whether implemented on buyer systems or with support from other parties.

Using a potentially wide range of automated methods and data elements at various levels of depth and breadth described more fully below, available data relating to potential offers is assembled 502 from Databases 204, 310, 442-448, and/or any other source of data that can be relevant, including any elements described in Appendix A or others, and as in 503, all relevant buyer data from databases 204, 310, 442-448, and/or elsewhere (also described further below), selecting and using such data in accord with defined decision rules/algorithms, as described further below. Such data is used to perform a preliminary analysis 504, which can optionally cause details of the analysis and any revised or added pricing reputation scores or other information to be output as updates to the databases. This preliminary analysis can optionally involve all of the detail and variety of the further analysis 507 as described below. This analysis can determine 505 whether the buyer is a candidate for any FP offers, and if not, the buyer might be rejected 506 as a candidate for FP offers, and can possibly be referred to conventionally priced offers. A wide range of methods for such analysis are detailed below.

As discussed below, it is suggested that in some embodiments it can be useful to provide a high degree of flexibility, such as by providing facilities to specify rich algorithms and decision rules applicable for different products/services in varying contexts. However, to illustrate with one case, this can apply data processing and decision analysis based on the buyer's FP reputation history and application of rule-based logic as illustrated in Table 1, above. The determination of FP reputations as falling into the groups shown in the left column can be based on thresholds on a FP reputation rating scale. For example, such a scale can optionally be applied by taking various price points as being defined as high, average, or low. To facilitate comparison of price fairness for varied products/services, such price points can optionally relate to normalized prices. For example, for each product a seller can optionally set an average price expectation, and/or thresholds. Referring to the Example 1 presented below for a music sales service with standard prices of $0.99 per song (approximately $1.00), high pay can be specified to be $1.25 or more, average pay to be $0.70 to 1.25, and low pay to be less than $0.70. Given the offer aggregation in that example, of 10 songs in a first FP offer/pricing cycle, the average of prices for the first 10 songs can be computed, and the thresholds applied to that average. To account for the case of an album, which can optionally be at a fixed price of $10, it can be useful to normalize both song and album prices to a scale where the expected average price is one normalized unit. Thus for songs, the thresholds can be approximately as just stated (0.99/1 is approximately 1) but for albums the normalized price can be 1.0 as well. Thus an album price of $7 can be normalized to 0.70, and just qualify as average pay. The buyer can optionally be permitted to buy only a single album in the first cycle, and so that normalized price would be applied to the threshold. Putting this in more mathematical and algorithmic terms, a first stage of data processing can optionally be to compute a Transaction FP Reputation score (TFR) for the current buyer, which in this example can be computed as a weighted average of aggregated prices for a single transaction stage, normalized to an expected price scale, and adjusted up and/or down by discrete factors for offer and usage context, including any buyer value feedback (explanations, reasons, issues, justifications, etc.), which can optionally vary to reflect whether the data is objective, sensed, stated, subjective or whatever, as described in the following paragraphs and in further variations elsewhere below.

One of the benefits of this derivation of a TFR, and of other similar metrics discussed herein, is that it provides a way to quantify pricing behavior with regard to fairness and/or other FP criteria in a way that can be based in part on the price but decoupled from the particulars of the absolute price across a full universe of product types, buyers and sellers. For example, buyers can be assigned similar TFRs for similarly “generous” prices whether it is $0.01 for a routine news story or $10,000 for a sophisticated personalized analysis of treatment options for a serious health condition. Similarly a well off buyer can optionally be given a low TFR for a given FP price while a buyer of limited means can optionally be given a high TFR for the same price. Also, a full-service, high-touch vendor can optionally be judged to justifiably give a lower TFR for a given price for a given item than can optionally be judged as justifiable from a bare-bones supplier. Similarly, a buyer who explains high or low prices well can optionally be treated differently from one who sets the same prices with no explanation (and/or with unsatisfactory explanations). As described further herein, such computational methods derive normalized metrics, such as of fairness and/or other FP criteria, which can be applicable and comparable across a full range of transactions over a universe of products/services, and of buyers and sellers, and of contexts. Using such methods to look at pricing fairness, or other such criteria, based on metrics that provide this decoupling from price alone, enables considerations of fairness that can compare prices for apples and oranges . . . and diamonds, literally and/or figuratively—and thus can work with consistency across a full universe of items.

So, in a, first cycle, example, if a buyer had average prices for songs of $0.50 (normalized to 0.50) or a single album priced at $5 (normalized to 0.50 also) the decision rule can optionally categorize that buyer as low pay, and thus not eligible for FP offers. If a buyer had average prices for songs of $1.50 (normalized to 1.50) or a single album priced at $15 (normalized to 1.50 also) the decision rule can optionally categorize that buyer as high pay, and thus eligible for FP offers at any of the three product value tiers (looking across the table at row #1). Such tiers, for this music example, can relate to hit songs, versus other mainstream songs, versus back-catalog, older items, versus long tail content from obscure musicians or genres, all as pre-designated by the seller(s). This can optionally be specified in terms of a first level version of an Offer Acceptance Function (OAF) or Offer Discrimination Function (ODF), which can optionally be defined in terms of the Transaction FP Rating and one or more specified Thresholds (T).

Additional factors, such as the high or low zeros factor and the limited means factor shown in rows #3 and #4, can optionally be computed using a numeric multiplier factor to convert a raw TFR to an adjusted TFR. Thus a buyer with more than 4 zero payments out of ten songs can optionally have an adjusted TFR decreased by a percentage, say −50%, while a student can optionally be given an increased percentage, say +50%. Thus in the first case, a raw TFR average of 0.90 (that would otherwise qualify as average pay) can optionally be decreased to 0.60 (and thus categorized as low pay). In the second case, a raw TFR average of 0.50 can optionally be increased by 50% to 0.75, and thus qualify as average pay. Of course in this example, normalized thresholds, such as for high pay, are defined at 25% above the average value, or 78% (1.25/0.70) above the average pay threshold across all product types. To provide more flexibility in assessing pricing, an embodiment can optionally normalize with a more complex function, such as a piecewise linear scaling relative to breakpoint thresholds specific to each product type. For example, low pay can be normalized to the range of 0-1, average to 1-2, and high to 2-3 with respect to each product type, thus allowing for different breakpoints to be specified for each, which can optionally then be combined into a single numeric decision threshold using simple arithmetic. (In other words, for product type A, the high pay threshold can be specified to be 100% higher than the low pay threshold, and for product B it can be specified to be 50% higher, but once normalized, a price set on that threshold would be set to a normalized value of 2 for both product types.) As noted in the discussion of Example 1, the threshold values can optionally change as a buyer passes from a first buying/pricing cycle to subsequent cycles, thus applying different thresholds, different aggregation quantities, different product tiers, and/or the like.

As explained further below, adjustments of this kind can be made based on objective data that can be understood to account for, and thus implicitly explain, prices that are high or low, and/or based on buyer-reported explanations that are explicitly intended to explain the buyer's pricing to the seller. Such explicit explanations can also be based on objective data that might be independently verified, or on subjective data that might be harder to verify. Weighting and/or normalization methods similar to those just described can be applied to these explicit explanations provided from the buyer in much the same manner, once the explanations are expressed in a form suited for use in algorithmic processes, applying any desired data conversion, natural language understanding, and/or the like. For example, continuing the music example with more than four zero payments, the buyer might explain a zero payment for three songs as being because of poor sound recording quality, and for two songs as being because of the song not being to the buyer's taste. In such as case the recording quality explanation can optionally be considered more reliable and/or more subject to verification than the taste explanation, and thus affect the weighting differently. For example the −50% adjustment noted above can apply to taste explanations and/or no explanation, while this case of three zeroes being for recording quality can optionally be given a less negative adjustment, such as for example −20%. Also, as described further below, such explanations can optionally be further weighted based on aspects of a buyer's reputation, as developed by FP processes. In such an embodiment, a highly subjective explanation from a high-reputation buyer can optionally be adjusted downward less or not at all, or even adjusted upward, compared to the same explanation from a low-reputation buyer.

For buyers that pass this preliminary screen, further analysis can optionally be performed 507 to compute a fully adjusted TFR. This also can optionally access and apply all available data relating to potential offers from Databases 204, 310, 442-448, and/or any other source of data that might be relevant, including all relevant buyer data. Such analysis can optionally cause details of the analysis and any revised or added pricing reputation scores or other information to cause updates to the databases. Also considered 508 can optionally be offer criteria rules and any special issues. These analyses can optionally vary depending on whether the buyer was new to the particular seller and/or to all sellers included in a cross seller embodiment. Again, these methods can optionally apply data processing and decision analysis based on the principles illustrated in Table 1, above, and extensions and/or refinements thereof.

Again, as noted for the preliminary analysis stage 504, it can be useful to provide flexibility, such as by providing facilities to specify algorithms and decision rules for different products/services in varying contexts, but the same example can be extended to add additional factors and data, in a similar manner. For example, buyer FP reputation data from sellers other than the current seller can optionally be discounted, such as by computing a weighted average, with the current seller having a significant portion of the total weight. Similarly historical reputation data can optionally be included, but at discounted weight, such as, for example, by exponential smoothing. To account for new buyers, a standard presumptive entry score can optionally be used, and any available non-pricing data, such as for example demographic data, psychographic data, behavioral data, social graph data, and/or the like, that reflects positively or negatively on expected pricing behavior can optionally be used to increase or decrease that accordingly, to determine whether a threshold is met. Thus even for factors that might seem fuzzy and hard to quantify, computational methods can be applied to approximate a desired effect in a purely algorithmic process. This can optionally be based on any mixture of theory-based and/or heuristic methods. It is also noted that the two analysis stages, 504 and 507 onward, can optionally be combined into a single stage.

Once again, to put this in more mathematical/algorithmic terms, a Cumulative FP Reputation score (CFR) for the current buyer can optionally be computed along the lines described above, based on a function of the individual adjusted TFRs for that buyer, as well as other adjustment factors. For example, the individual TFRs can optionally be weighted, such as by exponential smoothing, and, in addition to the transaction level adjustments, more global adjustments can optionally be factored in. Such broader adjustments can optionally relate to buyer history with the current seller, and/or for any other sellers for which data is available, as well as to factors relating to the buyer, the products/services, the usage levels and contexts, and any other factors deemed relevant, and can optionally result in computation of an adjusted CFR. Adjustments of this kind can optionally be applied using any suitable algorithmic and/or functional form, such as, for example, positive/negative/fractional additive, multiplicative, exponential adjustment factors, factors based on statistical parameters, and/or other such factors/methods for adjusting a functional value based on available data based on specified rules, algorithms, and/or other quantitative methods. Such adjusted CFRs can optionally be used as a metric to characterize the buyer's FP reputation at a more or less general level, and can optionally be maintained in the Databases, along with details of the TFRs, as well as any and all of the component factors and input data. While it can often be useful to apply a previously computed value of such an adjusted CFR, or of any of the other computed values described herein, such as can be obtainable from one of the databases, it should be understood that such values can optionally be calculated and/or adjusted dynamically whenever it is useful to use an updated and/or variant form in a current FP process, such as to change the data and/or decision rules applied to better address the current need.

To apply this to a specific set of forward transactions, it can be useful to convert an adjusted CFR to a predictor for fairness (or other desired attributes) specific to those possible transactions, a Predicted FP score (PFP). This can optionally be done in a computation similar to that for the CFR, but one that weights data for products/services, usages, and contexts most similar/relevant to the potential offer(s) highly and those less similar/relevant lower, using computational methods analogous to those described there. Relevance/similarity can optionally be quantified based on any suitable pre-defined and/or dynamically derived computational/statistical methods, including, for example, specified categories, multi-factor analysis, clustering, correlation analysis, etc., as described further below. Such a PFP can optionally be treated as an estimator of expected pricing, and thus a primary metric to be to be used in a fuller version of an Offer Acceptance Function (OAF) in which it can optionally be compared to one or more Thresholds T in order to make an offer decision. Such Thresholds can optionally take the form of a set of Thresholds T(i, t), specific to the number of the transaction cycle, i (first, few, many, etc.), and/or the tiers, t (low, medium, high, etc.), and/or specific to other aspects of the process. Such OAFs can optionally also factor in metrics of PFP confidence, such as related to buyer variability, such as based on any of various statistical measures such as variances, standard deviations, skews, kurtosis, etc. Thus the OAF can optionally be specified as a function of PFP, product, context, T(i, t), and any other variables considered appropriate, again using weighting techniques and quantification methods of the kind described above and elsewhere herein.

A result of this analysis can optionally be a ranking of potential offers such as in order of desirability/value, and use of decision rules to select one or more of the highest ranked potential offers to be conveyed to the buyer system. While a high level of automation can optionally be used in some embodiment, other embodiments can optionally also provide for a determination 509 of specified criteria to identify situations in which human intervention in the offer management decision/analysis process was useful, and invoke special processes to support that 510, leading to possible recycling through 508 and/or other elements. Examples of defined situations that can optionally trigger human intervention can include recognition that the buyer has entered free text comments in a pricing form, such as described with respect to FIG. 6B, below (such as if it is expected that automated understanding of such comments might not be reliable, whether routinely, or in cases of automated understanding failing to meet some defined confidence level), determinations that automated decision processes cross some threshold of decision significance, such as where an offer value threshold is crossed positively or negatively (such as to limit the risk of buyer dissatisfaction at low-value FP offers or no FP offers, or seller risk related to high-value FP offers), and/or the like Such human interventions can optionally simply adjust component factor and/or value inputs to be used algorithmically against the specified thresholds in the usual manner, or can optionally fully override the standard automated processes to result in direct assignment of adjusted ratings and/or corresponding actions and/or direct control of offer ranking/messaging A selection of potential offers to make can optionally result 511, leading to the preparation of one or more offers 512, including assembly of desired framing information from the analysis and from Databases 204, 310, 442-448 and elsewhere. This can optionally include data processing in a wide variety of aspects and levels of sophistication, as described extensively throughout this disclosure. The offer and its framing and all relevant context is recorded back into any of the Databases. The offer, including any desired framing information, is sent to the buyer via buyer system using any appropriate buyer communications interface 514. A sample of an offer transmittal and acceptance form is depicted in FIG. 5B. Not shown are various other elements as outlined in FIG. 3, such as acceptance of the offer, fulfillment, usage, etc.

Some embodiments can optionally support a wide range of methods for generating, targeting, and distributing offers, including any of the methods applied for conventional marketing offers, now and in the future. An offer management dashboard and/or sets of wizards can optionally be provided as a user interface to seller staff for the specification of rule-sets, algorithms, parameters, and other aspects of controlling such automated decision processes, and/or for operational staff oversight and/or intervention as such processes occur. Such dashboards and/or widgets can optionally present a wide range of contextual information from the various FP processes and databases and external sources, including rich database tools and analytics, a wide range of tools to adjust decision rules, algorithms, parameters, thresholds, and the like, as well as facilities for direct control of operational activity, including control of offers, reputation ratings, buyer interactions of any kind, and/or the like.

Referring now to FIG. 5B, there is depicted in one embodiment a sample user interface form related to the process of FIG. 5A. This shows an exemplary screen layout for a Web form, app UI, or similar interface used to convey an offer and obtain user acceptance. It reflects selected elements contained in or assembled from databases in accord with Appendix A or other sources, and is consistent with the sample offer context further described in Appendix B. User interface elements shown include hyperlinks, drop-down selectors, free text entry boxes, check-boxes, and buttons.

Referring now to FIG. 6A, and with reference to the above and Appendix A, there is depicted a further non-limiting exemplary view of selected aspects of an embodiment of a pricing request preparation process 600. This process can optionally be performed on any combination of seller, support service and/or buyer systems. The pricing request can optionally begin by receiving notice of a price setting request initiation event with respect to a buyer, seller, and transaction (triggered by user side or seller side), based on time, usage, and/or other factors, or by human request 601. Based on such a trigger, the process would then build a transaction price setting request (as further described with regard to FIG. 6B), including assembling related data, including transaction offer framing data, usage data, and any other related context data from Databases 204, 310, 442-448 and other sources. This can optionally include data processing and decision analysis steps in a wide variety of aspects and levels of sophistication, as described extensively throughout this disclosure.

Referring now to FIG. 6B, there is depicted a sample user interface form related to the process of FIG. 5A. This shows an exemplary screen layout for a Web form, app UI, or similar interface used to convey an offer and obtain user acceptance. It reflects selected elements contained in or assembled from databases in accord with Appendix A or other sources, and is consistent with the sample offer context further described in Appendix B. User interface elements shown include hyperlinks, drop-down selectors, free text entry boxes, check-boxes, and buttons. As can be seen from the customized exemplary data on usage and reference pricing factors in this example, extensive and wide ranging data processing can optionally be involved in the preparation of such a pricing request.

Referring now to FIG. 7, and with reference to the above and Appendix A, there is depicted a further non-limiting exemplary view of selected aspects of an embodiment of a price data collection/reporting process 700. This process can optionally be performed on any combination of seller, support service and/or buyer systems. Collection/reporting can optionally begin with a price setting event 701, which can optionally be triggered by buyer action and/or seller request and/or some other event such as for example a time or usage threshold. Variations in such aspects as database access and trigger events and stages can optionally occur similarly to the variations noted with regard to FIG. 5. Also similarly, while this figure views the process primarily from a seller/merchandising and/or support service perspective, similar system and database support can optionally also be provided to support the buyer aspects of price setting and related analysis, drawing on any of the same databases, including buyer-side versions and/or extensions of such databases, whether implemented on buyer systems or with support from other parties.

Transaction pricing analysis is initiated 702, assembling related data including transaction offer framing data, usage data, buyer advisory data and seller advisory data from Databases 204, 310, 442-448, and/or any other source of data that might be relevant, including any elements described in Appendix A or others, and any information included with a price setting notice. (A buyer-side process can optionally also use data from buyer systems and databases.)

Pricing for the transaction can be evaluated 703. This can optionally first be based on the current transaction alone, computing a Transaction FP Reputation score (TFR) as described for FIG. 5A, but alternatively can be extended to combine with evaluating the price in the wider context 704, based on additional available data from Databases 204, 310, 442-448 and price setting notices and any other available sources. The buyer's reputation history can be assessed with regard to the current seller, and in some embodiments, with regard to all participating sellers as data is available, to compute a Cumulative FP Reputation score (CFR) as described before. These processes can optionally include data processing and decision analyses in a wide variety of aspects and levels of sophistication, as described extensively throughout this disclosure. Some embodiments can optionally also provide for a determination 705 of situations in which human intervention in the pricing evaluation process was useful, and invoke special processes to support that 706, with possible recycling through 703 and/or other elements.

On completion of the analysis 707 the Databases would be updated with the transaction pricing data, as well as any details of the analysis, and with revised and/or additional pricing reputation data and scores, to compute a further adjusted CFR. In some embodiments there can optionally be provision 708 for immediate pricing assessment feedback to the buyer system, such as in the form of a message or alert with regard to its assessed fairness and acceptability to the seller with regard to reputation and prospects for further offers. If so, the process can link to an immediate feedback manager process 710 to support further buyer-seller system dialog on this and record it in appropriate databases, and to recycle through the assessment elements as appropriate. Once the process is complete 709 the process can optionally end with acknowledgment to the buyer and any relevant final recording to databases. That data can optionally then be used in further offer management processes relative to further offers, whether synchronously or asynchronously to the price data collection/recording process, for example, as outlined in FIG. 3.

As noted for offer management, some embodiments can optionally support a wide range of methods for evaluating prices. A pricing/reputation/rating evaluation dashboard and/or sets of wizards can optionally be provided for the specification of rule-sets, algorithms, parameters, and other aspects of controlling such processes, and/or for operational oversight and/or intervention as such processes occur.

The example provided above is non-limiting, but the computation and decision methods just described in that context are illustrative of some of the kinds of quantitative methods that can be applied, with any suitable alteration and/or enrichment, to other embodiments. In the discussions of FP processes, prices, reputations, and decision processes throughout this disclosure, it should be understood that similar kinds of quantitative methods and/or metrics can optionally be employed, even where, for ease of exposition or otherwise, the particulars of such methods/metrics are not specifically noted. For example, unless otherwise indicated or clear from context, discussions of “FP reputation” might be generally understood as comprising quantitative methods, such as using a metric more or less similar to a CFR.

As noted above, in some embodiments similar kinds of automation and rule-based processing can optionally be provided on the buyer side, such as in the form of a shopping bot/agent. The buyer-side determination of whether to accept a FP offer can be automated to any desired degree, and such automation can be particularly desirable for routine purchases. In some embodiments, basic components of an automated acceptance can optionally be based on some or all of the following determinations, based on access to buyer databases and decision rules:
Whether an offered item is desired at all, such as based on shopping history, wish-lists, recommender systems, and the like;
What price and/or distribution of prices a seller is expected to accept as satisfactory, such as based on comparables data, fixed prices, reference prices, and the like,
What price and/or distribution of prices are expected to be warranted based on anticipated value to the buyer,
What explanations can be provided to the seller to justify any difference between the prices expected to be acceptable to the buyer and those expected to be acceptable to the seller;
Determining to accept an offer if it is determined that an acceptable transaction can be effected with results, including anticipated seller assessments of pricing fairness, that are desirable and not likely to harm the reputation of the buyer.

Such decision processes can optionally be implemented in a manner more or less similar to that described for the seller-side decision processes, and similarly supplemented by human intervention as desired. Other more advanced features of buyer-side shopping tools are described further below.

Expanded Features and Variations

Offers and buy decisions: FP offers can optionally be extended in a context that provides, as background to the buyer, a range of pricing reference data types extracted/computed from FP databases and/or other sources and transmitted to buyer systems, including, for example:
No information
Ordinary set-price information (whether as an alternate set-price offer, or purely as a reference)
Seller minimum price (but considering that this might tend to limit the market)
Seller suggested FP price (but considering that this might discourage higher prices and might discourage potential buyers)
Comparable history data on FP prices set by other consumers after purchase of the same and/or similar products. As the volume of this price history data grows over time, this “comp data” may provide a new and more accurate estimator of a given product's “fair market value”, and thus, can optionally be a valuable resource for guiding the behavior of both sellers and buyers in the marketplace.

In various embodiments, comparable FP price history data can optionally be presented at varying levels of detail. One version can be simple average price. Other versions can optionally offer rich statistical views of the price distribution, with or without data on related factors such as recency, relationship to disposable income, consumer subgroups such as casual buyers, serious connoisseurs, and professionals or business buyers, and relationships to other context parameters. Consumers can potentially be given access to any and/or all of the data and analytics available to merchants as described below (in some embodiments limited by concerns for privacy and control of proprietary data). Such reference data can optionally be available prior to a purchase, and might aid the consumer in deciding whether to elect an FP purchase for a product that might have a fair price well beyond its likely value to that consumer. Alternatively, such data can optionally only be provided after purchase but before price-setting (or not at all). Such data can also be available from third party support services, including those acting independently and/or in some affiliation with sellers and/or buyers.

Negative prices (with or without a cap) can optionally be permitted in selected contexts, such as when a seller wishes to add incentives for a trial that might be considered burdensome, or even harmful to a consumer (such as software that might crash a computer).

The same kind of information noted just above, for offers and buying, can optionally be made available at the time of price-setting and/or at other times.
FP payment history data and usage in merchandising
FP merchandising can optionally be based on very rich analysis of a very wide range of multifactor data, as described in this section and elsewhere below.
FP price history can optionally be analyzed by individual buyer/user and across buyer/users, by product and product segment or category, and buyer/user groups can optionally be segmented by various criteria.

FP price history can optionally be analyzed with respect to other factors usable for merchandising, including demographic and/or psychographic data and/or location data, shopping history (in terms of both browsing and purchases), potentially including full clickstream data, environmental and/or shopping context data, psychometric data such as fMRI, EEG, eye movement, sweat, pulse, etc., recommender system data (which might facilitate more accurate prediction of a consumer's value/pricing decision), social graph-related data, other kinds of reputation data and/or reputation systems, and/or any other current and/or future forms of data relevant to merchandising.

FP methods can optionally also be integrated broadly with other merchandising and marketing processes, including customer relationship management (CRM), customized messaging systems, and/or loyalty programs, as well as with billing and subscription management systems, including the offer management components of such systems. Similarly, FP methods can optionally also integrate with production management systems and other aspects of business operations. Opportunities for integration can optionally include integration with enterprise resource planning (ERP) systems, which typically include production data (including materials requirements planning, including inventory, bill of materials processing, scheduling, and logistics) as well as sales data and a wide variety of other data, and can optionally include pricing analytics that relate to various market contexts and data sources. Integration can optionally be with a content management system (CMS), as a related aspect of an ERP system in a digital content environment. It should be understood that “analytics” may, depending on context, refer herein to the analytical methods, the results of those methods, and/or the software components that can optionally embody such methods to produce such results, such as Web services, modules, plug-ins, or the like.

Many of the data processing, analysis and decision methods described herein can generally be understood as applying predictive analytics to FP price history and/or the other kinds of data suggested. Aspects of predictive analytics that can be useful include, without limitation, predictive models, descriptive models, and decision models. Relevant methods can optionally be adapted from related applications such as, for example analytical customer relationship management (CRM), collection analytics, cross-selling, multichannel customer experience management, assortment optimization, placement and design optimization, in-store and/or virtual store behavior analysis, customer micro-segregation and/or personalization, customer retention, direct marketing, location-based marketing/advertising and geo-targeting, sentiment analysis, retail business intelligence, fraud detection, and/or the like. Statistical techniques that can be useful in such methods include, for example, regression techniques, discrete choice models, time series models, survival or duration analysis, classification and regression trees, multivariate adaptive regression splines, machine learning techniques, artificial intelligence, neural networks, fuzzy logic, and/or the like. Various existing analytical tools can optionally be applied and extended to address these methods, and standard languages, such as for example, Predictive Model Markup Language (PMML) and/or other languages, such as others based on XML, can optionally support their use and data interchange. Similar standard languages, such as those based on XML, can optionally be used to support the interchange of FP history data and other supportive data among various sellers and services as described herein. A variety of statistical and/or optimization and/or data mining and/or data processing and/or machine learning, and/or business intelligence, and/or other similar methods can optionally be applied to various aspects of FP processes. A non-limiting recap of some of these include function approximation, predictive modeling, regression analysis, spatial analysis, simulation, Monte Carlo techniques, signal processing, time series analysis/prediction, structural modeling/decomposition of series into cyclical, trend, seasonal and residual components, data fusion, data integration, fitness approximation and modeling, classification, including pattern and sequence recognition, novelty detection and sequential decision making event stream processing, filtering, clustering/cluster analysis, blind source separation, compression, process monitoring/modeling/control/management, association rule learning, market basket analysis, supervised learning, unsupervised learning, ensemble learning, natural language processing (NLP), sentiment analysis, neural networks, genetic algorithms, A/B testing and A/B/N testing, network analysis including social network analysis, visualization, tag clouds, clustergrams, history flow, spatial information flow, crowdsourcing, and the like. Such methods can generally be useful to selectively reduce the risk of Type 1 errors (false positives) and/or Type 2 errors (false negatives) in FP offer decisions and/or related FP processes. For example, such methods can optionally be applied to emphasize reduction of false positives for high value offers, such as to reduce FP credit risk, and/or conversely to emphasize reduction of false negatives for low value offers, such as to increase market reach, and/or to achieve a balance of both.

It should be noted that the use of the payment history data can optionally take a variety of forms, ranging from use of a single metric, much like a credit score, to detailed analysis of the kind of fine-grained data described here, using rich data mining, statistics, and multi-factor/multidimensional analysis methods, including such techniques as multidimensional screening, demand curves, parametric utility methods, and/or other current and/or future analytic methods that might be relevant to merchandising data and decisions.

Such data usage, of course, can optionally be done with varying levels of privacy and data protection to control what information about a consumer is available to what seller entities, and managed under what security and authorization methods. The consumer's acceptance of FP purchase offers can optionally involve a waiver of certain privacy rights, and such waivers can be standard or subject to negotiation.

One of the methods that can be expected to be useful in conjunction with such a merchandising strategy is to combine the FP data with the other merchandising data to predict which products are most likely to appeal to which consumers. Those products/consumers can presumably be favored as candidates for FP offers, anticipating relatively high pricing compared to fixed price, especially for consumers known to pay well for desirable items.

Conversely, a market-expanding strategy might be expected to be valuable, especially for virtual or other low marginal cost items, where FP offers can optionally be made to those who would ordinarily not be inclined to buy a given product. With FP, the riskless purchase opportunity might encourage consumers to try the product. Even if the FP prices that result are low (even with zero in many cases), the increased volume of sales might be expected to increase net revenues and profits.

This feedback/reporting/selective merchandising process can also be valuable with other payment models, including fixed price with a free/money-back provision, or other variations on more conventional pricing in cases where feedback on buyer fairness can be useful to qualify the degree of trust to place in the buyer. For example a fixed price sale can optionally allow for a free price (like a money back guaranty, but without requiring a return) if the product is not satisfactory, and use the feedback to limit such offers to those who have established a reputation for fair use of such offers.

Similarly, while the above descriptions primarily referred to embodiments in which the price is committed only after delivery, these feedback/reporting/selective merchandising methods can optionally also be used in embodiments with a different sequence, such as set price and/or pay before delivery, including cases that can include giving a commitment to allow partial or full refund after sale.

As was noted above, these methods can be applied to brick-and-mortar shopping in addition to electronic marketplaces. A development that facilitates such methods is the growing use of smartphones with location-based shopping services. Based on the above discussion, it will be apparent that smartphone apps or other similar personal agent software facilities can readily be adapted to interface will seller systems to present FP advertising and sale offers to consumers while in or near a store, to commit the purchase, and to feed into subsequent stages of the FP commerce processes.

While FP methods can be used in varying forms by individual seller entities, the richness of these methods can be much enhanced in embodiments based on sharing of FP feedback history data and related data and support processes across multiple sellers. Numerous advantages might be gained by applying a larger, common pool of feedback data to assess buyer reputation, and by drawing on shared support services, databases, and infrastructures. Sellers can optionally be able to draw on more or less extensive reputation/history data, even for buyers that are new to that seller, but who have a history with other sellers. Offer decision processes and criteria for buyers can optionally depend on whether they are new to a seller and the network (possibly treated as higher risk) or new to the seller but known to the support network (possibly treated as relatively lower risk). Sellers can optionally treat data from their own interactions with a buyer as most reliable and/or relevant, but can optionally give significant weight to third-party experience data as well. Such shared support services might make FP methods more attractive to even the smallest seller entity, including individuals as sellers. Such offerings can optionally take the form of FP platforms, offered with varying degrees of interoperability and/or deep integration with other related business and related support processes, both within and across businesses, and with individuals, on both sell and buy side.

Further to the discussion of buyer purchases contexts above, the context of buyer-seller relationships can optionally be similarly considered in merchandising/offer considerations. In a multi-seller FP data collection environment, rich data on how buyers behave with respect to different sellers might be available, and such data can optionally be analyzed to assess patterns regarding specific sellers and/or categories of sellers, and to apply that in the FP decision processes. For example, a given buyer might behave differently to a seller that is viewed favorably with regard to any of a variety of considerations versus one viewed neutrally or negatively. Such factors might relate to the seller reputation and/or image, again at particular seller and/or category levels. Just as buyers gain a FP reputation for their pricing levels, in terms of fairness and other criteria, sellers can optionally be viewed in terms of the differential effect they have on such pricing behavior with respect to their buyers, relative to how those buyers behave with other sellers, as a kind of reputation for favorability, likeability, responsibility, deservingness, and/or other dimensions that affect buyers' willingness to compensate them, using a variety of explicit/implicit data sources and analysis methods of the kind described herein. Such seller variations can optionally be applied to adjust/normalize CFR inputs and/or other reputation data for a given buyer relating to that seller for use relative to other sellers. Third-party services that collect and evaluate such data can optionally be oriented to serving sellers, buyers, or both. With the availability of such seller reputation data, an additional level of sophistication can optionally be applied to the assessment of buyer pricing decisions. Sellers can optionally consider how a given seller tends to behave to other sellers having similar reputation contexts, and can optionally weight such behavior higher than behavior with different kinds of sellers. Such seller considerations can optionally be tuned to the behavior of individual buyers with respect to seller categories, or can optionally be generic to general populations, or to categorized or clustered sub-populations. Sellers receiving low or high willingness to pay scores can optionally adjust their expectations of buyers, and thus tune their offer policies, accordingly. Thus a very rich multi-factor analysis and offer decision process can be applied to assessing how a given buyer might behave with regard to a given offer from a given seller, in a given context with regard to other variables. Additional information regarding the behavioral economics and related factors that relate to managing this decision process are included below. Note also that such cross-seller data analysis can optionally be applied to support buyer decision processes, as well, as described elsewhere herein, such as for example for vendor selection.

Implementation Considerations

To summarize some elements of exemplary embodiments: Computer-based infrastructures can be applied to facilitate the above described methods and apparatuses to serve sellers, consumers, and infomediaries, as well as other service providers. Such computer-based infrastructures can optionally include any or all of the following capabilities, whether in distinct subsystems, or in various combinations:
find/make sale/purchase offers,
negotiate terms,
commit to sale,
fulfill sale,
request payment (price)/decide on payment (price),
effect payment (price-setting),
report on payment (price, with fine grain context information),
compare to other consumers and/or vendor objectives,
build consumer payment (price) record,
derive pricing rating (reputation)—by category/factor/context,
use pricing reputation as input in offering algorithm,
manage feedback in application to repeated cycles (e.g.: recursively).

Exemplary system components can optionally include rich service interfaces including:
Buyer Interfaces and support services (possibly including human user interfaces and computer-computer interfaces, such as APIs, such as with XML support)
Seller Interfaces and support services (possibly including human user interfaces and computer-computer interfaces, such as APIs, such as with XML support)
Selling Services, including support for pricing offers by product/consumer (possibly including human user interfaces and computer-computer interfaces, such as APIs, such as with XML support)
Payment Level Reporting services, including analysis and data interchange (possibly including human user interfaces and computer-computer interfaces, such as APIs, such as with XML support or other database access and analysis interfaces)

Exemplary variations can mix centralized services with a rich, distributed ecology of service providers, sellers, and consumers. This can optionally be facilitated using rich Web services and allow multiple players to collaborate, share, interchange, aggregate, etc. This can optionally support a rich ecology, diverse technical approaches, and any or all combinations of the service interfaces above and/or others, and can optionally include:
Competitive selling services
A common reputation pool, whether centralized or distributed
Competitive reputation services
And/or other support services.

Some variations can integrate with credit reporting/usage reporting services, due to such factors as having related elements, to achieve economies of scope and/or scale, or alternatively can duplicate many similar elements in such services, depending on context and objectives. Also, as noted in other sections, these computer-based infrastructures can be more or less tightly integrated with any or all of the related systems and databases relevant to merchandising, sales, usage, and production, including, for example, advertising and marketing communications, offer management, customer relationship management, billing and collection, usage reporting and analysis, inventory (or content management), production, distribution, logistics, and the like. Note that services and corresponding databases can optionally also be embodied as hierarchies. For example, in one embodiment, sellers can have relevant systems and databases, as can aggregator services that serve multiple sellers, as can reputation database services that serve multiple sellers and/or multiple aggregators, as can other services that participate in such a market ecology. Such distributed systems and databases can have varying degrees of openness or restriction relative to the other parties.

FP Pricing for Bulk, Aggregated, or Subscription Sales—Web Content Example

In one implementation, the price-setting process may be sought to be made as effortless as possible. That becomes relatively more difficult as the relative unit-value of the product/service declines with regard to the unit-magnitude of the product/service, e.g.: for fine-grained products/services, since the effort to set a price does not reduce proportionately. Examples include Web pages, single plays of songs, phone calls, and the like.

One effective solution for such cases is to bundle such products/services to be priced in bulk or aggregate, or to offer subscription access, “all you can eat plans,” and/or the like, with FP pricing decisions made at such a level of aggregation.

In such cases, one variation that can be exploited due to the post-sale nature of FP methods is that the composition of such aggregations can optionally be defined after the fact. For example pricing of Web content services is difficult, not only because of the convention of free services (supported by advertising, freemium models, or just hope that a business model will emerge), but also because it is difficult to get users to pay subscription fees when they are unsure of usage levels and value to be obtained. With many embodiments of the FP model as described herein, the pricing decision is made after the value is received and known. Applied in this example, a Web content site can optionally allow users FP access on the basis that they get a usage report at the end of a period (e.g., as shown in FIG. 6B), and are asked to agree to pay a fair price for that usage. Such a report can optionally be in the form of a statement including arbitrary levels of detail that the consumer can drill-down into as desired, to remind the consumer what usage was made, with details of dates and times of usage, and specific Web pages or other resources viewed. Such reports can be weekly, monthly or quarterly, or at other fixed intervals, depending on what was found to be most convenient and effective (considering effort, recollection, and value in question), or at variable intervals, such as intervals based on usage events or usage thresholds. Again, it can be expected that such risk-free pricing schemes can bring in consumers who would not otherwise use the service, and lead them to pay a more or less fair price for the services actually used. For example, it is generally assumed that the Wall Street Journal's Web site requirement of a subscription payment (over $100 per year for Web-only) discourages many casual users from using that site. With a FP access arrangement, many of those users might try a few articles and pay a fair price for them—and some of them may come to rely more and more on the site. This might add revenue without compromising existing customer revenues.

Thus, this kind of bulk FP pricing might offer a very significant increase in the profitability of digital content services. It is well known that many publishers are suffering from severe profitability problems, and that current advertising-based models are under great pressure, and the now-established consumer expectation of free Web services seems to make profitability very elusive. Under the FP model, consumers may be far more willing to pay a fair price for Web content. The methods described above can optionally be applied to incentivize payment, extending FP offers to those who make appropriate levels of payment, and, alternatively, requiring advertising, payment, or other disincentives to those who fail to do so. Instead of a rigid “pay wall” between free and paid services, FP methods might facilitate a much more flexible range of payment options. FairPay can optionally be framed as a revocable privilege offering greater price flexibility: those who pay fairly, can optionally be permitted to rise above the pay wall—those who do not, can optionally be forced to face its rigidity. From this perspective, the offer process might be understood as being gated—offers are made selectively, depending on the buyer's reputation.

While, in some embodiments, the coupling between FP pricing and future FP offers can be more or less indirect and non-immediate in many cases, it is noted that some embodiments can close this feedback loop more tightly and directly in some cases. For example, in a repeating subscription service, feedback on FP price setting for a usage cycle just ending can be coupled more or less immediately to a decision as to what FP pricing offers, if any, are to be extended to that subscriber for the next cycle. Further variations on such methods can optionally give buyers increased visibility into such decisions, and can for example indicate what renewal offers can be expected based on possible alternative pricing actions. Some such variations can to a greater or lesser extent give the effect of a buyer-seller negotiation relating current pricing to future offers. In some such embodiments, buyers can be permitted to adjust an FP price they had already set for a given period, with the intent of getting a more desirable offer for future products/service than an offer they had since received based on the first price. In embodiments with a rich negotiation capability, buyers can optionally be permitted to set “offered” FP prices for a cycle just ending and receive in response a follow-on FP offer for a next period that is contingent on making that “offered” FP price become an actual set FP price for that prior cycle. It is noted that similar forms of tight coupling and negotiation can optionally be applied not only for recurring subscription cycles, but for any other kind of series of purchase offers (as discussed further below).

To better clarify the cyclic process as described herein, in some embodiments (with or without price negotiation of the kind just described), pricing can remain backward-facing (and at the buyer's discretion), in that such a price negotiation leads to buyer agreement (if he so accepts) on a negotiated price for the cycle ending, but does not constrain the buyer's freedom to set a new and different price at the end of each following cycle, based on the conditions relevant to that cycle (with prior prices, whether negotiated or not, as just another input factor into each new pricing decision). Thus, in such embodiments, pricing faces backward for each transaction cycle, to be decided by the buyer post-sale (possibly considering advice from the seller), while renewal offers face forward from one cycle to the next, to be managed by the seller after each sale transaction and before the next. In such embodiments the buyer's post-sale PWYW privilege potentially continues in all future cycles, indefinitely (until either party chooses to end or modify the process). Maintaining these characteristics might potentially allow both parties to find the best current terms to maximize their ongoing value exchange—and to adapt as the details of that value exchange change over time.

Expanding on exemplary details of the alternatives that can optionally be provided, an advertising-supported service can optionally have varying levels of ads, offered in combination with various pricing alternatives, or instead of other pricing alternatives to a given user. These can optionally include:
Free with varying levels of ads (from none to heavy)
FP with varying levels of ads (from none to heavy)
Fixed price with varying levels of ads (from none to heavy)

An exemplary approach to incentivizing good FP subscription pricing can be to selectively offer FP subscriptions, with the alternative of fixed price or advertising-based alternatives to those not offered FP pricing, much as described above, but adding further sophistication to the ad-supported alternative. For example, ad-supported users can optionally be tracked to see what level of usage they make of the service, and light users given relatively few ads to encourage trial use, but heavier users given relatively more ads, to encourage a paid alternative. Such gradation in advertising placement can optionally add further incentive to FP buyers to seek to maintain their FP privileges by pricing fairly, since they might be heavy enough users to otherwise be faced with undesirable levels of advertising. It is noted that such variable advertising models can optionally be used to incentivize fixed price paid subscriptions as well, independent of any FP offers. It will be understood that this kind of variable advertising might be most effective in conjunction with any available methods to uniquely identify users (with more or less confidence), to make creating new user identities or aliases (and thus get the low-advertising rate service) difficult or impossible. Detailed methods for defining and effecting desired levels of advertising applicable to different product categories (such as text, audio, and video in various forms), and the various relevant advertising formats, with respect to key parameters including revenue and intrusiveness, will be apparent to those skilled in the art based on the teachings herein.

In addition, there is reason to expect that FP pricing models might be largely self-regulating, in that embodiments of the kind described herein can automatically adapt to changes in economic conditions, market environment, and product and usage changes in a way that retains near-optimal behavior.

Physical Products, Returns, Open-Box Specials, and Used Merchandise

In the case of real physical products an FP pricing model can be expected to lead to increases in products delivered, but not put to use. This might result in a seller cost, and raises issues of how to handle returns.

Conventional merchandisers often offer very consumer-friendly return policies to encourage sales and maintain customer satisfaction. Such policies sometimes allow consumers to make free returns for full credit, resulting in high cost to the seller. Under FP, the consumer might have less incentive to make returns, since they can simply pay little or nothing, which also has a cost to the seller. A major incentive to actually return an item in a FP sales context might be the buyer's desire to maintain a good FairPay rating, and that incentive might be of reasonable effectiveness. In other embodiments it can optionally be desired by seller and buyer that items not be actually returned in order to be credited as if a return had been made, such as for example in cases in which the seller would obtain little or no value from an actual return. In such cases methods can optionally be applied to provide evidence to the seller that the buyer has destroyed the item or that is otherwise no longer in a state in which it might deliver value to the buyer who has effectively or virtually “returned” it in some manner. This can optionally be facilitated using any suitable form of usage tracking instrumentation, as described elsewhere herein, and/or by providing some evidence that the item has been destroyed and/or rendered inoperative and/or is expired/spoiled, and/or otherwise not suited to use or resale.

Another method for addressing the issue of returns can optionally be to exploit the economic value of returned merchandise with a model similar to that used for “open-box specials” in physical stores, and also similar to the offering of used or reconditioned merchandise at discounted price. Under a FP model, such returns can optionally be considered as “credits” and positively affect the FP reputation for those who do make the returns. Similarly, comparative FP prices for purchase of items that were previously returned by other buyers can optionally be categorized as such, and that can optionally reflect an understanding that open-box, used, and reconditioned items have lower fair market value. Thus products identified as returned can be offered as such (open box specials, specified condition categories/levels, etc.) on a FP basis, and so be priced by the consumer to reflect a corresponding discount. Here again, FP has the advantage of allowing the consumer to set the price after verifying the condition of the item, thus eliminating the risk of overpaying, a risk that is often an especially strong disincentive to purchasing items that are not new. Price tracking can be applied with regard to identified categories/levels of product condition, and can provide corresponding data on which consumers pay relatively well for the various categories, so that offers can be targeted to them or not, as deemed appropriate. Such methods might greatly enhance the market for such returned items, with benefits to consumers, sellers, and the economy as a whole (reducing the waste of serviceable products). It will be apparent that such methods can optionally be applied by ordinary merchants (such as Amazon), by merchants that specialize in used merchandise, and/or by marketplaces in which individual buyers and sellers conduct transactions (such as eBay).

Further Comments on Cost and Value and Data Validation

On the consumption side, using the proposed methods, prices can optionally be set by buyers based on a perception of value received, with consideration to problems such as quality of the item and/or related support services. Reflecting that context, a wide variety of data and analytic methods can be useful in informing and understanding specific FP price-setting behaviors to reflect such considerations. Such methods can optionally be applied by buyers and sellers, alike.

On the production side, production decisions can optionally be based on expected prices, costs of production, and expectations of the value added by the production. Given that, a wide variety of data and analytic methods can be useful in informing and understanding specific production and FP offer behaviors.

In support of both consumption and production sides, it should be understood that third party services can optionally be useful in a variety of ways to assist in providing data, analyzing data, correcting data, and interpreting results. It can be useful for buyers to have more or less full access to their raw and summarized data, and to have processes for disputing data as they see fit. Such dispute processes can optionally provide for entry of explanatory data relating to issues of value received, quality, service, repairs, problems, seller behavior and commitments given to induce the sale, and/or the like. Third party reporting services can optionally interpret and adjudicate such disputes and report the results of that process as well as reporting the raw data as provided by the buyer and seller, in an effort to minimize abuse or distortion on either side. Such dispute mechanisms can optionally provide for detailed explanations from buyers and counterstatements from sellers to be available for perusal, and/or for third party adjudicated distillations (using any combination of human and automated processing) of such details to be available, and such distillations can optionally be factored into FP rating scores, such as to produce adjusted CFRs and/or other adjusted FP data for use in FP decision processes, whether for use by an involved seller to adjust its own decision processes, or for other sellers to adjust for data from an involved seller. Again, such methods can be entirely automated or can optionally apply some mixture of automated and human decision processes, using methods of the kind discussed elsewhere herein. Sellers can optionally be permitted or required to withdraw ill-founded negative reports.

Similarly, if production cost data is to be made available to buyers or other sellers in raw or processed form, third parties can have a useful role in adding value to that data as well. For example, if buyers are provided cost data as an input for their price setting, third party analyses can in some cases be useful to validate and normalize such data. Again, such third party involvement might minimize abuse or distortion on either side.

FP Pricing and Economic Utility

Contrary to the long-standing conventional economic wisdom that “utility could not be measured or observed directly” (as stated by economist Paul Samuelson), it is suggested that FP pricing methodology might allow the FP price to serve as a very accessible, robust, and observable metric of utility across a wide range of products and services. It can be taken to effectively measure the perceived value, as perceived by each buyer, under circumstance that might tend toward maximum accuracy. This might produce an observable metric of utility, possibly denominated in dollars (or whatever currency), “U,” that can match supply and demand. It should be understood that FP prices may differ conceptually to some degree from pure utility as defined in economics, because buyers might not wish to yield the entire gap between seller cost and full utility to the seller, but instead can optionally choose to keep some surplus portion of that value difference for themselves. In such a case the FP price can optionally be somewhat lower than the total value or utility to the buyer. The magnitude of such a surplus retained by the buyer might be expected to vary from buyer to buyer, and, for any given buyer, to depend on the seller and the transaction/use context, but nevertheless, FP prices might still be a very effective surrogate metric for an ideal economic utility value. The near-realtime (possibly minutes/hours/days/weeks) feedback of FP also might facilitate rapid movement toward this optimum matching of supply and demand.

From this perspective, it is suggested that production planning, marketing, and sales activities might be optimized to maximize profitability using FP pricing, with an expectation that such results might be near optimal not only for the producer, but for the buyers and the economy as a whole. This might provide a reasonable approximation to Pareto optimality (in economic theory). Use of FP prices as U might thus be more useful in economic analysis than measures such as profit, revenue, or margin based on fixed prices. Accordingly, an objective function based on FP as U might be the most effective guide to managing a business, both for its own success, and for society on a system-wide basis.

In applying these methods it will be apparent that FP U can optionally be related to costs, to give a metric of cost-effectiveness, U/cost (Upper unit of cost), or some other function of U and cost (such as U-(unit cost)). That can optionally be done in ways that reflect the effects of both fixed and variable costs, and be further adjusted to reflect time-value-of-money and other basic economic factors. At an aggregate level, this can optionally be sought in terms of U/cost, as a measure of a utility multiplier, while at a micro level it can optionally be sought in terms of U-cost, as a measure of unit or marginal utility.

Producers can optionally particularly seek to exploit sweet-spots in the gap between cost and value, placing particular emphasis on offering features and/or performance attributes that are positioned to take advantage of regions of the product configuration/performance space that bring large increases in value at modest increases in cost, and to find domains in which low costs yield high values. Such considerations can optionally be optimized with regard to customer segment as well as product configuration. Thus, these methods can optionally drive learning processes on the production side that collect data on both costs and received prices to provide data to provide direction on how to manage product configurations/performance to maximize this gap. This can optionally be structured as exploration of a multidimensional space of product attributes and performance. Given digital products or other mass-customization situations, producers can optionally experiment with product attributes and price feedback in this multi-dimensional space, to better drive production processes, and to favor offerings that have the largest gap between cost and received price. In contexts where production and offers are fully automated, this can optionally take the form of an automated optimization process. Supplementary to that, human managers can optionally work at a layer above that to find opportunities to expand and alter the automatic production processes, as opportunities (sweet-spots) are discovered.

With regard to pricing of services, it might be expected that fair pricing for services might sometimes be more difficult and subjective than fair pricing for products. It might be harder for both buyer and seller to predict value in advance, and that might increase risk of pricing surprise. That might have positive as well as negative aspects. A positive might be that the FP price as a utility metric, U, might be even more important to producers of services, as a way to reduce pricing risk and/or to optimize production and sales decisions.

Characteristics that might benefit especially from FP methods might include products/services involving delivery of a complex product or service, persistence of ongoing relationships, access to ongoing feedback, and/or availability of an opportunity to readily adapt to FP pricing feedback. Some non-limiting examples of services that might have such characteristics are customer service/support, travel agents, brokers/advisors, and doctors and other health/fitness services providers. Generic FP-transaction service support platforms can optionally be adapted to more particularly support such service businesses.

For both services and products, it is apparent from the above that a business management platform that provides rapid feedback based on FP pricing might be very useful to both operating staff and senior management as a management/operational tool.

Another area for application of such FP data, in addition to the consumption side processes noted earlier, and the production side processes just outlined, can optionally be in the related area of market research and associated marketing, advertising, and sales efforts. This can optionally relate to both third-party data and analytic support services, and/or tasks that face buyers and sellers. It will be understood based on the foregoing that FP data can be a significant class of consumer profiling data that can optionally be used similarly to and in addition to existing forms of consumer profile data. Similarly such other data can optionally be used in conjunction with FP data in the FP offer decision process.

A helpful perspective on these methods is in terms of “the experience economy,” the recognition that beyond the simple view of products and services that may increasingly be commoditized, there is a more customer-centric view of “experiences” and/or of “transformations.” Rich, compelling consumer experiences and/or transformations are understood to be co-created by the interaction of consumers and producers. From this perspective, FP pricing, and the related feedback cycles described above can optionally be interpreted with respect to experiences/transformations, using appropriate metrics, and an objective function for optimizing production, selling, pricing, and other aspects of a business can optionally be defined, in part, in terms of various metrics of such an experience/transformation. Such metrics can optionally include those that relate to customer feelings and to customer transformations, and/or other aspects of an experience.

Another helpful perspective is from the concepts of a “process centered organization” or “process centered management,” in which management is based on optimizing processes, not just tasks, with a goal of creating value for the customer or end user. From this perspective, the FP pricing methods described herein can be viewed as a new way to define and conduct a pricing process, and to enhance its role in business optimization as a process that aids in customer value creation.

A further aspect of utility relevant to FP processes is the concept of “procedural utility” as described by Frey, Benz, and Stutzer in “Introducing Procedural Utility: Not Only What, but Also How Matters (Journal of Institutional and Theoretical Economics, September 2004, pp. 377-401). This suggests that people care not only about what they get but how they get it. In terms of commerce, the implication is that what is valued is not just the thing bought, but the entire process of shopping, and not just the price, but the process of setting the price. From this perspective, the participative and collaborative pricing process described herein can offer significantly increased procedural utility over conventional fixed pricing. FairPay can increase consumers' procedural utility by building much more positive commercial relationships, producing more satisfaction and loyalty, even if not always the lowest prices to the consumer. Thus, measurements of procedural utility can optionally be used as metrics to be tracked and applied to the meta-processes involved in designing and managing specific applications of FP methods and decision processes to specific commerce contexts, for specific buyers.

Further Variations and Economic Effects

It will be apparent from the present disclosure that FP methods are readily adaptable to “unlimited” or tiered pricing plans, which are very popular for removing the “penny gap” in which any set price, even as little as one cent, is a psychological barrier to purchase. This “penny gap” is also suggested as a reason why micropayments have failed to gain wide acceptance. Variations on unlimited and tiered pricing models effectively aggregate purchases and allow truly unlimited use (over some interval), or use up to some tier level. Consumers seem to like aggregating purchases this way to avoid the psychic cost of deciding on small purchases or using services with the nagging awareness that a ticking meter is running up costs.

It will also be apparent that FP methods can optionally be applied to take on characteristics of a wide range of other pricing models as well. These can optionally include effects of usage pricing, tiered pricing, multi-component pricing, including those having combinations of fixed and/or variable elements. As explained below, FP processes can optionally provide ability to adapt toward a nearly unlimited degree of dynamics, differentiation, and richness in setting prices on any desired basis. This can optionally facilitate pricing models that have previously been too complex for practical use in conventional pricing processes to become tractable for FP processes using the quantitative methods and decision processes disclosed herein. Similarly, a range of granularities can optionally be accommodated. Pricing can optionally be done at levels of aggregate transactions and sub-transactions (such as a price for a bundle versus individual items/units comprising a bundle, versus components/sub-units of an individual item/unit and/or the value delivered by an item. Such details are often avoided as too complex and confusing to apply in conventional pricing models and likely to generate buyer resistance, but can optionally be suggested in offer framing as factors to be considered to the extent desired and considered relevant and fair.

FP unlimited or tiered aggregations can optionally work much as for unit sales, exploiting the price-after-use feature to reduce buyer risk. Such aggregations can optionally be offered by single producers, and/or by aggregator intermediaries that bundle products/services from multiple producers. FP pricing can optionally be set periodically, at a frequency that is convenient while allowing a reasonable level of responsiveness to changing utility. For example prices can be set annually, but paid monthly, with monthly prices continuing at the rate set near the end of the first month until a new price setting at the anniversary. Just as with unit FP sales, the sellers can optionally withdraw or adjust new/repeat FP offers should the prior FP price set by a given buyer not be satisfactory. In such an annual pricing/monthly payment example, the seller can optionally be given the option to withdraw the offer after a single month, or only after the full year. Similarly, buyers can optionally be given the option to adjust prices during the year, or to notify the seller of their intent to adjust their pricing for the current year prior to renewal of the FP offer (and prior to the seller's renewal decision process).

In one embodiment, such bundling can optionally work much as cable TV operators bundle TV channels. On large scale, bundles can optionally provide for “run of the Web” or similar pricing across a broad cooperative aggregation of producers. As noted before, one model for this can optionally be to allow access to sites that ordinarily carry advertising to be seen on an advertising-free basis when accessed under the terms of an FP aggregation offer.

It will be apparent to one skilled in the art that the detailed methods and systems for such FP aggregation pricing can optionally be implemented as a wide variety of selective combinations and/or adaptations of the FP methods described above with the various methods of aggregated distribution generally used with conventional payment schemes, and such new variations as will be apparent based on these teachings.

A useful convention that can optionally be applied in FP schemes is the idea of limited casual use at no charge as being a generally acceptable practice. This can optionally work as an understanding that some low level of usage can be taken as a form of free sampling, and that paying nothing for that can optionally be accepted practice, and can optionally be understood to not detract from a consumer's FP pricing reputation. For example, a Web site (like the Wall Street Journal) that now requires a set subscription fee for use can offer FP pricing on a broad basis, and can optionally accept moderate levels of use at no charge as an accepted sampling or marketing cost, with the expectation that those who try more than a modest amount will feel obliged to pay a fair price. Again, the power of the FP methodology is that there is feedback that can be used to incentivize fair behavior, and to eventually penalize those who are judged to abuse that privilege.

To facilitate the understanding that reasonable levels of sampling are acceptable, and reduce pricing burdens, it can optionally also be made a convention that FP sample buyers need not even take any pricing action, not even to set a zero price, if they wish to have it inferred (after some set time) that their usage (and their failure to price that usage) was viewed by them as being within reasonable sampling limits. Such a convention would further avoid a pricing burden, as analogous to the effect of the “penny gap.” Should the seller determine the level of sampling to be beyond a threshold of concern, after an appropriate time, a polite reminder can optionally be sent to prompt users to pay, explain, or risk negative feedback and loss of the privilege of further free sampling.

FP pricing can optionally be applied to expand the flexibility and reach of sampling, in that conventional sampling is generally offered to selected potential buyers identified by some method that might miss significant numbers of unidentified potential buyers, give free samples to existing buyers, and give samples to those who would never become buyers. FP sampling might work more broadly and efficiently by allowing any potential buyer who meets FP offer criteria to be able to elect to sample the product (with screening to eliminate current buyers that might be facilitated at least in part by the FP data). FP reputation data can optionally also be applied to distinguish buyers who are found to sample without payment excessively (whether from a single vendor or across multiple vendors), and to reduce their access to such sampling offers, and, conversely, to increase access to such offers to those who do often pay reasonably well.

It should also be understood that the nature and range of FP sale offers might be highly variable as to both product/service composition and terms. In the example noted above of FP offers for ad-free versions of Web content, a variation can be to allow for variable levels of advertising intensity and/or obtrusiveness to be set by the seller based on the FP price history of the buyer (rather than a simple, binary, full ads vs. no ads alternative). A rich variety of other variations of terms and dimensions of product/service features can optionally also be built into offers. With the proposed methods, the cyclic, recursive nature of FP offers, sales, feedback and more offers might effectively yield a significant degree of price setting power to the seller over time, indirectly, even though the buyer has the price setting power for individual offers once they are extended to the buyer. The seller effectively has a basis to predict what a buyer is likely to pay, and the power to tailor offers to that buyer to match the expected price.

FP methods can optionally also be applied to post-sale services, including guarantees and warranties, at multiple levels. While free services commonly come with no warranty, FP offers can optionally include warranties. Such a warranty can optionally be as of right, for any price, or for any price above a set or to-be-determined threshold. In another embodiment, the warranty services, themselves, can optionally be provided on a FP basis. Thus a buyer (whether FP or conventional) can optionally be offered warranty service on an FP basis. It can optionally be understood that factors in the setting of the FP price for the warranty service would include factors that might apply to honoring a conventional warranty, such as nature of the problem (and whose fault it might be), amount/nature of use (abuse) prior to breakdown, etc., but with the greater flexibility and adaptability of the FP methods (and with the greater buyer control of FP). This can optionally work much like the Nordstrom practice of no questions asked returns, but with the added seller benefits of FP feedback processes.

Much accessible background on current pricing models and issues can be found in Chris Anderson's book “Free: The Future of a Radical Price” (Hyperion, 2009), which is incorporated herein in its entirety by reference. Many of the methods described above will be clearer in their applicability in light of that background, and additional variations will become apparent in light of these teachings, from the perspective of related conventional models and their current limitations. Many of the objectives of those conventional models, including “freemium” in various forms, might be better achieved, with better results and fewer limitations, by applying FP methods of this disclosure, as described in the following sections and elsewhere herein. Some examples of background that takes on new meaning in light of the methods disclosed herein include:
the different concepts of Cournot and Bertrand pricing (note the relevance of cases of near-zero marginal price as presenting opportunities to apply the methods disclosed herein to obtain new and better results, as described below)
the relevance of markets for attention (note an incentive for FP pricing to more effectively encourage trial use and referrals with better revenue results, and the viral marketing uses of FP described below) and for reputation (adding the FP pricing reputation, in combination with other conventional and emerging aspects of reputation), both as described in various examples herein
the difference between free as gratis (no charge), and free as libre (unrestricted)—note that FP might be said to offer aspects of gratis in order to facilitate a degree of libre, such as by providing buyers a high degree of freedom to set their own prices.
the concepts of distributed cost as applied in freemium models (note distributed cost also applies to FP models, in that those who price above cost subsidize those who price below cost)
neuroeconomics (note neuroeconomic data can optionally be another input factor in the decision to make FP offers as well as an input factor for determining TFRs, and that FP prices can serve as a metric of neuroeconomic aspects of utility, and other observable metrics of neuroeconomic satisfaction can optionally be applied as inputs to many FP decision processes)

Expanding on the concepts of near-zero marginal price (based on near-zero marginal cost) provides another way to understand how FP might facilitate a new kind of economic value maximization. This can be thought of as a way to capture a “long tail” of price, in terms of value and revenue. Instead of being limited to price as a single flat price to all buyers, or alternative schemes of a few differentiated set prices offered to a few market segments, FP provides for a continuous curve of prices that are automatically matched to utility, for market segments of one, or at least of more finely grained sub-groups than are practical with existing merchandising and pricing methodologies. While this might forego some profit margin in many cases, it might bring two positive counter effects. One is that some buyers might voluntarily pay even higher FP prices (than the conventional fixed price), and the other is that many buyers might pay lower (but marginally profitable) FP prices for transactions that would not otherwise be realized as sales at all. The latter can be thought of as a new kind of “long tail” (similar to the one Anderson noted in his book “The Long Tail,” but in the dimension of buyers, rather than the dimension of items that he addresses). In other words, in a graph of prices vs. buyers going from high to low price, FP might facilitate high prices to those who value an item highly (the short head), while capturing low prices from many who might not purchase it at all (the long tail). Much as Anderson's long tail of infrequently purchased items was, in aggregate, comparable in value to its short head of popular items, this new long tail of low-paying buyers might be very significant (many added buyers) relative to the short tail of buyers paying “full price,” and might expand profits, productivity, and the economy at large.

From this perspective, it might be useful that, in one embodiment, offers have no minimum price, so that a maximum population of potential buyers can be enticed to purchase. However, in another embodiment, it might be determined that a minimum price (such as one at or near the marginal cost or variable cost or other similar metric) might be desired to avoid sales that do not make a positive contribution to profit, or that fail to meet some other criteria. Such a minimum can optionally be absolute, or can optionally be merely a guideline, which might acceptably be rejected by a buyer who judges that he has not received even that minimum level of value. As with other such buyer evaluations, the seller can optionally expect a satisfactory explanation to avoid a negative feedback evaluation.

One example of usefully applying a minimum price (or floor) in a FairPay offer can be to seek to capture unrealized value from the short head of the price sensitivity curve (those willing to pay more than standard price), while protecting against any possible downside. This might especially be useful for introducing FairPay into a context in which conventional fixed-price subscriptions were in use. For example, a newspaper can optionally create a special subscription tier of “partners” that emphasizes their relationship as a “patron” of the newspaper's quality journalism, and is targeted specifically to regular readers who might pay more than standard price in return for some perks or recognition. In this example, payments can optionally be set at least the standard fixed subscription price, and thus entail zero risk of revenue loss, whether through loss of subscribers or reduced prices. Thus, only the premium portion of the subscription can optionally be subject to FairPay processes, and it can optionally be framed in terms of those two distinct pricing elements: a standard price for the standard subscription, plus a FairPay premium for optional premium products/services/perks. Then, once established and successful at the premium end, the long tail (more price sensitive buyers) can optionally be targeted with an unbounded FairPay offer for the basic subscription products/services.

It is noted that FP pricing methods can optionally be used as a new and better way to achieve many of the effects of “freemium” methods. As previously outlined, embodiments that provide for an acceptable level of free sampling within a FP model can produce many of the beneficial effects of some freemium methods, but do so in a more powerful and dynamically adaptable manner. As outlined above, free sampling can optionally be applied at the buyer's initiative, up to a point determined fair by the buyer, with the alternative of payment for more extensive use. One difference between FP model and freemium methods is that freemium methods have the static inflexibility of conventional fixed price methods, while the FP methods bring the dynamics of a FairPay process that sets prices after use, and use feedback to control, learn, and adapt, in an ongoing process. Thus FP-based sampling methods might be far more effective, being far more flexible and self-adjusting than fixed price freemium methods.

More generally, it will be recognized that by varying the many parameters used in applying FairPay embodiments, pricing policies can optionally be designed to approximately mimic desired features of conventional pricing policies, as well as to create new ones with widely varying characteristics, suitable for diverse situations and objectives, again with benefits of flexibility and self-adaptation. Some design variables include, without limitation, the explicit and implicit terms of the FairPay offer framed to the prospective buyer, the contexts of the offer/transaction/use, the metrics to be paid for, the buyer pricing behavior reported, and/or any other variables that might be recognized as useful.

As noted above, embodiments of FairPay can optionally seek to emulate variations of freemium, for example based on a list enumerated by Anderson, which varies with regard to the nature of the limit bounding free versus premium. For those variations, FairPay can be adapted to have similar characteristics as follows:
by feature, by making the offer (and subsequent elements) specific with regard to pricing for purchase/use of the feature versus for purchase/use of other features;
by time, by making the offer (and subsequent elements) specific with regard to pricing for purchase/use at certain times versus for purchase/use of other times;
by capacity, by making the offer (and subsequent elements) specific with regard to pricing for purchase/use when capacity is at one level versus for purchase/use when capacity is at other levels;
by seat, by making the offer (and subsequent elements) specific with regard to pricing for certain numbers of seats versus for purchase/use for additional seats;
by customer class, by making the offer (and subsequent elements) specific to the desired customer class.

Other variations of this kind can optionally include any other form of metering, one-time pay-per-view, site license, any form of volume/quantity discount, any limit to a set number and/or defined set of access/use devices, and/or the like.

It will be understood that similar dimensions of conventional fixed pricing plans can also be more or less closely emulated in FP embodiments.

A further example of strategic pricing opportunities that might be based upon FP methods relates to customer retention. Various businesses such as phone companies, subscription information services, magazines, and others can optionally apply FP methods to retain customers in situations where customers become dissatisfied with the value proposition and terminate or threaten to terminate their business. The FP methods can optionally be applied even if not offered or even made known to regular satisfied customers. While it may be useful to improve the value proposition to dissatisfied buyers by increasing their satisfaction without reducing the price, making a FairPay offer can be an alternative, or at least a stop-gap, especially in situations where the dissatisfaction is judged not unreasonable and/or a lower FP price might be satisfactory to both buyer and seller, at least until remedial measures increase the value perceived.

In reviewing the variety of such uses of FP methods, it is emphasized that in many situations it can be useful to use FP pricing methods as just one tool among many, and that conventional and FP methods can optionally be mixed and used selectively depending on the context and the desires of buyer and/or seller. Sellers can optionally offer a choice of pricing methods or respond to buyer requests for such methods. Sellers can optionally structure hybrid offers that combine conventional pricing for some elements of a package or bundle or otherwise related items in conjunction with FP offers for other elements (as in the warranty example above). Similar hybrids can optionally combine conventional pricing for one-time or up-front elements with FP methods for recurring elements, or vice versa. In some situations, sellers can also seek to keep FP pricing offers in reserve for special situations (and not generally known to buyers), such as to minimize risk of cannibalizing fixed price sales (such as perhaps in the case of retention strategies just noted), while in other situations it can be judged that openness is useful, and perhaps more conducive to better cooperative relations and trust with buyers, and/or to enhance the visibility and desirability of FP options.

The workings and motivations of FP methods as described herein might be usefully understood with regard to economic theory relating to price differentiation and/or price discrimination. Price discrimination occurs when a price from the same provider for a given good or service varies to different buyers. First degree price discrimination may be understood as a theoretically ideal way to discriminate, based on a customer's willingness and/or ability to pay (as that may vary dynamically with time and context), but that information is generally not known to a seller. Given that lack in the real world, second degree price discrimination is often employed, where prices vary by quantity, such as with a quantity/volume discount. Third order price discrimination is also often employed, where external customer attributes are used to segment the market, such as customer location, demographics, psychographics, etc. as a proxy for ability/willingness to pay information that is not available. From this perspective, FP methods can be understood to provide a totally new way to discover ability/willingness to pay (the “reserve price”), for individual buyers, both in specific transaction contexts and as larger patterns over time, and to directly apply that proxy data to achieve a near theoretical ideal level of price differentiation as a result of the ongoing FP discovery and adaptation processes. Thus in this terminology it might be understood that FP methods seek to provide new ways to facilitate first degree price discrimination, including ways to gain buyer cooperation in doing that, including self-selection and self-reporting, as well as to supplement that with new ways to incorporate second and third degree price discrimination. It is also noted, that as a new way to obtain valuable data relating to ability/willingness to pay, FP methods can optionally be used to make this data and similar data available for many other valuable uses, including sale and/or allied business decision processes.

Other useful features of FairPay methods can also be understood in terms of price discrimination theory. For example, it is recognized that, in theory, if it were feasible, price discrimination might yield maximum economic output, and thus add to maximal (Pareto optimal) societal welfare, but there are many reasons why such ideals usually cannot be realized. Among the reasons are privacy concerns, and adverse societal reactions to the negative perceptions of discrimination as being unfair attempts by sellers to extract arbitrary, coerced premiums from those in need of their product/service. There can be great sensitivity to this perceived unfairness of price discrimination. Examples such as raising prices of snow shovels during a blizzard are cited as examples that raise objection. The nature of price discrimination/differentiation in a FP pricing content is altered in a number of ways. One set of differences relates to how FP methods shift pricing decisions to the buyer, and further, to how they do this in the context of open dialog on prices, values, costs, usage contexts, and the factors that affect value as obtained and perceived by the buyer—as well as the various cost factors that affect the seller. As a result, buyers, and the public in general, might have little reason to regard FP price discrimination as being unfair, since the processes generally alter and even reverse typical pricing practices, so that they might become intrinsically and demonstrably fair. In many embodiments prices are set at the user's discretion, with explanatory justification stated by the user. Thus, even if a context for differentiation is set by the seller by framing the offer in a manner that suggests that price differentiation be considered, the user accepts the offer and sets the price as seems fair to him. Thus any price discrimination is done with the direct participation and acceptance of the buyer. Also, unlike many conventional attempts at price discrimination, FP processes might generally be explicit and open about the rationale and basis for discrimination, so that the result might be naturally perceived as a form of discrimination that is fair, justified and beneficial to consumers and the general welfare, rather than unfair, manipulative, secretive, and exploitive.

Note also that price discrimination is generally understood in economic terms of demand curves and price elasticity, including such factors as profit maximizing output with respect to marginal cost curves and marginal revenue curves, with respect to individual transactions and/or the total market. Embodiments of FP processes can optionally be defined in terms of these and other related economic parameters as well.

Viral Use of FP

Free digital products and services often benefit from viral marketing, in which satisfied users pass an item (or information about an item) on to other users. This generates a positive word of mouth and benefits from the reputation value of the sender and the transmission over the sender's social network, much like a chain letter. FP products and services can optionally be configured to behave in a way that benefits from viral transmission, while keeping benefits of FP pricing.

An objective is to allow users to pass items on in a viral fashion, but still to obtain revenue from those who find the item of value. Since people generally do not want to pass an item on unless they believe it may have value to those they pass it to, it is suggested there might be a way to exploit that indication of value. At the same time, the recipient might be permitted to judge for themselves, without risk, whether the item actually had value to them.

FP methods can optionally be applied to such viral transmission. This can optionally be done by using methods to track the viral transmission, and to ask for FP pricing acceptance by recipients. Following are two non-limiting examples that illustrate how this can be accomplished:

In one example, the item can optionally not be retained by users (such as with a download), but rather obtained from a server for each use, such as in the form of a link to a Web page, or to streamed audio or video. Viral transmission can optionally be supported by the server, by offering a “send this to” option. In such cases, the server can optionally facilitate such transmissions from a first user, and control the use of the FP pricing relating to that viral transmission and use by offering the item on a FP basis to the recipient of a viral transmission from a first user, interacting with the recipient of the viral transmission to effect the FairPay offer to that recipient. The server would also be able to track that the first user passed it on, which can optionally be used as FP feedback data that can optionally be included in the fairness evaluation for that user's FP pricing of the item, since passing it on can optionally be presumed to correlate with some recognition of value.

In another example the item can optionally be downloadable. In this case various rights management methods can optionally be adapted to control use of the downloaded item under FairPay terms. One such example can optionally be to apply any of various “superdistribution” technologies, with one non-limiting example being the IBM cryptolope technology, to facilitate server involvement in the use of the item. In such a case the object is received, but its activation and use can optionally be facilitated from a server. Once the server is involved, the process is essentially the same or similar to that applied for any FairPay offer, as described herein.

Pricing as a Function of Reputation and Value at Risk

It may be helpful to further clarify some aspects of how pricing can optionally be dependent on reputation. In some embodiments of FairPay, the buyer unilaterally sets transaction prices. However, the vendor can optionally have an effective degree of control of the value put at risk in his FairPay offers to the buyer, both at an individual offer level and at an aggregate level for multiple offers. This value at risk can be an important factor in managing offers. The vendor might find it effective to manage his offer levels in terms of some surrogate price or imputed price that serves as a metric for the value at risk. This can optionally be based on marginal cost, or on some metric related to an expected price. That can optionally be an average across previous buyers, an expected value for a given buyer, some kind of nominal price for an item, and/or any other basis that might be found useful for managing the offers.

At an individual offer level, this can optionally be a factor in determining whether to make an individual offer to a user dependent on this surrogate or imputed price (in conjunction with buyer reputation data and other factors)—for example, the better the buyer's reputation, the larger the value of offers that can optionally be extended.

At an aggregate level, this can be a factor in the total number and scope of offers made outstanding to a buyer—for example, the better the buyer's reputation, the larger the total value of all offers that can optionally be extended. This can optionally be broken down into categories such as offers not yet accepted, offers/sales accepted but not yet priced, and offers/sales priced but not yet paid, as well as other variations or combinations. This aggregation can optionally be done at the level of a single seller, and/or across a network of sellers.

At both individual offer and aggregate offer levels, even though each individual transaction price can optionally be unilaterally set by the buyer, this value at risk metric can be used much like a price to determine what level and combination of offers to extend to a buyer. It might generally be expected that the better a buyer's FairPay reputation, the more value can be put at risk. In such a case, those with better reputations will get offers for more valuable items, and can optionally be enabled to have a higher value of total offers outstanding. As noted before, such methods would give buyers strong incentive to maintain a good FairPay reputation.

Value at risk can optionally be computed as an expected value based on a probability distribution of expected prices for a given buyer and product/service combination. Such a probability distribution can optionally be computed based on the buyer's FP reputation, other knowledge of the buyer, and knowledge of the product including cross-buyer knowledge of distributions of pricing for that product as a function of buyer reputation, and as a function of any variations in offer presentation, framing and other context factors, including reference prices, price bounds, product/service descriptions and any others factors. This can optionally be done using a computational approach more or less like that described above for a Predicted FP score (PFP). For new buyers, default FP reputation values can optionally be assumed, whether as simple default, or as adjusted/estimated by any other available knowledge of the buyer, including but not limited to demographics, psychographics, behavior, etc, as noted elsewhere herein. Such expected values can optionally be computed both for individual transactions, and/or across any aggregate of transactions as outlined above. Methods of computing and managing risk can optionally draw on techniques used in finance, including options, derivatives, insurance, and the like. FP prices can optionally be treated as a form of option, such as an option to buy a product and/or set of products over some period for some price, with bounds and distributions as just described. Value at risk, as can optionally be used in offer management processes that factor in risk management considerations, can optionally be computed much as for options or other derivatives, using any of the methods currently used or developed in the future for such purposes, with adjustment as need for the specific characteristics of FP offer and pricing processes. Thus in some embodiments, management of value at risk in FP offers to a buyer, and across buyers, can optionally be treated much as for risk management for holdings, portfolios and/or institutions in finance.

This ability to have significant amounts of value at risk, managed on the basis of reputation, can optionally be useful in reducing the burden of price setting on buyers. Buyers with good reputations can optionally be permitted to have many offers/sales with high value at risk outstanding, and to be able to defer price setting, and to set pricing in a simplified batch process for all or some set of outstanding offers/sales. This might simplify price setting by making it more infrequent and more broad-brush. For example, pricing of subscriptions for media products can optionally be priced by item, monthly, quarterly, or yearly. Sellers can optionally set upper limits on aggregation in accord with such metrics as numbers of items, time, or imputed value, and buyers can optionally take advantage of whatever limits are extended to them, or can elect to act on a shorter cycle, as they find most useful. It might be expected that many buyers would find larger aggregations, priced infrequently, to be least burdensome. Note that this pricing cycle can optionally be different from the related payment cycle. For example, with subscriptions, even in a case where price setting is annual, payments can optionally be made more often, such as monthly, based on the most recent prior price setting. In such a case the next year's price setting for monthly payments can be tentatively based on the previous year's usage (but can optionally be subject to change as desired). For example, a cable TV or other video service subscription can optionally be paid monthly at a price set based on the prior year's viewing. Viewers would then later review the current year's viewing statistics to set a new price that can optionally be used 1) to adjust payments already made for usage already made during the current year, and/or 2) to tentatively apply to payments during the next year. Should either the viewer or provider determine that the current price no longer seems appropriate, a mid-term price adjustment can optionally be permitted (or if a price is found unsatisfactory in light of changed conditions, the FairPay subscription can optionally be terminated). Vendors might often seek that payment cycles be more frequent than pricing cycles, such as to manage receivables risk, but cases where the opposite relationship is desired might arise as well (such as in the case that pricing risk is a larger concern). A wide variety of variations on such details can optionally be applied, depending on the context and the level of sophistication desired by both buyers and sellers.

In some embodiments, risks relating to fraud or other undesirable behaviors in commerce, including electronic commerce, can optionally be addressed. Embodiments can optionally apply any conventional methods of identity management and access control, such as those based on user IDs and passwords, and such methods can help ensure that users are held responsible for payment, and are limited to products/services to which they are entitled under whatever business arrangements might apply. Because the methods for managing value at risk just described build on the tracking of history/reputation to determine which buyers are reliable, it might be desired that supplementary measures be applied to better ensure that buyers can be properly identified over an extended time so that they cannot exploit identity theft of good reputations, nor can they escape the effects of a bad reputation by simply changing identities and/or assuming new identities and/or aliases to continue to receive valuable offers (even if the value offered to those lacking established reputations is small). Some non-limiting examples of useful methods that can optionally provide more reliable and/or persistent identification include the following:
A user's Internet device IP address is often a moderately good identifier, and can be determined with no burden to the buyer. (Services can optionally be used to inexpensively detect and reject anonymous addresses obtained through proxies.) Similar identifiers for mobile devices, such as phone numbers or SIM card identifiers (such as International Mobile Subscriber Identity or IMSI) can optionally also serve this purpose, perhaps more reliably. Other methods for more positive and secure identification of Internet users, such as those based on hardware IDs, tokens, trusted systems, identification of referrer Web sites, single sign-on services, user hierarchies/trees, federated security, and other kinds of identification technologies, can optionally also be applied in any desired combination.
Credit cards can optionally be used to verify identity (including name and address), without making any charge, and this adds only a modest hurdle to buyers. Buyers accepting FairPay offers can optionally be asked to provide a credit card for validation as a form of identification, possibly with the written commitment that no charge will be made except as subsequently authorized by their later pricing action.

As noted above, to manage identity risk, a seller can optionally limit buyer/users who have yet to establish good FairPay reputations to low value offers. These can optionally be for small numbers of items, and only for low value item types, and then, as good experience is gained, gradually extended to offer more FairPay “credit” covering larger quantities and more premium item types, as noted just above. Once established over time, good reputations might not be lightly sacrificed.

In B2B markets, as noted above, buyer identity may take on a rich structure that can optionally be correspondingly addressed in FP processes and databases. In such situations, it can be useful to distinguish multiple users having more or less independent access to use of products/services, grouped into hierarchies and/or other suitable structures, including hierarchies of pricing decision-makers, in any combination of human and/or automated, responsible for groups of users, having various distributed levels of responsibility to control pricing and usage decisions. In such cases, the FP databases can take on correspondingly richer form, and the various processes, including offer management and FP reputation management, can be adapted to track usage, pricing, and other data, and to provide reporting of usage and requests for pricing in accord with such levels and groupings.

Privacy and FairPay Reporting Data Services

Given the privacy issues relating to detailed purchase history information, which might desirably include product and usage details as well as price information, various methods for insulating that data can optionally be applied.

As was noted, large vendors can in some embodiments provide themselves with direct access to such data to use as needed (and need not disclose it further).

In some embodiments, vendors that service themselves as well as other affiliated vendors (such as, for example, Amazon, with its affiliated merchants) can optionally make this data usable to their affiliated merchants, and can optionally do so by providing Web services that perform rich merchandizing analysis on behalf of an affiliated merchant (in any manner that the merchant might otherwise do using in-house FP processes, systems, and/or databases, etc., if it had direct access to the data, as discussed elsewhere herein), based on inputs from the merchant about the product and possible terms, and returning some reputation score and possibly related metrics, without disclosing to the seller any details of the history that information is based on. In other embodiments, such services can optionally make a recommendation as to whether and how to make the offer, without disclosing the data used to do so, not even any reputation metric (other than the contextual recommendation to offer or not).

Similarly, other transaction support service operators can optionally serve as intermediaries that support FairPay transactions as outlined previously, and can optionally offer Web services similar to those just noted in the Amazon affiliate merchants example, to apply FairPay reputation data without exposing private information. Further, such service operators can optionally make such services usable by sellers/merchants of any scale, including individuals as sellers (much as for auction and fixed price sales on eBay and similar services). A rich variety of services can optionally be facilitated, which might be considered as “Pricing as a Service,” drawing on cross enterprise “cloud computing” services, platforms, and infrastructures. Such services can optionally extend to include handling of any and all kinds of non-FP pricing as well.

Such Web services can optionally take the form of services that operate by applying a function of the FP reputation history data to inform merchandising decisions without revealing the data.

Input parameters can optionally include details of the product/service to be offered, details of its cost and related production/merchandizing parameters, categorizations of its nature and how it maps to known product categories and patterns of appeal and value, information on pricing for that product, and such other parameters as noted previously or as will be apparent to those skilled in the art in light of these teachings.

Outputs can optionally be in the form of a FP rating for a given potential buyer for that product, or richer sets of parameters about that buyer's FP pricing behavior, which can optionally include breakdowns of statistics relating to prices paid by product category without revealing specific product details (such as book or article or song or movie titles, or details of product categories that might be sensitive, such as medications, adult entertainment, politics, etc.).

Alternatively, outputs can optionally disclose nothing of the buyer's history, other than to recommend that a specific offer be made or not.

It should be understood that while the above description in this section relates to a third-party service that serves more or less as an intermediary between buyers and multiple sellers, similar third-party services can optionally serve, as described further below, in a converse role, where the seller(s) face the buyer more or less directly and intermediate between the buyer and the service, such as where the service takes more of a confederated and/or back-end role, and/or in any variation along such a spectrum. Thus relationships with buyers relating to data ownership and/or related privacy controls can optionally be delegated or restricted in either direction, including cases where the sellers can optionally control all FP data for their transactions, and can selectively share portions of that, with any desired level of limitation, with third-parties and/or directly with other sellers.

In spite of privacy issues, it should be understood that many of the forms and/or sources of data collected by the various parties participating in the processes described herein can be expected to be of value as market data, or for other uses. Subject to any privacy restrictions, and optionally in accord with methods of masking individual details and/or identities, such data can optionally be sold by any of the parties. That can be an added source of revenue to those practicing these methods, including buyers, sellers, support services, and/or the like.

Exemplary Business Application Contexts

The following are some non-limiting examples of business contexts where there can be good opportunities to rapidly deploy FairPay support infrastructures by building on existing marketplace infrastructures and business relationships, with particular attention to digital media (including text, multimedia, music, video/TV, e-books, games, and software) and other digital products and services.
Aggregators of digital media—such as Apple, Amazon, Netflix, etc.
Producers/sellers of digital media—such as News Corp, the New York Times, Disney, Sony, Time Warner, etc.
TV distributors—such as Cable TV operators, Telco TV operators, Satellite TV operators, and Internet video services (Hulu, MySpace), etc.
Merchant support service providers, including credit card services—such as Amex, MasterCard, Paypal, Google Payments, etc. might also be well-positioned to develop platform offerings to sellers, building on their related infrastructures and business relationships.

As noted previously, in addition to these exemplary digital business contexts, the methods described herein can optionally be effectively applied in many other contexts, including sales of physical products and services. Particularly good opportunities might be found within businesses that already make use of individualized marketing and/or merchandising services such as those based on predictive analytics, for example Sam's Club, CVS, Kroger, etc., and Web-based vendors of physical products/services, such as Amazon. Other early opportunities may apply to low cost products (such as for example DVDs), and to service industries in the real world, especially those where high fixed costs may be coupled with low variable costs, such as hotels, airlines, restaurants, and theaters, other venues, and the like, and/or for products/services produced using costly facilities, and especially in cases where the product/service might effectively be perishable (in the broad sense of being salable only at reduced value or not at all, after some passage of time, whether through actual spoilage and/or any other kind of time-related loss of value, such as for example, a seat on an airplane that has departed), as noted further below.

It is also noted that while much of the preceding discussion relates to examples of business-to-consumer commerce, these methods are applicable to business-to-business contexts as well (both small business and large business markets). These methods can be applied at any tier in the value chain, from consumer to consumer marketer, to wholesaler, to manufacturer, to component supplier, to creator, or any other buyer-seller pair in a value chain. Such variations can optionally operate at a single level in such a value chain, and/or at multiple levels. Multi-level embodiments can optionally be applicable to each level individually, with more or less independent cycles of offers, pricing, and further offers, or embodiments can optionally involve offers in which prices are apportioned to multiple levels. For example, in a case of selling electronic books, music, video or the like, the owners of various rights (such as copyrights, mechanical rights, performing rights, etc.) can optionally be apportioned a share of the price set by the buyer. Depending on the context, such sellers/rightsholders who are at more distant layers of the value chain can optionally have direct, dynamic roles in the offer analysis and decision process (such as by dynamic invocation of their own FP decision processes, in federated on confederated modes, such as via Web services or other integration methods), or can optionally have more statically defined rules-based pricing criteria that can apply and be factored into the decisions controlled by seller(s) at those layers of the chain in more direct proximity to the end buyer on their behalf. Similarly, such multilevel share allocations can optionally be based on any desired formulas that are a function of the price set and/or other factors, such, for example, as to give differing allocations to portions of price up to a specified level and to portions above that level. Similar combinations/delegations can optionally work in the reverse direction of the value chain, as well.

Such multilevel apportionment of roles in offer analysis and decision processes can optionally also be usefully applied in contexts of third-party services that facilitate FP processes for multiple sellers. While in some cases, the individual sellers can optionally retain control of most decision processes, as noted elsewhere, aspects of FP reputation analysis and/or decision making can optionally be done by the third party service. Similarly, there can be embodiments in which increased levels of decision control, up to and including full control, are given to and/or retained by the third party, whether to gain benefits from cross-seller data and/or decision rules, to maintain privacy of data, and/or to delegate management, operations, and/or support tasks to an outsourced service. It should be understood that such delegations can optionally be made in either direction, whether from sellers to a third party service or from a third party service to sellers, and that the related issues of buyer relationship control and/or visibility, policy control, pricing risk, data ownership, data access, privacy control, and/or the like can be similarly distributed, whether in correspondence, or with variations, in any desired dimension. Such apportionment can optionally be applied to any blend of rules, decision criteria, constraints, offer terms, or other FP management, policy, or operational parameters, and the like. This can optionally involve complete flexibility and/or more or less limited degrees of flexibility, such as for example to permit seller control of specific aspects/parameters in a set of decision rules/criteria set by the third-party service, and/or conversely to permit control by a third-party service across multiple sellers. Note that, in embodiments with higher levels of independent seller control, there can optionally be higher levels of cross-seller variation in such aspects, and an understanding of such differences can optionally be applied for various purposes, as described elsewhere herein. One non-limiting example includes developing seller reputation metrics of various kinds, such as those relating to how they evaluate buyer fairness, how they set suggested prices, and or the like. Such seller reputation metrics can optionally be made useful to buyers, as well as to sellers and third parties.

Such divided apportionments can optionally be used to divide aspects of a buyer-seller relationship between sellers and support services, and/or to allocate certain transaction risks between sellers and support services. For example, a FP shopping service that supports multiple sellers can optionally have a direct relationship with consumers that can optionally be shared to varying degrees with the individual sellers. In some such cases the pricing risk can optionally be limited to the seller, but in other embodiments the shared service can optionally take some of those risks. Such allocations might or might not be visible to buyers. A non-limiting example is a case where a multi-seller shopping service wants to extend a full satisfaction guaranty, possibly in the form of ability to set a FP price of zero, even if it permits individual sellers to set a non-zero floor price, or for extended periods, or otherwise. If the seller floor price was visible to the user, the shopping service can separately offer the guaranty as being from the service, not the seller. This might be used, for example, in a context where the shopping service seeks to gain buyer trust for its service, while including access to sellers who choose not to accept the same level of buyer discretion. A wide range of such allocations might prove valuable in many aspects and contexts, some visible to buyers and some not.

While these methods might be attractive for use by high-end sellers who can attract customers who appreciate and pay for premium products/services, other contexts might include sellers who cater to more price-conscious buyers. Such uses can optionally capitalize on the attraction of the participative aspect of these methods to such buyers, while using various methods to manage seller risk. Some such contexts can optionally include use for secondary distribution channels in which discount prices are acceptable for any of various reasons. Such reasons can optionally include situations with opaque sales, such as where added quantities of product can be sold at discount without impacting full-price markets, or where offerings are for lower-value items. Non-limiting examples include specialized “buying services” that are marketed narrowly, private label versions of products not readily compared to full-price equivalents, remaindered or out-of-fashion or other less-desirable products, or the like. Another example is a distribution service for independent authors, artists, software developers, or other creators of digital or real products/services who might be happy to obtain a high percentage of a less than normal retail price, because they have no chain of expensive middleman taking a large share of revenues. Such services can optionally be independently operated or can take the form of a cooperative of such creators.

Other examples of such secondary distribution services are those that take on forms more or less similar to coupon services, including embodiments as third-party coupon services, in which coupons are offered on a FP basis and/or have a FP pricing component. Such services can optionally be identified as “coupon” services and/or use actual coupons in some form, but can also be more or less indistinguishable from more general classes of offers/transactions. As with any FP offer, these can optionally be unbounded, but bounds and suggested prices might fit well the objectives of the merchants sponsoring such FairPay coupons. For example, instead of a coupon for 50% off a standard price, a FP coupon can optionally provide for a range, such as for up to 75% off, possibly with the suggested price of 50% off. Such offers also can optionally have upper bounds, such as standard price, or not. Offer management and framing strategies as described elsewhere herein can thus allow merchants to set the expectation that if the service was as expected, the buyer can optionally price at the suggested 50%, but that if disappointed, they can price at less, whether permitting a zero price, or the example of a 25% minimum, or otherwise. Conversely, if the service exceeded expectations, a higher price (lower discount) might be expected to be set. It is noted that discount/coupon services can optionally be embodied in the form of services that specialize in such offers, but that may not be the case, and that variations in how offers are framed and otherwise communicated to buyers, or other techniques, can optionally be used for differentiating discount, full-price, and premium offer contexts. For example, FP offers to new customers, or for new products, can optionally be framed as special FP offers, for which a corresponding special discount is expected to be factored into the pricing evaluation by the buyer, and accepted by the seller—one that would not be expected to apply to repeat offers. As noted elsewhere herein, such framing of offers as trials and/or sampling is another aspect of how FP processes can be used to mitigate buyer risk aversion that might otherwise impede sales. Such services can optionally be segmented and/or fenced in any manner, as described further below, including with regard to such context parameters as time, location, weather, and the like.

Looking more closely at how such discount/coupon services can optionally apply FP reputation data gathered from the pricing actions of individual buyers across their multiple sellers, a range of benefits might be seen as obtainable. As might be the case with any customer acquisition campaign, an objective of FP offers can optionally be to bring in buyers that are new to a given seller. This can optionally be used in businesses with high customer acquisition costs, especially where repeat customers have high value. In such cases the use of cross-seller reputation data might be valuable. As discussed extensively herein, such pooled reputation data can optionally be applied to aid in selecting which potential buyers are given which offers. Some such decisions can optionally be specified at the third party service level, and some at the individual seller level. For example, depending on the seller and the items offered, it can optionally be determined that a given level of offer from a given seller is to be extended only to buyers with a cross-seller FP reputation above some specified level. This can allow sellers to target potential customers much more selectively than in conventional services. For example, targeting can be on the basis that they only wish to attract higher-rated buyers for an especially valuable or costly offer, or it can be for broader reasons, such as to bring in the most profitable new customers, possibly by drawing from those known to exhibit more liberal pricing behavior). This can also allow the service to better assure their sellers that they can limit their risk and maximize their ability to target desired customers. Of course some sellers might find reason to seek to attract those who price at relatively low, but still acceptable, levels, such as perhaps for sellers that cater especially to highly price conscious buyers.

It is further noted that offer criteria can optionally change over time, whether for the discount/coupon embodiments described here, or otherwise. For example, at first relatively selective offers can optionally be offered to the most desirable potential buyers, by FP reputation and/or whatever other criteria, and then the criteria can be gradually relaxed until the desired level of acceptances is reached. Such expansion can optionally be to a broader population of buyers, and/or to extend enhanced offers to potential buyers who have yet to accept an earlier offer.

It is also noted that FP coupon offers can optionally obtain or not obtain advance payment for the coupon. Where payment is not obtained in advance of arrival to a point of service, the product/service, FP pricing and payment can be done at the point of service, whether up-front, or after use, or can be done some time afterwards, whether at the point of service or otherwise. Where payment is obtained in advance, FP pricing processes could provide for a credit or debit to adjust pricing at or after the time of obtaining the product/service. Further, such a coupon service can optionally further decouple the payment from the price setting. For example it might be desired that the use of a FP “coupon” payment process not be apparent at the point of service at all, such as, for example, in the case of a meal at a restaurant, such as to hide the use of FP pricing and/or coupons from guests and/or restaurant staff, or similarly in other retail establishments, or to obtain a degree of privacy for any other reason. In such a case, the buyer can optionally conduct what appears to be a normal credit card (or other form) payment for a normal set-price transaction, with an entirely separate process used to relate the payment to a “coupon” offer, whether with an actual coupon or not, and to separately enable the buyer to set an FP price, and separately effect an appropriate credit or debit to adjust the net payment accordingly. The relating of the transaction to the FP offer can optionally be effected by any desired means, including, for example, via a smartphone app, and/or by emailing a smartphone photo of the payment document.

Other examples of opaque offerings to price-conscious buyers can optionally include use, such as for perishable products/services such as excess inventories of travel and transport services, including air/train/ship travel, hotels, car rentals, and tour packages, in a marketplace role much like that provided by Priceline's opaque name-your-own price demand-aggregation service. In contrast to the pre-sale price setting used by Priceline, which is “named” by the buyer but subject to a seller acceptance floor (minimum) price, a FP-based service can optionally selectively offer inventory to buyers with the price to be set after sale and use, as described herein. Such a service can optionally be positioned as offering bargain prices on a more win-win basis, so that buyers will be confident that they have a bargain, but sellers can still use FP reputation to limit their risk that buyers will not offer reasonable compensation, where there can optionally be recognition on both sides that the price is for excess inventory for which top-dollar might not be appropriate. A buyer pleased with the result can optionally choose to pay at a relatively small discount from standard prices, while one disappointed can optionally pay at a large discount (or nothing at all). Based on such feedback, the selling service can optionally become adept at steering offers to those who will value them well. Of course non-opaque variations providing more details of the item to be sold can optionally also be provided as well.

Such services might appeal to a range of consumers, including those seeking bargains, and others who simply value the ability to have the high degree of price control offered by FP. Many buyers might appreciate the security of post-sale PWYW, even if it may lead to somewhat higher prices than conventional discounting methods that lock in prices before a sale (including Priceline's so-called “name your price”), thus risking buyer's remorse if the product is not as expected.

Further Variations

Some further exemplary variations are noted, as follows:

A variation closer to conventional practice can optionally be to use fixed but contingent prices, with an agreement of obligation to pay only if value is judged to be satisfactory to the buyer. This can give much the effect of a conventional money-back guaranty, but with the added features of feedback for selective qualification of whether such an offer is to be extended in the future.

Offers can optionally be made with the buyer having the option to buy either on the basis of FairPay terms, in accord with any of the embodiments described herein, or on a conventional fixed price basis. The seller can optionally decide to do this based on payment reputation and product merchandising factors, or other factors as described herein or apparent to one skilled in the art based on these teachings. Seller choices can optionally include, for example, to
make no offer,
make a firm fixed price offer,
make a free offer,
make pay what you want offer (PWYW),
make a name-your-own-price offer (NYOP),
undertake a price negotiation and/or auction and/or reverse auction of any kind,
make any other kind of conventional and/or to be developed offer,
make a FP offer,
or any combination thereof

FP methods can optionally also be applied in open market and/or multi-seller contexts, in which case additional alternatives, such as for example, auction pricing can also be provided. For example, a service, such as one like eBay, that offers both auction and fixed price sales options can optionally offer a FP pricing option in addition to or in place of its other options.

Offers can optionally be optimized at various granularities within any or all of the dimensions of consumer by product by context. Contexts can optionally relate to buyer factors relating to usage level and type, importance, value, level of attention, level of price sensitivity, relation to product/vendor, business/pleasure/necessity, and with a rich variety of demographic/psychographic variations.

Offers can optionally be determined based on adaptive, individualized offer cutoff threshold functions (using methods, data, and dynamic decision processes of the kind described above)—for example, based on consumer's disposable income/assets at the high end, and based on consumer patience/attentiveness/context at the low end, in order to raise or lower thresholds for making offers to those buyers accordingly. Offer decisions can also factor in marginal cost, not just price, such as, for example, to apply more stringent criteria in cases where costs are relatively high.

As a method of managing cash flow and risk, while many embodiments collect payment after initial use and pricing, alternatives can be to collect some amount, essentially as an advance or retainer, at the time of the sale. Depending on context, this amount can be refundable if the buyer decided the price should be lower, or some or all of that amount can be non-refundable. Such variations might be particularly applicable for ongoing subscription offers, in which a portion is paid at the start or end of each payment period, but adjustments can be made retroactively in a later pricing review. More generally, timing of payment can optionally be more or less completely decoupled from timing of price-setting, occurring in any sequence and/or combination of steps. Note, however, that while the timing of pricing and of payment can be decoupled from one another, and much of the discussion herein regarding FP decision processing and notions of “FP credit” is described with regard to pricing and independently of issues of payment credit management, such as for example timeliness and/or completeness of payments, it should be understood that these considerations can optionally be combined in any of the FP decision processes described herein, in much the same manner as other criteria are combined, and that such combinations, such as considering pricing and payment behavior together, might produce enhanced results. For example, payment timeliness and/or completeness can optionally be used as a factor to weight pricing, such as to devalue a high price set that is not timely paid relative to a lower price set that is timely paid. Alternatively, metrics of payment reputation can optionally be built into FP decision processes to be used along with metrics of pricing fairness, to apply more or less equally as dual criteria.

Perspectives from Conventional Pricing Practices

Further insights into the methods described herein and their effective embodiment in various business contexts may be aided by close understanding of conventional pricing processes and their application. A broad current review of that context may be found in “The Strategy and Tactics of Pricing,” by Nagle, et. al. (5th Edition, Prentice Hall, 2011), which is incorporated herein in its entirety by reference. Some further discussion in light of this background follows. As outlined below, the methods disclosed herein can optionally be applied in many of the contexts described in that work, to achieve similar objectives with better results.

At a broad level, Nagle describes strategic pricing as being understandable as a pyramid, which starts at low levels with (1) Value Creation, including Economic Value, Offering Design, and Segmentation, (2) Price Structure, including Metrics, Fences, and Controls, (3) Price and Value Communication, including Communications and Value Selling Tools, (4) Pricing Policy, including Negotiation Tactics and Criteria for Discounting, and (5) Price Level, including Price Setting. Further, Nagle states that among conventional pricing approaches, those that apply a value-based focus and apply market segmentation in terms of that value-based focus are particularly effective in achieving customer value and providing sustainable strategic value. As discussed extensively herein, FP methods and processes supplement and extend the methods described there to enable new and better forms of value-based focus, and facilitate richer levels of market segmentation, within the kinds of market contexts described by Nagle, and the like. Some particulars follow.

As described, the various embodiments disclosed herein introduce radical changes to many aspects of conventional processes. In many embodiments the FP methods can optionally be used in combination with and/or as selective alternative to conventional methods, and thus might desirably be closely integrated with conventional processes, exploit such conventional processes and their support infrastructure, and retain commonalties with such conventional processes where appropriate. Many of the FP methods can be expected to effectively coexist with many conventional methods such as those described in Nagle, and to radically extend some of them. In particular, many of the FP methods, as described herein, have a focus on customer value, and thus can particularly coexist, integrate with, and extend conventional methods and related support infrastructure that share that focus.

Segmentation, especially value-based segmentation, is an important element of conventional pricing methods, and as described herein segmentation might be relevant in applying some of the methods disclosed herein as well. Conventional segmentation seeks to offer different prices to different identified market segments of buyers to exploit differences in perceived product/service value between such buyers. Some embodiments of the methods disclosed herein shift the direct control of pricing to the buyer, but as noted above, the use of FP feedback to decide whether to make future FP offers provides an indirect, downstream control to the seller. Thus in some embodiments, segmentation can optionally be applied in regard to the offer context, instead of, as is conventional, in the pricing context. Thus similar principles can optionally be applied to achieve segmentation of the FP offers in ways similar to those for segmentation of conventional prices. Thus, using FP methods might lead to much more effective, finely tuned, and dynamically adaptable segmentation with regard to value, when applied over a series of cycles. Such segmentation of offers can optionally relate to any aspect of buyer, seller, and/or usage context deemed to be useful, such as with regard to value obtained. Aspects of context can optionally include time/date (including for example time of day, day of week, holidays, external events, etc.), geographic location, details of usage location/configuration, current/recent/expected weather, medical conditions, social situations, and/or the like, As described throughout, FP methods can capture value information in great variety and detail, implicitly and/or explicitly, and embodiments can provide for buyer-seller dialog that facilitates collection of such value data throughout the usage and relationship life cycle.

Related to applying segmentation are fences, which are the policies, rules, programs, and structures that customers must follow to qualify for price discounts or rewards aimed at a given segment, and the product/service metrics that are used as the units or criteria for pricing and to track the value customers receive. While the buyer-set PWYW pricing of some FP embodiments might at first appear to impede segmentation in the form of fencing by taking control from the seller, closer understanding of the indirect control FP might offer to the seller can optionally facilitate arbitrarily fine levels of segregation to be achieved.

It is noted that communication to the buyer can optionally be a point of control in applying the FP methods. At a broad level, various forms of communication can optionally be exploited at various stages in the process described above, using combinations of FP and other data, to frame the buyer's understanding of the product/service and its value proposition both in itself and with respect to competing, alternative, or substitutable products/services. With regard to price-setting and market segmentation, such communications can optionally be structured in accord with segmentation strategies to frame offers to different buyers in ways that are specific to segmentation objectives. For example, while a seller can optionally not set a price in an offer, the seller can suggest pricing, and can suggest (or emphasize) different prices to different segments. Furthermore, the seller can optionally apply many other aspects of offer configuration control to achieve segmentation benefits. Beyond the simple binary control of whether to extend an FP offer to a segment, the seller can control many other aspects of the offer. Some non-limiting examples (which can optionally combine with segmentation of suggested prices) follow:
Bundling or unbundling of product/service elements selectively to specific buyers and/or buyer segments, so that only desired segments are given and/or are likely to respond to relevant offers. As noted above, this can optionally be exploited to give effects like freemium, and can optionally support various segmentations, such as business versus consumer, basic versus advanced, and the like.
Framing offers in terms of selected metrics, so that offers, and the eventual setting of prices by a buyer, are in terms designed to maximize the perception and recognition of value to a particular segment. Framing can optionally also include use of performance-based metrics, and be made with consideration to tie-ins,
Fencing offers with respect to such variables as buyer identification and/or transaction context, such as for example purchase location, time of purchase, quantity of purchase, and the like, so that offers are applicable only to desired segments and/or contexts and can optionally be restricted to use within such segments and/or contexts. Such fencing can optionally be applied to the decision to make the offer and/or to limit the terms of the offer. Location-based shopping offers, as described above, are an example of an offer context that can benefit from fencing. For example, this can be applied with smartphones that can receive offers that are transmitted based on the shopper's presence in the vicinity of a store or service facility and/or a location that is suggestive of a particular need for a product or service. Potential buyers can be targeted with offers, including FP offers, that are relevant to a current location. Such offers (as any offers) can optionally be limited to the fenced context, so that they no longer apply if aspects of the context change. For example, FP offers, including the case of FP coupon offers, as described below, can optionally be extended to qualifying buyers based on any desired combination of who they are, any expressed needs, their current location, the time, and/or other factors, and such offers can optionally be limited, such as to apply only at that location and time. Such applications of fencing can be particularly effective for sales of perishable or otherwise time dependent and/or capacity-limited products or services, such as for example restaurant meals, personal services, and/or the like.

Price band analyses is another method that can optionally be applied in the new context of FP processes to aid in recognizing when a buyer's FP pricing behavior is out of line with the desired pricing behavior for that segment, and thus to refine future offer management processes to better seek to align the buyer's behavior, or to exclude undesirable buyers, as follows. Such a new application of price banding analysis to FP processes can optionally use regression or other techniques to assess various factors that can justify a value-based price, and then determine whether a given buyer's FP pricing behavior is consistent with those factors. The example of merchandising strategy given in the tables above might be interpreted as being an example of four segments, with offer policies designed to identify, respond to, and shape those segments, thus bringing buyer behavior closer to the segment-price banding sought by the seller. Far richer segmentation structures than this example can optionally be applied, based on banding and/or other analyses, with far richer variations in offer structure, terms, and framing.

As a further non-limiting example of how communications to buyers can optionally be varied in accord with the new form of segmentation objectives relevant to FP pricing set by buyers, buyers can optionally be segmented and managed based on the importance of product differentiation and difficulty of product comparison or search, as follows:
Value-driven buyers can optionally be given offers and background that highlight value received, such as FP offers with appropriately well bundled feature sets and metrics and supporting data to reveal the value delivered by the relevant features. Buyer-seller dialog can optionally be structured to encourage collection of rich data on value obtained, for use in a wide range of ways, as described elsewhere herein. As one non-limiting example, a seller of stock recommendations can optionally obtain rich data on the potential value of such a recommendation, and on the actual value as realized by the buyer, such as over a series of resultant trading actions over an extended period, using a range of data sources, including automatically and/or independently obtained data and/or data explicitly reported from the buyer.
Price-driven buyers can optionally be given FP offers and background that highlight economy, such as offers and metrics focused on basic feature sets
Brand or relationship-driven buyers can optionally be given FP offers and background that highlight the value-add of the brand or relationship, such as by integrating superior customer relationship management support services with the FP offer, pricing, and service processes.
Convenience-driven buyers can optionally be given FP offers and background that are highly streamlined, such as offers with very simple terms, simple metrics, and tools for pricing that emphasize simplicity in the product/service as well as in the pricing process.

The embodiments disclosed herein can optionally build on and extend powerful analytical and data mining techniques and business systems, including ERP and CRM functions. Some non-limiting examples of specialized systems for pricing support that can optionally be extended to support the FP methods include systems from such companies as ZILLIANT, VISTAR, and VENDAVO, some of which can optionally be integrated with other ERP/CRM systems, such as VENDAVO is with SAP.

It is also noted that methods for estimating price sensitivity from data such as buyer preferences and/or intentions, especially those using methods such as conjoint or trade-off analysis to identify price sensitivity of potential customers with respect to specific product/service attributes, can optionally be applied to managing the FP offer processes to better identify and define customer segments and price sensitivities, and to frame offers in ways that optimize offers and resultant FP pricing behavior with regard to each buyer's objectives and value perception, as recognized by the seller's FP systems. Such methods for managing the FP processes can optionally be applied within segments of multiple buyers, or dynamically targeted, customized, and/or personalized to segments of one. Product attributes considered can optionally include product versions and features, and product versions can optionally be packaged or bundled to support desired segmentation.

For example, a software package might ordinarily be sold in different versions having different feature sets, with premium versions having richer features. Using FP methods, a seller can optionally identify the premium features and communicate that to the buyer/user, and track whether (and possibly to what extent) those features are used by a buyer. Knowing this, the buyer can optionally consider whether he wants to use the premium features and adjust his FP pricing actions accordingly. This also demonstrates the self-adapting capability of the FP methods, at multiple levels. At one level, the buyer decision on which “version” to use can optionally not be made in advance, but can be deferred until the added features are desired. At another level, the seller can optionally not predefine specific versions at all, but can simply report usage with respect to features, and allow the seller to consider that use of more advanced features warrants a higher price, and can allow for adaptive learning over time as to whether to use and pay for “premium” features.

To clarify one aspect of this example, FairPay can optionally be applied to the use of the premium features, with the standard price for the standard software serving effectively as a minimum floor price, Thus, in this usage, the user can optionally buy (or subscribe to) the standard version for the standard fixed price, but be offered the use of (some or all) available premium features on a gated FairPay basis. Then, if the pricing set by the user for such premium feature usage is determined to be acceptable (considering whatever factors might be appropriate), the offer continues, and if not, the user can optionally be given the choice to either be limited to the standard features (for the fixed standard price), or to pay a fixed upgrade price to get the premium version.

As a further non-limiting example of communications and framing illustrating some of the points made above and in the next section, Appendix B presents a simple example of how a FairPay offer can optionally be framed to a potential buyer, in this case for an online newspaper subscription.

Further Aspects of Communication to and from Buyers and Related Data Analysis

As noted above, the FP methods, in some embodiments, shift aspects of pricing processes from the seller to the buyer. As a result, embodiments can optionally be accompanied by enhanced communications to the buyer (and back to the seller), at any and/or all stages of sale and use processes to support desirable behaviors. Attention can optionally be paid to communications at the time of the offer, to frame the offer in a way that most effectively prepares the buyer to understand the value proposition and pricing basis intended, and, at the time of pricing, to add to that understanding and support a win-win pricing action that can lead to sustained satisfaction on both sides. Many embodiments of the FP methods involve new kinds of buyer-seller cooperation to achieve a mutually satisfying transfer of value, and enhanced communication in both directions might be supportive of that cooperation. (As noted previously, in many embodiments seller systems will be highly automated and in such cases most or all of such seller communications, and related analysis, should be understood as being managed in whole or large part by more or less advanced automation on the seller side. At the same time, some embodiments can also involve highly advanced levels of automation on the buyer/user side, and in such cases the buyer/user communications, and related analysis, outlined herein should be understood as highly automated as well. As also noted before, for ease of exposition, the term “user” in such contexts should be understood to include usage as referring to a system element operating on behalf of a human user.)

In addition, particularly as these unconventional and unfamiliar methods are first introduced to potential buyers, it can be useful to frame the concepts, rationales, assumptions, and expectations the seller has, and to explain the key processes, the buyer's responsibilities, the data collection and feedback processes, any buyer data privacy considerations, and the expectations for fairness in the buyer's pricing actions, as well as any other useful background. Effectively, FP offers can optionally be framed as a privilege extended to responsible buyers, with attendant responsibilities expected in order to continue to receive similar privileges in the future.

In extending the offer, communications to the buyer can optionally include details that support the desired market segmentation. This can help set and validate expectations on price, on offer terms as related to features and metrics, and on the fit of the segmentation assumptions being applied. At the time of setting a price by the buyer, communications can optionally add details on the usage of the product, which can include information intended to ensure that the user fully appreciates the value received, such as usage details, and understands how to set a price appropriately, such as by receiving data on past pricing by the buyer and by other buyers. Such data on other buyers can optionally be limited or positioned to emphasize data relevant to the buyer's market segment. Effective framing of such communications, and selection of the background and data and analytics made available, can in some cases seek to limit the buyer's view to the seller-intended segment, or in other cases, can be more open in order to guide the buyer to self-select his proper segment and to cooperatively recognize how to price appropriately to that segment.

Expanding on the discussion of cost data, it should be understood (in such aspects as buyer-seller merchandising and communications considerations, and production optimization, and in utility metrics) that in addition to marginal costs, as referred to above, a more precise understanding of costing can optionally distinguish true marginal costs from closely related concepts of variable costs and of incremental costs. It will be understood that choice of the particular cost parameters to use and/or communicate in various situations will depend on the particulars of the situation, and the references herein to marginal cost and to fixed cost should be understood to apply to the respective similar parameters, incremental/non-incremental, and variable/fixed, unless otherwise indicated or clear in context. It is further noted that some of the analysis and decision parameters described herein can optionally by viewed in terms of avoidable costs as opposed to sunk costs, and that joint costs and/or activity-based costing can be desirably applied in some situations, as well as any other cost information deemed relevant. References to cost parameters herein are to be understood to refer inclusively to all appropriate variations and refinements in cost analysis, unless otherwise indicated or clear in context.

Expanding on the discussions of usage data as applied to setting prices and interpreting pricing behavior and related cooperative processes, it is noted that improved communication, and improved characterizations of usage by a buyer, and relative to other buyers, might be helpful. Digital products and Internet-based commerce are particularly well-suited to facilitating collection and communication of usage information. Usage can be done in a context of ongoing interaction with seller servers or other systems that can track a wide variety of usage data. For example, a wide variety of highly detailed usage data can optionally be available for Web or other Internet-based services, including number and identity of pages viewed, times of viewing, dwell times, interaction paths (clickstreams), queries and other functions requested, and/or the like. In cases where digital or other products/services are used without ongoing interaction with a server, instrumentation can optionally be added to collect data similar to that collected online. Such instrumentation can optionally use ongoing real-time communications if practical, and/or alternatively, opportunities for periodic reporting of activity as relevant times can optionally be exploited to gather data. It can in some cases be preferable that such data collection be done implicitly, using instrumentation that requires no user action or awareness (subject to any desired privacy limits), but such data can be supplemented as desired by explicit collection actions, which can optionally include more or less structured surveys. Such explicit usage data can be as simple as a single click on a selector button to indicate that an product/service element (such as a Web page, song, video, etc., and/or a current aggregation of such items) was accessed and judged satisfactory, or thumbs up/down buttons giving positive or negative signals. This can optionally be done in response to usage triggers or at some time interval and such collection can optionally be initiated by sellers and/or buyers. To the extent that such usage and/or rating feedback elements are available for other purposes, those mechanisms can optionally also be applied and optionally extended for this purpose. Examples of such feedback data that is at least in part a byproduct of other needs include Web and/or other usage tracking, digital rights management (DRM), and or the like. It is further noted that the use of such data to increase the transparency of FP pricing processes and related consideration of fairness and/or the like can optionally be positioned to buyers as making the collection of such data more beneficial to them, and thus make such practices less subject to objection on the basis of privacy or the like. Such mechanisms can optionally also include third party activity and/or rating feedback mechanisms, such as those offered by various Web services (including such non-limiting examples as Digg, or the Facebook “Like” button) as well as the more advanced and wide-ranging rating data collection and analysis methods described below.

Products/services can optionally be designed such that where disconnected use is possible, connections for such reporting purposes can be used, such as by use of locking methods that depend on server contact to unlock use and/or further use. Collected data can optionally include data of any kind, such as without limitation, data on the intensity and nature of usage, with varying levels of detail and/or granularity as to features, functions, contexts, and results, and with provision for user annotations and comments. As noted above, such data can be useful in price setting, offer management, market segmentation, and/or other processes.

Drawing further on sources of product/service usage data, similar data might be available in various forms, whether arising from existing market activities and data collection processes, and/or those developed to support FP systems and services as disclosed herein. Such sources of data include methods of collecting usage data and ratings from users and/or from intelligent products or other devices (explicit and/or implicit), and for aggregating and assessing user ratings of products, aggregating and analyzing such data, characterizing the usage of products, and the like, across a population of users, all of which can be supportive of the methods described herein. Such applications can optionally include collection and interpretation of such data to characterize and quantify use, to derive estimators for value received, including indications of positive and/or negative value, problems, benefits, ease of use, effectiveness of use, proficiency, and many other factors that might bear on determining FP pricing fairness reputations and in the decision processes related to reputation, usage, and other factors. With respect to the use of instrumentation, as noted earlier, to collect usage data with no need for user action or awareness, and with high objectivity, such instrumentation data can optionally come directly from the subject product/service, and/or from other data sources accessible in conjunction with the subject product/service. Various kinds of usage data, whether obtained from user input, whether implicit or explicit, and/or operational measurement instrumentation and/or any methods for aggregating and analyzing such data, can optionally be incorporated as component elements into the computation and/or adjustment of TFRs, CFRs, PFPs, OAFs, and other FP computational and decision methods/processes/functions as described herein. Some further non-limiting examples of usage data that can optionally be obtained and methods by which they can be quantified and weighted as component elements of this kind include the following:
Obtaining cost of ownership and/or lifetime cost of products/services, including maintenance, repairs, supplies/consumables, related costs and benefits, etc.
Estimating value/utility in various forms, scaling value/utility metrics obtained from diverse sources, distinguishing objective and/or clearly explainable components from subjective and/or less clearly explainable components of value/utility data, working with various forms of value/utility metrics, and applying statistical methods of the kind useful in assessing distributions of such metrics, including probability distributions, probability density functions, cumulative density functions, normal and other distributions, trust metrics, statistics of means, standard deviations/variability, skewness, kurtosis, curve fitting, fractiles/percentiles, etc.
Provision of shopping and asset management tools, from any provider and intended for any of a variety of purposes, that can optionally integrate with similar tools for FP processes, to aid users in shopping for and in managing use of the products/services (assets), and that can generate data relating to such shopping and use, whether using FP or conventional pricing methods. These can optionally include bots/agents supporting buyer asset management in the product/service use cycle, decision support systems, analytics, normalization and conversion aids, access to aggregators, feature comparisons and parametric analysis, integration with other relationship services including incentive/reward programs, maintenance and service programs, digital rights management, etc. Many such methods, even those provided for purposes unrelated to FP processes, can optionally be applicable to achieving the growing levels of buyer-side automation and decision support suggested herein, and such methods can optionally facilitate the collection of many kinds of data that can be applied to FP analysis and decision processes. Some further discussion of such buyer-side support is provided below.

Also, as noted above, one aspect of buyer reputation in some embodiments can optionally relate to the quality of the explanations the buyer provides for his pricing actions, such as for pricing relatively high or low with regard to specified value factors. Such explanation quality/reliability attributes can, for example, include factors relating to credibility, honesty, objectivity, reasonableness, consistency, and the like. A variety of methods can optionally be applied to collecting and assessing the explanation quality/reliability of buyer feedback regarding products and/or services and their perceived utility in quantitative terms suitable for use in the various FP pricing reputation assessment computations and metrics describe herein. Such methods include, for example, methods for obtaining direct and/or indirect feedback, applying statistical methods to comparing feedback among buyers, finding disparities, agreement, disagreement, inconsistencies, extremes, skews, bias, and other factors affecting the objective, quantitative interpretation of such data, and for making adjustments to compensate and/or normalize such data in ways similar to those described above. Similarly, to the extent that FP prices and other related feedback reflect buyer judgments of value/utility that can be related to other available data sources, any quantitative methods suited to evaluating the objectivity/reasonableness of such value/utility judgments as reflected in FP prices can be usefully applied. Various statistical methods can optionally be applied to identifying individual buyer variations in pricing, relating those variations to any available objective data on usage, performance, value, utility, problems, and any of the various metrics that objectively affect FP prices, and separating out the more subjective component of such variations. Such statistical methods can optionally be applied in the computation and/or adjustment of TFRs, CFRs, PFPs, OAFs, and other FP computational and decision methods/processes/functions as described herein. As a more particular example, such statistical methods can optionally be used with the various data sources described herein and/or any other available data, to separate the objective component of buyer pricing decisions and/or other feedback, such as those related to verifiable differences in usage, quality, problems, and the like, to determine that after such adjustment (based on statistical explanation relating to apparent contributing component factors, such as by using regression analysis), a given buyer has remaining unexplained disparity suggesting bias toward high or low prices and/or other feedback reports, or that the buyer shows a pattern of apparently subjective and/or not clearly explainable extremism in both directions, and to quantify such explained and/or unexplained component patterns in terms of statistical metrics. The various FP processes described herein can optionally, derive factors based on such determinations and metrics to lower reputation metrics for those determined to be likely be exhibiting a subjective bias to price low and/or provide negative feedback reports, or to raise reputation metrics for inferences of positive bias, and/or to include factors for consideration of apparent instability/unreliability/risk, whether by lowering reputation metrics, and/or by applying supplementary decision parameters/metrics that quantify such instability/unreliability/risk.

Other sources of data relevant to assessing FP prices and buyer feedback might be available from various services and/or databases that might provide forums and/or rating services and/or the like that facilitate sharing of such data among buyers, and assist in the use of such data in detail and/or summarized form. Regardless of whether integrated with FP processes, or managed more or less independently, such crowd-sourced information can optionally supplement and/or serve as a complement to the data relating to the context of FP pricing evaluations, as reported by buyers and assessed for fairness and/or other criteria by sellers, such as with regard to reports and assessments of value/quality/satisfaction and/or the like. For example, such data can optionally serve as supplementary “comparables” data on how other buyers view more or less equivalent products/services. Such crowd-sourced comparables data can then be used, in similar ways to that of the various forms of comparables data disclosed elsewhere herein, to assess and weight feedback from a buyer. As a more particular example, in a case where a buyer had reported dissatisfaction with a product/service in an aspect not readily subject to objective verification, such a report can optionally be given higher credence/weight in FP processes if crowd-sourced data indicated that other buyers/users of the product/service often agreed with the buyer report, and lower credence/weight if crowd-sourced data indicated that other buyers/users of the product/service consistently disagreed with the buyer report.

In some such buyer forums and/or rating services, aspects of buyer feedback on a product/service/seller can optionally not be private between the buyer and the seller (and/or any agents of the seller), but rather can optionally be accessible to other buyers, and such feedback can optionally itself be subject to comment and/or ratings by those other buyers. Such ratings of raters by peers can optionally be applied to contribute to quantitative evaluation by sellers (or their supporting services) of a buyer's peer-rated reliability for providing meaningful feedback on value, quality, satisfaction, and other product/service usage issues in support of the methods described herein, such as to develop consensus evaluations of product/service value and, indirectly, of whether peer ratings add or detract from an expectation that a buyer might be inclined to set FP prices fairly, and to explain them reasonably and honestly. Such peer ratings can optionally be collected and analyzed across broad populations or within arbitrarily narrow segments (sub-communities) and/or product/service domains. Thus, analysis of comparable FP pricing decisions, in which a given buyer's prices and related value feedback is compared to that of other buyers, can optionally be weighted, using FP pricing reputation methods using inputs from buyers with regard to their own transactions, as described herein, and supplemented with inputs from complementary crowd-sourced data to derive additional functional components (such as weighting factors) that can optionally be used to further adjust TFRs, CFRs, and/or other FP reputation metrics. Such data can aid in better evaluating how a given user's pricing behavior compares to others, and how much credibility to give to a given user's feedback on value/quality/satisfaction and the like, based on the further inclusion of the crowd-sourced, assessments from other buyers with regard to a subject buyer. Thus comparable prices from those rated by peers to be reasonable can optionally be weighted higher than those rated by peers as unreasonable. As described for other sources of data, such public ratings and any such peer-ratings could be compared within the most relevant sub-communities, such as those with similar pricing behavior, usage level and/or type, economic status, demographics/psychographics, location, domain expertise, social graph-relationship, or any other useful segmentation. Similarly, similar crowd-sourcing methods and databases can also be applicable to assist in evaluating buyers' assessments of sellers (as distinguished from the items they sell), and applied to provide inputs that can optionally be quantified and used in FP processes to factor in variations in willingness to pay by a buyer with respect to different sellers, and/or whether that might be particular to a given buyer or might reflect a commonly shared pattern, considering any of the characterizations and criteria affecting that, as noted herein. Also, in a similar manner, information on sellers, and/or their services/agents, with regard to their roles and their proper behavior in FP processes (such as for example in all aspects of customer relationships and/or in the reliability of seller inputs to cross-seller FP reputation ratings) can optionally be collected in various forms and also be subject to crowd-sourced rating and similar peer-reputation processes as component inputs to FP processes that combine data from multiple sellers, so as to assist in weighting data, including for example FP reputational inputs, to favor more highly inputs from sellers assessed as reliable, whether from buyers and/or from other sellers, and/or, conversely, to discount similar inputs from sellers assessed as unreliable.

Further to the above, additional disclosures relating to methods for post-sale data collection with applications to product selection, purchase, usage data collection and reporting, and valuation of products/services are contained in U.S. Pat. No. 7,406,436 to Richard Reisman, “Method and apparatus for collecting, aggregating and providing post-sale market data for an item,” which is incorporated herein in its entirety by reference. Any combination of the various methods disclosed therein can optionally be used in conjunction with any of the embodiments of the methods disclosed herein to achieve even better results, such as with respect to pricing process effectiveness, fairness, and the like.

Also further to the above, additional disclosures relating to “the wisdom of crowds” and methods for collection and for ranked and/or weighted evaluations of such data are contained in co-pending application Ser. No. 10/692,974, “Method and apparatus for an idea adoption marketplace,” which is incorporated herein in its entirety by reference. Any combination of the various methods disclosed therein can optionally be used in conjunction with any of the embodiments of the methods disclosed herein to achieve better results, such as with respect to pricing effectiveness, fairness, and the like.

Further, any combination of the various methods disclosed in either of U.S. Pat. No. 7,406,436 and co-pending application Ser. No. 10/692,974 can optionally be used together in conjunction with any of the embodiments of the methods disclosed herein to achieve better results, such as with respect to pricing effectiveness, fairness, and the like.

The methods described herein also facilitate an entirely new way to achieve many of the effects sought in performance-based pricing and/or outcome-based pricing, and FP offers can optionally be explicitly framed in ways that support that usage. The buyer can be encouraged to exploit the features of the FP process that allow pricing criteria to be dynamically set by the buyer at the time of pricing (keeping in mind the understanding that the seller can optionally review that in determining future action). Such features could reflect the performance of the product/service and/or broader outcomes resulting from use of the product/service, and can optionally do that and reflect considerations of value, utility, cost/effectiveness, and the like with a richness of nuance that can only be achieved after the performance or outcome is tested and known, so that factors that might not have been recognized or fully appreciated can be fully considered.

From this perspective, it can be useful to allow for multiple stages of pricing, or for positive or negative adjustments to prices that have been set and paid, after further experience is gained, as was suggested above. For products/services having a long lifetime of delivering value, such ongoing price adjustments can optionally be applied over that entire lifetime to provide appropriate compensation for ongoing value that continues to meet (or exceeds or fails to meet) expectations. Methods for continuing tracking of such use and related benefits, and for requesting pricing reviews on a periodic and/or event-driven basis can optionally be applied in such contexts. By facilitating such a life-cycle view of pricing and providing the tools to manage buyer-seller dialog over that life cycle, FP processes might facilitate wide use of pricing models more reflective of the true value exchange over such a life cycle. For example, pricing can optionally be framed and managed as having life-cycle components, such as an initial acquisition price (possibly one-time or otherwise discrete, reflecting initial costs and values), an ongoing usage price (possibly reflecting ongoing costs and values, as functions of time and/or usage), and life-cycle increments (possibly reflecting costs and value of longer than typical life). Such methods can optionally facilitate better matching of pricing (flat, variable, component, and/or other variations) and product design as related to product life over a diverse range of usage life-cycles, such as for disposable versus extended life products, and for individual buyer context variations in useful life for a product (such as a car that was used for well over 200,000 miles vs. one traded in after 20,000 miles, and how that value varies from one buyer to another). Accordingly, in some embodiments transactions can be treated as having a more or less open-ended lifetime, such as with no closure and/or with a closure that is contingent and subject to reopening as warranted.

Here again, joint communication and effective framing of offers by sellers might be relevant to guide buyers to acceptable ranges of pricing behavior. For example, with low marginal costs, pricing guidance can optionally be framed to be heavily weighted to performance/outcome-based criteria, while in cases of higher marginal costs, pricing guidance can suggest that some or all of the costs should be compensated even when performance/outcomes are not all that was desired (possibly with consideration to the inherent quality of the product/service, or lack thereof). Similarly, the offer framing process can optionally give guidance as to what kinds and/or levels of performance/outcomes metrics are viewed by the seller as appropriate, and what kinds/levels might be less appropriate.

As suggested elsewhere herein, for some embodiments, such dialog on pricing considerations can optionally be conducted at various levels, ranging from sellers simply reacting to buyer set prices in setting future offers, to more negotiation-like interactive processes in which the seller proposes his suggested pricing with details on metrics, criteria, rationales, evaluation processes and the like to the buyer, and the buyer proposes his suggested ones to the seller. Such negotiation-like processes can optionally maintain sole buyer discretion with regard to pricing of a given transaction within any predefined constraints, with seller control limited to the handling of future transactions, or can provide for any level of seller control that the seller wishes to have and the buyer is willing to accept. For any and all process parameters, this range of possible embodiments can be viewed on a spectrum from complete buyer control, through full joint negotiation, to full seller control. In regard to such variations in buyer versus seller control, in some embodiments the ground rules for such decision processes can be clearly specified at the time the offer is made and accepted, to avoid misunderstandings and disputes as the process unfolds. Conventions for such understandings might become widely recognized as embodiments of these methods become widely used.

As noted earlier with respect to subscription pricing, similar forms of dialog on buyer price setting can optionally be broadly applied to communicate a seller's perspective on buyer price-setting actions, even where relatively simple pricing criteria are thought to apply. Tighter coupling, increased visibility, and possible negotiation can be useful for a variety of reasons, in a variety of contexts. Thus it can, in at least some situations, become common practice for the seller to provide timely feedback on how a buyer-set price is being evaluated, and/or how it can be expected to affect the buyer's overall FP reputation (whether with a single seller, or across multiple sellers), so that buyers can optionally reconsider their pricing actions from that perspective.

One situation where this can optionally be used is when a buyer's pricing puts his reputation in jeopardy, or lowers it at all. In particular, buyers just learning how to behave in a FP pricing environment might be fearful of pricing too low and thus being precluded from further offers, or might not even realize they are at risk when they are perceived as doing so. To soften the risk of surprise negative effects (and/or undue fear), a warning can be useful, and making it known that such warnings might be provided can also be useful.

Practices can optionally range from simple rules to issue warnings only at given thresholds, whether strongly negative or just borderline, to more widely applied and perhaps richly detailed forms of feedback that indicate how a buyer's price is being assessed, at varying levels of detail, and in terms of any absolute or relative criteria. For example, rules can specify that buyers be informed that their FP price is at a given percentile or quartile level compared to others for that item, whether overall, or for those in similar circumstances, and/or that their price moves them to a lower FP rating, such as a lower CFR, and/or brings them close to a threshold of some kind related to ratings, CFRs, and/or other FP rating/offer criteria. The rules can optionally provide that such information be provided only when a buyer is deemed in need of a warning, such as for being at a low pricing/reputation threshold, but can also be provided in other contexts, and can optionally be routinely provided in market contexts and/or buyer-seller relationships in which high transparency is determined to be desired.

Depending on context, such warnings can optionally lead to options for immediate re-pricing actions for any transactions in question, or can be taken as notice that things are moving in a negative direction, and that future pricing actions that extend or increase that negativity might be problematic. Processes can optionally provide for a probationary stage, with one or more levels, in which buyers with new or declining reputations are treated with special care, such as by limiting value at risk, and such buyers can be treated with more intensive communications designed to enhance understanding of and compliance with expected behaviors, such as providing notice that they have been placed in such a probationary status, and notice as to their continuing status as it evolves. Such measures can optionally provide for a soft-landing and facilitate remediation in cases where pricing behavior perceived as unacceptable might be a result of insufficient understanding and communication in either direction.

Indications to buyers of pricing that is viewed as especially high can also be useful, even at risk of lowering such prices, to limit risks that buyers might later learn that they have paid more than they might later view as fair, as they gain knowledge of pricing practices in a given market.

As discussed further below, such issues involve complex and novel behavioral economics considerations that may take time and experimentation to find best practices for various market contexts.

Similar rich variety can optionally be applied in managing dialog relating to the timing of buyer pricing actions and of seller requests for pricing actions. These can vary depending on the nature of the product/service, and the particular buyers and sellers involved. Requests for pricing can follow coincident with, or soon after, delivery of the product/service, or after some interval for expected or measured usage. Buyers can be given varying amounts of time to take pricing actions after fulfillment and/or a pricing request, and this can be dependent upon buyer reputation and other context parameters. For example, rules can specify that buyers with high FP reputation ratings and/or high FP credit limits can be given more time (e.g., a month) than those with less favorable ones (e.g., a week). Buyers can be permitted to request additional time to take pricing actions, and to submit reasons for such requests, such as delay/lack of use, desire for further evaluation, etc., and dialogs can be undertaken regarding such delays. Delays in setting prices, whether unexplained or not satisfactorily justified can be factored into pricing reputation. Depending on reputation and other context, delays in pricing can be treated as more or less equivalent to setting a zero price (or other low price), until satisfactorily remedied. Thus in some cases, new offers can be held back until a previous transaction cycle was priced, while in other cases a buyer can be permitted to have a number of open transactions outstanding and still obtain further offers.

In one embodiment, buyer-seller dialog can optionally be done using machine-understandable forms, possibly with options for supplementary entries in free-form text, voice, video, or other formats which might require human interpretation or live human interaction (e.g., see FIGS. 5B and 6B).

More on Relationships, Behavioral Economics, Names, Name Theory, and Social Consciousness

As already outlined in numerous examples, the methods described herein introduce a whole new range of considerations in the ongoing relationship between buyers and sellers, and make many previous considerations more important. As these methods become familiar in the marketplace and are applied to diverse market environments, considerable evolution and increasing levels of sophistication might be expected. Some additional suggestions of possible directions are outlined here.

Broadly speaking, these methods can be viewed in terms of their behavioral economics (including considerations of how actors might not act entirely in terms of pure economic rationality), and behavioral economics studies can optionally be applied in designing particular embodiments to achieve desired behaviors from buyers (and sellers). At the same time, the feedback and data collection processes described herein can optionally provide a source of data for such behavioral economic studies, and such studies can optionally be tightly integrated into marketing, merchandising and other business processes. Similarly, these methods can be further understood in terms of game theory, in which the buyers and sellers are players in complex, ongoing or continuous game. Such game-theoretic analyses can shed light on individual interactions, series of interactions of a seller with multiple buyers, a buyer with multiple sellers, and any combinations up to and including an entire marketspace with rich assemblages of buyers and sellers and support services and intermediaries. Thus game-theoretic principles can optionally be built into the FP processes described herein. Some examples of behavioral economics and game theoretic aspects already touched upon include the buyer's feelings toward the seller, altruism, and “social costs.”

Some example of such broader considerations and how they can optionally be reflected in some embodiments are as follows:
Much pricing of digital content is done on a flat-rate, “all-you-can-eat” basis because consumers seem to prefer that to a ticking usage meter, even if that might be economically inefficient on both sides. FairPay might allow buyers to not feel enslaved by usage meters, but to view usage reports as guidance in setting their prices. Thus buyers who are heavy users, and/or who use lots of premium items or services, might recognize that they should pay at relatively high rates—possibly more than they would under conventional flat-rate pricing. Similarly, light users might recognize that they may be justified in paying less than average users, at least in that respect.
Being eligible for future FairPay offers can optionally be positioned as not a simple yes or no decision, but one with many levels. Buyers might be told that those who pay better than average will get enhanced offers and those who pay below average (but not unacceptably low) will get bare-bones FairPay offers. This can optionally relate to larger amounts of product/service being made available before a price must be set, access to more premium item types, or other perks. In this respect, FairPay can optionally be configured to behave much like freemium.
Perks can optionally be similar to the perks in frequent flyer programs that provide upgrades, visible recognition and status, and other special privileges. Such methods can optionally include making some aspects of good payment behavior visible as a status symbol (possibly only for those buyers who seek that kind of “conspicuous FairPayment”). Such perks can optionally be pre-designated, but some hints of surprise bonuses can also be provided. Such expectations of surprise effects might entice buyers and make it less useful to try to “psych out” the process to minimize payments. Similarly, some random component to both positive and negative effects of buyer pricing can be broadly useful to impede efforts to outsmart the process.
Also, a good FairPay reputation can optionally depend not only on how well a buyer pays, but on how well he explains why he paid especially well or poorly in specific cases. This can give the seller valuable feedback not just on pricing, but on the merits of their product. Buyers can optionally be given visible recognition for such thoughtful feedback (such as virtual badges, or real tote bags, or other real or virtual items) naming them as elite partners, a form of status reward that consumers can optionally seek to earn and display.

Broadly, these and other enhancement methods can optionally be based on concepts of game mechanics that allow buyers to treat the FP process as a sort of game to be played for fun and psychic as well as economic reward, and to further motivate them to interact deeply with sellers in these pricing, feedback, and other dialog/feedback processes. Such methods can optionally include a game layer that adds processes, including tools/capabilities and score-keeping elements, to exploit social and competitive drives, both to cooperate with and benefit from social networks, and to gain status or recognition from others. Such status and recognition can take varied forms, including both FP offers and broader elements, including any mixture of virtual and real activities, challenges, and rewards. Such game layers can take any form on the spectrum from separate layer to deeply integrated with other aspects of FP and/or related commercial or other processes.

Such methods can be useful not only to move average payers to pay more, but to convert bargain-hunters to be less fixated on price and more on relationship and value. A related aspect of this is how well the seller can position the price paid as being a well-deserved compensation for value creation, and necessary to ensure a continuing supply of value. Such positioning may be relatively easy for sellers who can indicate that most of the price goes to compensation to artists, journalists, or other human contributors. It is also likely to benefit companies that are perceived as being focused on consumer value, or who are recognized for superior service, or for other kinds of social benefit, such as green/sustainable, charitable, etc.

The addition of charitable elements can be effective in increasing buyer willingness to price fairly. For example a seller can optionally frame the FP offer such that a percentage of the price goes to charity, in order to gain positive consideration and discourage free-riding. Such a percentage can be pre-set by the seller, or buyer controlled, with or without suggested levels, and the selection of the charity can also be set by the seller, or buyer controlled or selected. In such cases, the decision process for subsequent offers can optionally take into account not only the price, but any or all of the percentage and amount to charity and the percentage and amount to the seller.

As noted earlier, the FP methods can be applied to consider all of these factors affecting how specific buyers determine willingness to pay for specific items from specific sellers in specific contexts. The methods described herein can frame offers, pricing processes, and other transaction-related experiences to suggest the relevance of any of these factors, obtain pricing and other context data in any desired range and granularity, analyze the related rich behavioral data from any and all relevant perspectives, and considering any and all relevant factors, to make offer decisions that are most effectively positioned in terms of any useful dimensions, to lead to a mutually beneficial interchange between any buyer and seller. Of course such data obtained in the course of FP processes can be valuable for many other uses, as well. Subject to acceptable limitations related to privacy and/or other buyer rights and concerns, such data can have considerable value to any of the parties in the marketspace, including parties not directly involved in a particular buyer-seller relationship.

Drawing on the perspectives of economics and on buyer-seller communications outlined here, one design objective of many FP embodiments can be to facilitate maximum recognition of perceived fairness by individual buyers, for themselves, and across the market, as for the general welfare. For example, with regard to the perspective noted earlier with regard to allocation of the surplus between the seller's marginal cost and the buyer's marginal utility and/or willingness/ability to pay, FP methods can be directed to seek a mutually satisfactory sharing of this difference. Some embodiments can explicitly frame pricing decisions to relate to a consumer surplus (which is generally defined in economics as the difference between a price paid and the reserve price that is the maximum a consumer would be willing to pay), and/or to the total surplus between cost and reserve price. In varying forms, such embodiments can frame fairness in terms of dividing some measure of such a potential surplus such that the consumer keeps a fair portion of the surplus as a benefit, but yields a portion of the surplus to the seller as a fair profit. (Of course, should a product/service be judged as unsatisfactory, the price can optionally still acceptably be set below cost.) FP embodiments can optionally use the full range of communications to frame the pricing context to seek a division of such a surplus that is mutually agreed to be fair in terms of multiple dimensions, such as 1) with regard to costs and benefits, 2) with regard to pricing for transactions between a buyer and seller over the life of a relationship over time, 3) with regard to prices paid by other buyers, considering whether in similar or differing contexts and circumstances, and/or 4) with regard to any other useful dimensions. As noted above, a wide variety of reference data can optionally be made available to assist in such considerations. Both buyer price-setting and seller evaluations of fairness can be framed and evaluated with consideration to any and all of these dimensions. And as noted, in the ongoing context of typical FP embodiments, it might be recognized by all parties that fairness can be judged on an aggregate basis, to a greater or lesser extent, without excessive concern that every transaction be priced perfectly fairly in all respects, as long as the balance is perceived as approximately fair over time.

Another aspect of some embodiments of FP is this broadening of focus from pricing of individual transactions to a pricing relationship that evolves and converges over time, and thus can seek fairness and/or optimality in ways that are not feasible with methods that are more focused at the level of isolated transactions.

Many other aspects of FP processes can be managed to gain maximum benefit from behavioral economics effects, whether related to fairness or other aspects of perceptions and decision processes. As just one non-limiting example, in some contexts the FP price setting process can optionally be couched in terms of a percent discount rather than a numeric price. For example, for a product with a standard fixed price of a pre-set value ($X), instead of being asked to set a price of $Y, the buyer can optionally be asked to set a discount of Z %. Here again, a bound, such as a floor level for any discount (a maximum percentage) can optionally also be specified. Such framing can encourage pricing to be more closely tied to the fixed price of $X, and position the discount as being justified relative to that reference price for whatever reasons might be given. Such discount-denominated pricing can optionally also provide for negative discounts, such as for situations where a higher-than-standard price seems justifiable.

Expanding on disclosures elsewhere herein, FP processes can be applied to buyer-side automation and decision support. In one aspect, such applications can facilitate market behaviors in which buyers seek out sellers in terms of the level of value they offer. Thus there is an aspect of applying FP processes in which the seller determination of which buyers set prices fairly is complemented by processes in which the buyer determines which sellers obtain prices and related buyer behaviors that are most fair and/or jointly favorable in some aspect, and/or which sellers evaluate buyer behavior most advantageously to buyers. Some embodiments can optionally focus on addressing such aspects. Making some or all FP data available to buyers, whether directly or via intermediary services, can enable buyers to search for and/or select sellers based on any of various metrics and algorithms that can determine and rank those sellers who are inferred to be the best to do business with by any of various combinations of criteria. For example, buyers might wish to do business with sellers that generally obtain fair and/or generous pricing from other buyers in terms of some criteria/metrics, with the idea that such sellers offer better value than those that generally obtain lower value by such criteria/metrics.

Here, just as with seller assessment of buyer fairness and/or related behavior, a full range of context data can also be potentially useful. For example a seller selection tool that serves buyers can optionally enable searching and/or filtering of advertising, listings, catalogs, aggregations, offers, and the like based on any combination of factors available in FP and/or conventional databases and/or shopping services. Such factors can optionally include FP prices, other prices, FP fairness and/or reputation factors of any kind, buyer data, seller data, data on buyer explanations, seller evaluations of buyer explanations, and the like. Such a seller selection tool can, for example, enable a selection for sellers that obtain generous FP prices and for whom buyer explanations of pricing have few negative explanations and many positive explanations, whether in general and/or for specific types of explanations. For example, a buyer seeking high design and high quality can optionally be enabled to seek sellers that obtain generous FP pricing and few quality complaints, and many positive comments on design. Such selections can optionally be enabled broadly, such as for all products or services, in broad categories, and/or to arbitrary levels of product/service specificity.

Such embodiments of FP processes tuned to buyer selection of sellers and/or their products/services can take a rich variety of forms, including counterparts to most or all of the forms described herein for other aspects, with such variations as are suited to the objectives of this aspect. These potential forms include rich computation, analysis, and decision processes more or less equivalent to those described for seller evaluation of FP reputations and/or for use in offer decisions. As with the other FP process aspects described herein, these aspects can optionally be provided as specialized services and/or integrated with other marketplace functions and services of any kind

A further embodiment supportive of buyers can be provided to expand on the varieties of comparables data described above with regard to prices. For example, such facilities can facilitate assessments by buyers related to suggested and/or other reference pricing, and/or related to other information that sellers can optionally provide in framing their offers and requesting favorable pricing decisions. Examples of such broader forms of comparables data that can optionally be provided to buyers include analysis relating to suggested and/or other forms of reference pricing. Thus buyers can be enabled to determine how such suggested prices compare to those provided by other sellers, and to further evaluate that with respect to how buyers respond. Here again, considerable nuance can optionally be enabled using methods similar to those described herein with regard to FP pricing and buyer fairness. For example a given seller can optionally provide higher suggested prices than another seller, and might still obtain relatively more generous pricing responses from buyers, even within a comparable population of buyers, if that seller stood above the other with regard to quality, service, and/or other attributes that made buyers feel that they obtained higher value overall and/or wanted to compensate the seller more generously for any reason. As a further example, buyers can optionally use data on how different sellers rate fairness to seek sellers that are relatively more understanding and/or forgiving of behaviors and/or contexts that might be viewed negatively, and/or are more appreciative of those that might be viewed positively. To such ends, buyer-side tools can optionally provide arbitrarily rich data analysis and decision support tools, using the methods described herein, to interpret such data and aid buyers in determining a full range of aspects of how to optimally select sellers to do business with, and how to then work with those sellers to obtain best results, both in individual transactions, and in the broader ongoing relationship. As described elsewhere herein, this interplay of both buyers and sellers each seeking counterparts they can work well with can facilitate more efficient value exchange throughout the spectrum from the highly cost-conscious bargain hunter to the most price-insensitive seeker of quality and service.

A few non-limiting examples of some forms such buyer-side services can optionally take include the following:
An independent shopping search service that searches for specified products based on the kind of selectivity just described and that can optionally rank results by some statistical metric of differential value with respect to the item and/or the seller.
A shopping aggregator service, such as one much like Amazon.com, that provides integrated access to many affiliated merchants, with the addition of ranking features of the kind just described
A buyer-side shopping bot/agent or similar tool that integrates such services with other buyer-side shopping support services and interacts with seller-side services.
Any of the other more or less integrated services described elsewhere herein.

### Further Examples

To give a further perspective and demonstrate some of the features of the methods described above, the following non-limiting examples of practical use cases are provided. These are also meant to suggest in what ways rich system support services of the kind described herein can optionally be applied for such process elements as offer management, buyer-seller dialog, data collection and tracking related to usage, pricing, and the more subjective aspects of buyer-seller communication on usage, pricing, and context and valuation factors, as well as various other aspects of these processes. In some embodiments, these various system support services can reflect correspondingly full richness of features, although in some cases simpler support services can be workably applied to even the more advanced usage modes, especially as these methods are first introduced, and then augmented as buyers and sellers become more experienced in using processes of this kind While many of these examples relate to digital products or services, very similar methods can be applied to physical products and services.

### Example 1

This first example is provided for sales of music through a download service such as iTunes. As noted, songs on such a service might conventionally be sold for a fixed price, such as $0.99. An FP embodiment for such a service can optionally provide for sampling, aggregation, and risk management of FP offers as follows.
Established users of such a service can optionally be given an initial FP offer for some number of songs, N1, perhaps 10 songs, and asked to set a price for those songs within some limited time after purchase and download. Users could try the songs, and decide on and set the prices they are willing to pay.
The seller can optionally consider that feedback with regard to the buyer-set prices, relative to some Offer Acceptance Function, OAF, consider for this example a simple average. Based on that average buyer-set price, the seller can optionally decide (a) if the average of the buyer-set prices is below a minimum threshold for a second offer, T2, not to make further FP offers to that buyer (at least for some time, or until some remedial action is taken), or (b) if the average of the buyer-set prices is above that minimum threshold for a second offer, T2, to make a second FP offer. That second offer can optionally be for some larger second number of songs, N2, perhaps 20 songs. The function, OAF, can optionally check that the prices set by the buyer average at least $0.50.
The process for subsequent offers can optionally have multiple tiers with the same or different criteria, such as having a threshold for a third offer, T3, and setting the third offer to N3 songs, if the threshold T3 is satisfied.
This can optionally extend generally to i levels (or indefinitely), with Aggregation Functions AFi (Ti, Ni), for thresholds Ti and leading to offer aggregation levels Ni.

Thus, as a satisfactory history is built, the number of songs offered on an FP basis at each stage can optionally increase. As discussed above, such a sequential offer process allows the seller to manage risk, and allows a buyer to establish a FairPay reputation that results in increasing freedom to price as desired, and without having to consider and set pricing more often than is convenient.

Similarly, that same seller can optionally also provide for a free sampling capability, by making similar kinds of FP offers to new prospective users. Using the same or different quantities and functions/thresholds, new users can optionally be permitted to try 5 songs, again on a FP basis. If not satisfied with the operation of the service and/or the songs themselves (or simply not desirous of making further use of the service), the new user can optionally decide to pay nothing. In such a case no further offer would be made or desired, and the trial would conclude.

While this example describes digital products, application to sales of physical products can optionally be very parallel (e.g., for low marginal cost items). For example, this can be done for CDs, DVDs, books, packaged goods, etc.

### Example 2

As another example, consider an Internet video service that currently offers free service, supported by advertising, and has some premium services behind a pay wall, charging either by download/viewing, or by monthly subscription.

An experimental program can be offered to a selection of users based on FairPay pricing. This can optionally be aimed at heavy users, and offer ad-free access on a subscription basis on the following terms:
Ad-free unlimited access is offered on a month-by-month basis upon subscription.
Before the start of the next month, the user decides on a FairPay price to pay for the current month (with a usage report provided to the user for reference).
Depending on the FairPay price set by the user, the seller decides whether the subscription offer will or will not be extended for the next month (again on a FP basis, with a price-setting for that month to follow).

Once tested, such a FairPay subscription pricing plan can optionally be enhanced and offered more broadly, with various levels of service, such as for example:
Price setting can gradually be reduced to a yearly cycle for established subscribers with good FairPay reputations (with prices then set for the entire previous year).
The subscriptions can include options for access to premium content that can optionally be behind a pay wall (such as recent theatrical movies and pay TV and network hit programs, etc.).
Usage reports can be provided to assist in the yearly pricing reviews.
Payments can be monthly (even if price setting is yearly).

The options offered to any user on each renewal/pricing cycle can optionally be adjusted based on their pricing history (with consideration of any relevant circumstances known or reported).

### Example 3

A third example is for an online newspaper subscription service.

First, an experimental program can optionally be offered to a selection of readers based on FairPay pricing. This can be aimed at regular users on the following terms:
Unlimited access can be offered on a month-by-month basis upon subscription.
Before the start of the next month, the user can be asked to decide on a FairPay price to pay for the current month (with a usage report provided to the user for reference).
Depending on the FairPay price set by the user, the publisher can then decide whether the subscription offer will or will not be extended for the next month.
By coexisting with the paid subscription model, users can have a reference price, and the usage report can indicate how their usage compares to averages (and to the standard number of free articles).

Once tested, this FairPay subscription plan can optionally be enhanced and offered more broadly, with more varied levels of service:
Price setting can gradually be reduced to a quarterly or yearly cycle for established subscribers with good FairPay reputations, easing the hassle of price setting, and extending “FairPay credit.”
Usage reports in varying levels of detail can be provided to assist in the pricing reviews.
Payments can be monthly (even if price setting is yearly), for better cash flow and flexibility.
The options offered to any user on each renewal/pricing cycle can be adjusted based on their pricing history (with consideration of any relevant circumstances known or reported). Those who pay better than average can optionally get added rewards, and those who pay less can get less.

Thus those who pay fairly get increasing levels of trust and other rewards, and float above the pay wall, but those who do not get kicked back down into the pay wall.

This benefits both the publisher, and readers:
Users might feel more respected and empowered by the added trust and flexibility.
Some can optionally pay less than the standard subscription rate, but some can pay more.
Relating pricing to usage can potentially help get heavy viewers to pay more, compensating for those who pay (and/or use) less.
Many who might refuse the conventional subscription service might be willing to pay something reasonable for a FairPay service—added revenue to the publisher.
The details of the offers and the process can optionally be individually and dynamically tuned to encourage good payment levels, and to send free-riders back into the hard pay wall of the standard plan.

Again, this example and the prior Example 2 both described digital services, but similar methods can optionally be applied to other kinds of services.

### Example 4

A fourth example takes the case of a music and/or games publisher. The FairPay process for such a business can optionally be as follows.
A distributor of music or games can offer to let buyers try a few items on a FP basis, with the understanding that the buyer can try the item for a time, see if they like it, and then set whatever price they consider fair.
The full FairPay process can be explained in detail up front, so buyers understand that future offers are to depend on what reputation they develop for paying fairly.
The buyer can optionally try the items, then set prices, and can be facilitated to indicate why they paid what they did. For example, a buyer can optionally explain that they were disappointed in a product if that is why they decided to pay little or nothing for it. (Of course they can also say the love it, and/or love the band/developer, and want to pay especially well.)
The seller can then assess the price paid, and the reasons, and decide whether to offer that buyer more items on the same basis.
Those who pay well might expect therefore to get a continuing stream of further offers (as long as they continue to pay reasonably well). Those who pay well for some, and explain why not for others, might also expect to get a few further offers, effectively on a probationary basis, possibly until it is determined by the seller that they either do or do not pay fairly.
Those judged by the seller to generally not pay at an acceptable level can optionally be cut off from further FairPay offers, and can be restricted to conventional, set-price prepaid sales (at least for some time, possibly extending another chance sometime in the future).
The cycle can optionally continue indefinitely, based on these FairPay reputations.

Buyers using this FairPay process can be expected to recognize that they cannot pay zero, or very little, and expect to get further FairPay offers (except for occasional cases of explainable dissatisfaction). Unlike conventional PWYW offers, as sometimes used for special promotions for music and games, for which it is typical that a majority of buyers pay little or nothing, a FP seller can expect a majority to pay a reasonable price. And the longer this process runs, the more meaningful the FairPay fairness reputations of the buyers, and the better able the seller can be to manage revenue and risk, by controlling what offers are made to which buyers. FP pricing would also benefit from the post-sale timing of the pricing decision process in which the buyer need not factor in a discount to adjust for the risk that the product is disappointing.

This method can be especially attractive in situations where it is known to buyers that the artists or game developers (or other individual contributors) will get the dominant share of the price. Buyers can be especially motivated to pay at reasonable levels if they know that their payments are going to the artist or developer, rewarding them for a good product, and providing the compensation they need to allow them to continue to produce future products.

FairPay is also applicable to large recording studios and music and game distributors as well. For example, iTunes or Amazon could make similar offers across their entire inventory of downloadable music, or across some subset. They can optionally experiment with some selection of songs or albums. Perhaps they might start with less popular and familiar items that might especially benefit from the try-before-you-set-the-price features of FairPay, to increase sales (and revenue) even if the average unit prices are reduced. Similarly, subscription services like Rhapsody and Pandora can optionally apply FairPay to their subscription offers.

### Example 5

A fifth example considers usage for online travel guides, as suggestive of how very complex and variable usage and value considerations can optionally be addressed using FP methods.

In some cases different readers might get very different levels of value, so set prices may be too high for some potential users and too low for others. What if a buyer could have access to many guides, and pay based on the use he made of them? It is suggested that it can be impractical for sellers to set prices on such a flexible basis, but can be relatively easy for a buyer to do so (on an intuitive basis, aided with reference to detailed usage data).

Consider the range of situations for using a guide. On some trips one might spend a week or two in one large city, acting as one's own guide, and want to make extensive use of one, two, or more guide books to plan excursions, consult while sightseeing, select hotels and restaurants, etc. On a return trip to the same city some years later, one might not need nearly as much help. On a far-away small-ship cruise, one might stay a few days in two terminus cities, plus have day stops in half a dozen small towns in as many as five or six countries along the way (some with guided tours, some on one's own). On that cruise trip one might want limited use of one or two guides for each of the countries visited, even though some small ports might have little or no coverage in such guides.

Paying a set price for each guide, as usually packaged, might create significant dis-economies. For the multi-country cruise, and buying even a single set of guides to all cities/countries visited might be a poor value proposition (well over $100), so one might not buy any. For the single-city trip, on first visit, paying maybe $10-40 for one or two guides can be reasonable, even a bargain. Thus one can end up paying less than he would be willing to pay in both extremes. The conventional buyer can optionally be willing to pay more than the set price of the guides for intensive use (but pays regular price), and he can optionally pay something more than zero for light use of many guides (but pays nothing). Under conventional pricing, the buyer suffers and the publisher(s) suffer.

With conventional pricing, it might be impossibly difficult for a publisher or even a full-service bookseller to set multi-factor prices that worked for such extremes of usage. With FairPay, they do not have to—the buyer sets the price. Knowing the list price of guidebooks, a buyer might be willing to spend $20-40 per week, if using the guide(s) heavily, and less if not. One might go higher if covering a lot of cities, and lower if just in one place, and higher if the places are covered in depth, less for small towns with little or no coverage. If one used multiple guides, he might want to divide his payment based on which he used most and which were most valuable (such as tipping him off to good “finds”).

To facilitate this, the buyer might not mind if the sellers had meters that recorded his usage, but might be put off by knowing that there are set charges per page or minute of viewing, with a pricing meter going ka-ching. He might be OK with such metrics of usage as suggestive of what he should pay, but not as a ticking meter of set charges (as in a taxi).

A full-service seller can optionally administer the store, collect the metered usage data, and let the user pay as he sees fit. As long as he paid at reasonable levels (considering his usage), the seller can optionally continue to let him get more guides (for his next trips) on a FairPay basis. If he did not pay well, they can optionally cut him off and it would be back to the old way. For his return trip to the big city, the sellers can optionally offer use of an updated guide, and expect only modest payment (effectively a discounted upgrade), resulting in another win for both the buyer and the sellers.

As for the publishers, overall, they can do much better, also. The buyer might have only bought one or two guides conventionally, for $10-40, so under his FairPay allocation, he can optionally pay $20-40 to those one or two publishers, and so the second might have a sale they would not have gotten. But the buyer might have used other guides in those places as well, and might have paid something to those publishers, as well. He also might have used guides at various cities on the cruise trip, and can pay for the moderate level of usage that was foregone because he did not want to buy guides he would use only lightly (maybe paying $20-30 for those as well). Also, he might feel much better about being able to use and pay for guides accessed his way, not the way the publisher pre-packages them into “titles” that don't fit his needs, and so can act on a willingness to pay at higher levels than he would conventionally. The publisher and the store can potentially get more from him, and he might be much happier about the fairness of the value exchange.

Such FairPay offers can optionally be structured as packages for specific trips, with pricing to be set by the user soon after the trip (effectively guides as a service, rather than a product). Frequent travelers can place high value on the flexibility this offers, and be careful to pay at good rates to retain the privilege of doing the same for future trips. Occasional travelers, and those on tight budgets can pay at lower rates, but, without Fairpay, they might otherwise not buy guides at all. (To prevent low-paying buyers from hopping from seller to seller, the sellers can optionally share their reputation data.)

The result can potentially be high economic efficiency. The buyer gets access to all the guides he feels he has use for (exploiting their near-zero marginal cost), and pays based on how he uses them (based mostly on his own intuitive allocation of value, grounded in the reality of usage data). The publisher can potentially sell to far more people who have use for the product, and get revenue commensurate with that use. Doing that with conventional pricing models might be impractical, and the ka-ching of a ticking usage meter might put a damper on the kind of casual use that, with FairPay, can result in added revenue (after the fact, when the value was known).

### Example 6

A sixth example addresses an application to non-digital, real-world services, in this non-limiting example, for admission to cultural institutions.

Service providers such as cultural institutions can optionally provide a FairPay pricing process either individually, or in common service across institutions, such as museums, theaters, concert series, etc., such as in a particular locale. A shared “culture pass” service can permit buyers to become members and to gain admission to participating institutions. For example, museum admissions can be arranged using the culture pass to gain entry much as with a museum membership card. Such admissions can be logged and tracked using FairPay methods.
A member can optionally enter any participating museum on a FairPay basis, the entry being logged, and at some time after completing the visit, be asked to set a price for that visit. That price would be tracked.
The pass can be managed on a monthly basis, or quarterly, or on some other cycle based on time or number of visits or some other criteria. At the end of each cycle, pricing can be reviewed by the seller(s) to determine whether a renewal offer will be allowed, and whether that offer will be for a similar level of service, depending on the prices paid. Such levels of service can optionally be defined in terms of which institutions are included, which of multiple types of admission, which days and or times, which special exhibits, whether ticket lines can be bypassed, whether discounts in museum stores are offered, whether any other member perks are included, or any other methods of defining levels or tiers of service. Such decisions and criteria can optionally be made or set by an administrator of a shared service, or by the individual institutions, or some combination.

Such a culture pass can significantly improve the economics of such institutions. Visitors might be more likely to try unfamiliar museums where they can get member benefits without the fixed up-front cost of conventional individual memberships, and where they can pay what they think fair. Institutions might find this generates higher attendance and better revenue than conventional pay what you want admissions, or other conventional fixed pricing. Offers can be framed to suggest per-visit pricing that is less than non-member single admissions, and in which the per-visit prices for subsequent visits to a given institution decline, much as the effective cost per visit declines with the number of visits for flat-rate yearly memberships, but perhaps in a way that does not result in very high cost (the rate for a full year of membership) if very few visits are made. Such pricing can adapt in well-behaved ways to varying and unpredictable levels of attendance by an individual. Similar methods can optionally be applied for any kind of product or service.

### Example 7

A seventh example addresses an application to a cross-seller coupon service aimed at bringing new customers to sellers. Many of the features of such an application are described above, with some added detail on relevant processes provided here.

Sellers can work with the coupon service to develop an offer strategy that exploits the FP reputation data and other data available to either the coupon service and/or the seller, including what level of FP reputation to target offers to.

Based upon agreed decision rules, the coupon service matches potential buyers in its database to the seller offer, and communicates offers, customized as desired, to the buyers, with suitable framing information. Such offers can be for any good or service, for example a meal at a restaurant, an event, a product from a store, a personal service, etc. Here we take the example of a meal at a restaurant, and an offer framed as a variable discount with a suggested value of 50% off standard menu prices for up to $100 of the total check. It can optionally be further framed that should the meal be disappointing a discount as high as 75% is allowable, and that if the meal is very pleasing, a discount of only 25% can be appropriate, on the basis that the buyer still gets a bargain for trying the new place, but the restaurant deserves more than 50% for a very good meal.

As an FP relationship between the buyer and the coupon service (in this aspect), it can be made clear that buyers who price at above the suggested value can generally expect to become eligible for more attractive offers, and those who price below that value will generally get less valuable offers.

While the restaurant has limited its risk to 75% off, the coupon service can optionally commit to a full 100% guaranty to its buyers, and can manage its selection of which sellers it services to manage that added direct risk. The service can thus be responsible for that portion of the 75-100% range. Alternatively, some more complex allocation of risk between the seller and service can be negotiated.

The offer acceptance can be for all payments to be made later, or can be for some portion to be paid up front. For example in an up-front case, the buyer can pay $50 for the coupon just described.

After the meal, the buyer can present his coupon, and use it as credit for the desired discount and have that reflected directly in the payment. In the case that the buyer paid $50, as just suggested, the credit would be up to $100.

Processing at this point can optionally take a variety of forms. Price setting adjustments can optionally be handled on site at the restaurant and reported to the coupon service by the restaurant, using any suitable mix of restaurant and/or coupon service and/or other third-party systems. Thus the buyer can optionally request a credit for a discount of more than the nominal 50%, or pay a surcharge to effect a less than 50% payment. Provision can also be made for multiple choice and/or free text explanations of reasons to be captured and relayed to the service. Alternatively, the price-setting adjustments can be made after the fact, directly between the buyer and the coupon service, whether to confirm the suggested discount, or to set an alternate level, and to provide explanations.

Context data can also be collected from the restaurant, such as any relevant comments on the nature/circumstances of the experience as perceived by the seller, as it might reflect on the seller's pricing fairness and/or any other useful information for market segmentation of other uses. Such data can be obtained at the time of service, or in the course of any continuing dialog.

The coupon service can make any appropriate financial transactions among any of the three parties, including any adjustments from payments made at the time of coupon purchase, the dining, or afterwards.

The coupon service can optionally assess all of this data to evaluate the current transaction, and the overall reputation of the buyer. Such evaluations can then be used by the coupon service to determine which future coupon offers, or any other kind of offers, to extend to that buyer. Note that as described here, no FP reputation data is shared with the seller. In such a case, the information relating to FP reputation made available to the seller is the inferred information that those who bought coupons met the specified reputation criteria. Of course in some embodiments this reputation data can optionally be shared with the seller, with other sellers, and externally to the coupon service, such as in a broader FP reputation service.

Further Notes on Implementation Options

The inventive methods described herein can optionally be embodied in a wide variety of forms. Some selected non-limiting aspects of the inventions to be claimed in this filing based on these disclosures include the following.

One aspect of the invention involves offering to conduct a sale of a product/service to a potential buyer, the possible accepting of such an offer, and the setting of prices to apply to such a transaction. Each of those elements can optionally be supported and linked by access to a range of databases that provide data supportive of each element and its context in the larger environment and that record data relating each element and its context in the larger environment as it develops. Each of these elements can optionally be supported by third parties, and any of the databases can optionally be managed and/or controlled by any of the parties, whether individually or in combination.

Aspects of the invention can optionally involve any and all of the component elements being supported by any combination of buyer, seller, and/or third party support systems and related databases, using any desired technology for integrating such systems and databases (including without limitation Web services, cloud computing, Application Program Interfaces or APIs, distributed and/or confederated systems and databases, and the like).

Aspects can optionally be viewed with respect to actions of buyers, sellers, and/or third-parties, whether direct or mediated, such as for example along the lines of the columns of FIG. 2B.

Seller perspectives can optionally include, among other elements, deciding to make offers, communicating them to buyers, obtaining acceptances from buyers, fulfilling transactions, interacting on support, requesting pricing and providing relevant context data, receiving pricing and relevant context data, and cycling forward to deciding on and continuing the process for further offers, with interface to relevant databases, with or without third party support for any or all of these elements.

Seller perspectives can optionally further relate to multiple levels of a distribution channel and/or supply chain, so that elements can apply in any combinations of a plurality of parties to such a distribution channel and/or supply chain, whether acting on their own account or as agents for others. Such multiparty elements can optionally include multiparty roles in offer decisions, price evaluation decisions, division of receipts, and other elements, and database management with regard to any and all elements.

Buyer perspectives can optionally include, among other elements, receiving offers from sellers, communicating acceptances, receiving fulfillment of transactions, support interactions, obtaining pricing requests and relevant context data, setting and communicating pricing and providing relevant context data, and cycling forward to deciding on and continuing the process for further offers, with interface to relevant databases, and being performed with or without third party support for any or all of these elements.

Third-party perspectives can optionally, in support of sellers, include more or less extensive involvement in any and all of the seller aspects much as just described, and/or similarly in support of buyers, and/or in any and all combinations of support to both roles. Third-party perspectives can optionally also be particularly focused on aspects relating to the databases, possibly including cross-seller databases consolidating data in support of any and all aspects of these processes for arbitrary sets of sellers and/or buyers, and possibly including elements of tracking and evaluating buyer pricing and related reputations on a cross-seller basis and aiding in offer decision support processes, possibly including support for seller-specific and/or buyer-specific aspects of such data and processes as well. Cross-buyer services can optionally also assemble data from multiple buyers relating to one or more sellers, such as to aid in evaluation of offers and of pricing decisions or other tasks. As noted above, such third-party services can optionally be delivered using any desired technology for integrating such systems and databases (including without limitation Web services, cloud computing, Application Program Interfaces or APIs, distributed and/or confederated systems and databases, and the like).

The behavior of these systems and any of these parties, and the communications among them, can optionally be considered sensitive and subject to various security measures, including encryption, authorization, authentication, and other measures.

Interactions of buyers, sellers and/or third parties can optionally range from fully automated to manual, and can optionally rely on user interfaces to facilitate human roles and control of the methods and the systems that facilitate the methods. Such user interfaces can optionally be facilitated by buyer, seller, and or third-party systems or any combination thereof. Embodiments can optionally involve a range of levels of decision support systems, any of which can optionally support buyers and/or sellers and/or third-parties in any combination, and with any level of full and/or partial automation of decision processes. Such automation in support of any of the parties can optionally include any suitable methods, including decision support systems and social decision support systems, artificial intelligence of any kind, expert systems, smart agents or bots, or the like.

Aspects of the invention can optionally involve the buyer being free in his sole discretion to set any desired price, such as on a pay what you think fair basis, or alternatively, the buyer can be constrained to a seller set and/or bounded price, and/or a negotiated price, with or without pre-constraints. Note that pricing options can optionally be limited to a set of multiple-choice selections, round amounts, and/or the like, such as, for example, as a practical matter, to streamline user interaction and/or analysis, whether or not there might be a more fundamental intent to bound or constrain the pricing in such ways. As noted elsewhere herein, behavioral economics considerations can optionally also be a factor in defining various aspects of how pricing decision requests are framed to buyers.

Similarly, instead of specifying prices directly in dollar (or other currency) amounts, prices can optionally be set in relative terms, such as, for example, percent increments above and/or below some central value, such as for example a standard or suggested or other reference price, or above and/or below some upper and/or lower bound. Such incremental/decremental pricing can be useful to streamline the seller pricing process and/or the specification of reputation rating and decision rules, and/or to achieve more desired behaviors, such as greater compliance with suggested pricing, clearer and more readily quantified/analyzed explanation of departures relative to such suggested prices, and/or the like, or for other reasons. For example, in some embodiments, a seller can optionally have or desire a highly structured pricing model, possibly with many tiers of pricing, possibly in multiple dimensions of volume, product segments/tiers, market segments, and/or the like. Having FP prices set by the buyer as percentage variations above or below such a schedule of reference prices can optionally encourage buyers to stay close to those reference prices, and to clearly explain their reasons for departing from them in either direction in terms of that differential. That, in turn, can improve the ability to maintain a shared perception of high level of buyer freedom coupled with a high level of fairness, and provide a clearer basis for the seller to quantitatively evaluate fairness in the context of that pricing structure, in terms of variances from it, to achieve the nuance that can optionally be structured into the reference pricing scheme, plus the further nuance, dynamics, and flexibility facilitated by the FP processes, such as to focus that in terms of the variances from the scheduled reference pricing. Options for building a degree of rich seller control into such suggested pricing include various price optimization methods, including, for example use of demand-elasticity models to manage SKU variations, markdown pricing and scheduling, and/or the like. Of course such relative increments/decrements need not be specified in percentages, but can optionally be specified as dollar (or other currency) increments or decrements, with similar effect, and any of the methods described herein in terms of one such pricing scale should be understood to apply, in correspondingly adapted/transformed form, to any alternative pricing scale. Such relative prices and/or price differentials, such as from a standard or suggested or other reference price, can optionally be handled in terms of any suitable functional form, including, for example, arithmetic increments/decrements, multiplicative ratios/fractions/percentages, exponentials, and/or any other desired functional form, including any combination of such component factors.

Aspects of the invention can optionally involve the seller being free in his sole discretion to selectively gate his offers to specific sellers at specific times and with respect to specific contexts, or alternatively, such powers can optionally be limited by certain rights of some or all buyers to demand or negotiate such offers, with or without pre-constraints.

Aspects of the invention can optionally involve use of systems and databases not only to contain, collect and provide data for transactions supported using the methods described herein with regard to pricing and other aspects of transactions, but also for any combination of such transactions with any and all other kinds of transactions involving the same or other buyers and sellers, as well as any and all other data considered useful in commerce, including without limitation data relevant to pricing, usage, and value exchange, as related to any and all of offers, transactions, usage, and their context.

Another aspect of the invention involves offering to sell a product/service to a potential buyer and the setting of prices to apply to that transaction in combination with elements relating to product and/or production management, possibly including decisions as to what products/services to offer, with what features, such as by relating those decisions to pricing data. Each of those elements can optionally be supported and linked by access to a range of databases that provide data supportive of each element and its context in the larger environment, including but not limited to any of the data-based considerations described herein, and that record relevant data relating each element and its context in the larger environment as it develops. Each of these elements can optionally be supported by third parties, and any of the databases can optionally be managed and/or controlled by any of the parties, whether individually or in combination.

Aspects of the invention can optionally evolve over time, such as to include more limited and/or more advanced and/or complex and nuanced embodiments in any combination, phasing, and/or sequence, possibly depending on time and/or context, and with any mixes of full, partial, and/or no automation. Any and all of these and the above aspects can optionally involve a dynamic and/or adaptive balance of elements and alternative methods depending on timing and/or context.

It should be understood that the above description is only representative of illustrative embodiments. For the convenience of the reader, the above descriptions have focused on a representative sample of all possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Although various embodiments, implementations, and aspects of the present invention have been described in detail hereinabove, it is to be understood that the descriptions have been provided for purposes of illustration only and that other variations and embodiments, both in form and detail, can be made thereupon by those skilled in the art without departing from the spirit and scope of the invention, which is defined solely by the appended claims.

Additional exemplifying details can be found in the Appendices filed with this application, all of which are expressly incorporated herein by reference. Note that these Appendices are merely illustrative of sample implementations, and do not limit any of the claimed concepts. Appendix A gives an example of database structuring which can be used to implement the information base in a sample embodiment. Appendix B is an example of how an FP offer might be stated to a buyer. Appendix C includes marketing material, and is written in imprecise terms to help explain some relevant concepts to a particular audience. All of these Appendices are merely examples, are related to particular, selected embodiments, are presented in relation to current market conditions, and in no way limit the claimed inventions. In particular, the materials in Appendix C include very informal and free-ranging discussions related to particular questions, particular users, and particular applications, and should all be taken merely as examples rather than definitions.

According to some but not necessarily all disclosed embodiments, there is provided: A computer-assisted method for selling through a distributed marketplace system, comprising: on an ongoing basis, indicating items available to be exchanged for value which is at least partly indeterminate; looking up prospective buyers in an information base which includes, for previous transactions based on at least partly indeterminate value, the seller's assessment of the fairness of the value actually exchanged or set to be exchanged for that item by that buyer, and the buyer's assessment of the fairness of the value set to be exchanged by the buyer; and conditionally performing an indeterminate-value transaction with that prospective buyer, in at least partial dependence on the results of the looking up step.

According to some but not necessarily all disclosed embodiments, there is provided: A method for buying remotely through a distributed marketplace system, comprising: reviewing items which are offered in exchange for value which is at least partly indeterminate; under at least some circumstances, using a machine-assisted process to determine: (1) what value a seller is expected to accept as satisfactory (2) what value the buyer predicts to be an acceptable value exchange for the buyer (3) any explanations the buyer expects to provide to justify any difference between (1) and (2); and conditionally performing an indeterminate-value transaction with that prospective seller, in at least partial dependence on the results of the determining step, and in at least partial dependence on possible damage to the buyers reputation which can be expected from the difference between (2) and (1) in light of (3).

According to some but not necessarily all disclosed embodiments, there is provided: a method for buying through a distributed marketplace system, comprising: reviewing items which are offered in exchange for value which is at least partly indeterminate; under at least some circumstances, looking up the prospective seller of an item which is offered in exchange for indeterminate value, to see what assessments of the fairness of value set to be exchanged by buyers have been posted by that seller, as well as at least some buyers' inputs on the fairness of the assessments posted by that seller; and conditionally performing an indeterminate-value transaction with that prospective seller, in at least partial dependence on the results of the looking up step.

According to some but not necessarily all disclosed embodiments, there is provided: a method for operating a distributed marketplace system, comprising: conveying to potential buyers indications of offers for items wherein multiple sellers offer multiple different items, in exchange for value which is at least partly indeterminate, on an ongoing basis; under at least some circumstances, allowing potential buyers and sellers to access an information base which includes, for previously completed indeterminate-value transactions, at least some information on what item was provided to the buyer for indeterminate value, the seller's assessment of the fairness of the value actually exchanged or set to be exchanged for that item by the buyer, and, for at least some cases, the buyer's input on the fairness of the value set to be exchanged by the buyer; and under at least some circumstances, allowing buyers and sellers to add to the information base regarding completed indeterminate-value transactions.

According to some but not necessarily all disclosed embodiments, there is provided: a method for operating a distributed marketplace system, comprising: under at least some circumstances, allowing sellers who make indeterminate-value offers to access an information base which includes, for individual buyers, information on items provided to the buyer for indeterminate value, the seller's assessment of the fairness of the value actually exchanged or set to be exchanged for that item by the buyer, and, for at least some cases, the buyer's input on the fairness of the value set to be exchanged by the buyer; and under at least some circumstances, allowing buyers to review assessments in the information base, and to add comments.

According to some but not necessarily all disclosed embodiments, there is provided: a distributed marketplace system, comprising: a plurality of sellers, offering items in exchange for value which is at least partly indeterminate; wherein individual ones of said sellers offer more than one instance of each item or multiple items or both, on an ongoing basis, to multiple potential buyers; a plurality of prospective buyers, wherein ones of said buyers can indicate willingness to receive ones of said items in exchange for value which is at least partly indeterminate; and an information base which includes, for individual buyers, information on items provided to the buyer, value actually exchanged or set to be exchanged for that item by the buyer, the seller's assessment of the fairness of the value actually exchanged or set to be exchanged by the buyer, and, for at least some cases, the buyer's comment on the fairness of the value actually exchanged or set to be exchanged by the buyer.

A distributed marketplace system, comprising: a plurality of sellers, offering items in exchange for value which is at least partly indeterminate; wherein individual ones of said sellers offer more than one instance of each item or multiple items or both, on an ongoing basis; a plurality of prospective buyers, wherein ones of said buyers can indicate willingness to receive ones of said items in exchange for value which is at least partly indeterminate; and an information base which includes, for individual buyers, information on: items provided to the buyer; value exchanged for that item by the buyer; the seller's assessment of the fairness of the value exchanged by the buyer; and for at least some cases, the buyer's input on the fairness of the value set to be exchanged by the buyer; wherein the information base also includes, for at least some ones of the sellers, assessments from buyers regarding the fairness of the seller's assessments.

According to some but not necessarily all disclosed embodiments, there is provided: An electronic system for selling through a distributed marketplace system, comprising: means for assisting a seller to indicate items available to be exchanged for value which is at least partly indeterminate; means for looking up prospective buyers in an information base which includes, for previous transactions based on at least partly indeterminate value, the seller's assessment of the fairness of the value actually exchanged or set to be exchanged for that item by that buyer, and the buyer's assessment of the fairness of the value set to be exchanged by the buyer; and means for conditionally performing an indeterminate-value transaction with that prospective buyer, in at least partial dependence on the results of the looking up step.

According to some but not necessarily all disclosed embodiments, there is provided: An electronic system for buying remotely through a distributed marketplace system, comprising: means for reviewing items which are offered in exchange for value which is at least partly indeterminate; means for, under at least some circumstances, using a machine-assisted process to determine: (1) what value a seller is expected to accept as satisfactory (2) what value the buyer predicts to be an acceptable value exchange for the buyer (3) any explanations the buyer expects to provide to justify any difference between (1) and (2); and means for conditionally performing an indeterminate-value transaction with that prospective seller, in at least partial dependence on the results of the determining step, and in at least partial dependence on possible damage to the buyers reputation which can be expected from the difference between (2) and (1) in light of (3).

According to some but not necessarily all disclosed embodiments, there is provided: an electronic system for buying through a distributed marketplace system, comprising: means for reviewing items which are offered in exchange for value which is at least partly indeterminate; means for, under at least some circumstances, looking up the prospective seller of an item which is offered in exchange for indeterminate value, to see what assessments of the fairness of value set to be exchanged by buyers have been posted by that seller, as well as at least some buyers' inputs on the fairness of the assessments posted by that seller; and means for conditionally performing an indeterminate-value transaction with that prospective seller, in at least partial dependence on the results of the looking up step.

According to some but not necessarily all disclosed embodiments, there is provided: A computer-implemented method for enabling sales of a product or service comprising: collecting, via a computer, a report of a sale transaction between a buyer and a seller, wherein the sale transaction is for a sale price not yet set at the time of the sale transaction; collecting, via the computer, a report of the sale price for the sale transaction after the sale price is set and transaction context data, wherein the report of the sale price and the transaction context data are entered into an electronic database; obtaining information from the electronic database including the sale price and the transaction context data for use by one or more sellers, wherein the information from the electronic database is used by the one or more sellers to quantify a fairness metric that is used as input into a subsequent decision to make or not make a subsequent sale offer to the buyer; providing the subsequent sale offer to the buyer, wherein the subsequent sale offer results in a subsequent sale and delivery to the buyer; and entering a subsequent sale price and transaction context data in the electronic database.

According to some but not necessarily all disclosed embodiments, there is provided: A computer-implemented method for facilitating sales of products or services comprising: collecting, via a computer, a report of a sale transaction between a buyer and a seller, wherein the sale transaction is for a sale price not yet set at the time of the sale transaction; collecting, via the computer, a report of the sale price for the sale transaction after the sale price is set and transaction context data; wherein the report of the sale price and the transaction context data are entered into an electronic database; wherein information from the electronic database including the sale price and the transaction context data is provided to one or more sellers, and wherein the information from the electronic database is used by the one or more sellers as input into a subsequent decision to make or not make a subsequent sale offer to the buyer; providing the subsequent sale offer to the buyer based on the use of the information in the electronic database, wherein the subsequent sale offer results in a subsequent sale and delivery to the buyer; and entering a subsequent sale price and transaction context data in the electronic database.

According to some but not necessarily all disclosed embodiments, there is provided: A computer-implemented method for controlling production of products or services comprising: obtaining, via a computer, from an electronic database, statistical reports of sale prices for a first product or service and transaction context data; obtaining, via the computer, from the electronic database, statistical reports of sale prices and transaction context data for other products or services having identified similarity to the first product or service; wherein the sale prices are set by respective buyers of the first and the other products or services at those buyers' discretion at a time after delivery of a respective product or service and reported to a price reporting service; and deciding, by a producer or provider of the first product or service, based at least in part on the statistical reports, whether to produce a second product or service having identified similarity to the first product or service.

According to some but not necessarily all disclosed embodiments, there is provided: A computer-implemented method for supporting business transactions comprising: entering, via a computer, into an electronic database, reports of a plurality of sale prices for a product or service; obtaining, via the computer, from the electronic database, aggregated data on the reports of the plurality of sale prices, wherein the aggregated data is used at least in part to control future production of similar products or services; wherein the plurality of sale prices are set by respective buyers of the product or service at those buyers' discretion after delivery of a respective product or service and then reported to a price reporting service.

According to some but not necessarily all disclosed embodiments, there is provided: A computer-implemented method for enabling sales of a product or service comprising: determining, via a first computer system, to make an offer to conduct a sale transaction between a buyer and a seller, collecting, via a second computer system, a report of a sale price for the sale transaction after the sale price is set, and transaction context data, determining, via the first computer system, based at least in part on a quantification of a fairness metric that is based at least in part on the report of the sale price and the transaction context data, whether to repeat at least the making of an offer with regard to the buyer.

### Further Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC Section 112 unless the exact words “means for” are followed by a participle.

The claims as filed are intended to be as comprehensive as possible, and NO subject matter is intentionally relinquished, dedicated, or abandoned.

### APPENDIX A

### Sample Database Data Sets and Elements

### Customer Databases

Basic Customer Data
   Customer identification data
   Consumer ID
   Consumer Demographic data (age, race, gender, marital status, income, religion, schooling, kind of work/student/retired, memberships, credit cards held, cars, residence location(s), other geographic data including shopping/travel locations, housing size(s), rent/own, how many in the household/ages/relationships, etc.)
   Consumer Psychographic Data (lifestyle data, hobbies, interests, opinions, behavioral data, etc.)
   Social Network Data (social graph, etc).
   Anonymous ID
   Behavioral Data (summaries, links to detail)
   Shopping History Data (summaries, links to detail)
   Credit Data
   Customer privacy preferences
   B2B Customer Hierarchy Data (expand throughout to reflect multiple users, pricing decision groupings, etc.)
Customer Offer/Merchandising Data
   Offer History Data (summaries, links to detail)
   Offer criteria parameters
   Offers extended, not accepted
   Offers accepted
   Other purchase history data
   Price sensitivity analysis data (summary, details)
   Recommender data
   Market segment data
FairPay Reputation/Score Data
   Score (by seller/overall)
   Score details (summaries, links to detail)
   Score aging data
   Item FP score data (summaries, links to details)
Supplementary Customer Reputation Data
   CRM interaction history and ratings
   Social network relationship/trust/reputation data
Trust data
   User objectivity scores (skew to good or bad, etc.)
   User consistency scores (tendency to average or extreme, etc.)
   User affluence/price-sensitivity scores
Overall Customer FP Pricing Reputation Assessment Data
   Overall Poor assessment data (reasons, context, dialog history, etc.)
   Other overall relative assessment data (distributions, reasons, context, dialog history, etc.)
   Overall FP reputation dispute history (links to details, dispute dialog trails, etc.)
Other Customer Data

### Item Databases

Item data
   Item type ID
   Item instance ID
   Make, model, year
   Options/accessories
   Serial #
   Manufacturer
   Dealer/Vendor
   Assembly plant, Key subsystem type/source info
   Service date
   Problem/repair/service history
   Reference data ID
   Reference price data (list, suggested, competitive)
   Other buyer comparable price-setting data (summaries, links to details)
Other Item Data

### Transaction Databases

Pricing Data
   Item type ID
   Item instance ID
   Offer data
   Acceptance date/time/location
   Fulfillment date/time/location
   Pricing requests/reminders sent
   Price set date/time/location
   Buyer price set value
   Buyer price reasons (codes, descriptions, etc.)
   Buyer price adjustments (amount, date, etc.)
   Reference data ID
   Reference price data (list, minimum, suggested, competitive, previous, etc.)
   Other buyer comparable price-setting data (summaries, statistics, links to details)
   Other offer and pricing framing parameters (value/usage metrics/weightings, etc.)
Item FP Pricing Assessment Data
   Poor Item FP pricing assessment details (degree, reasons, context, dialog history, etc.)
   Other relative FP pricing assessment details (degree, reasons, context, dialog history, etc.)
   Transaction context details (times, locations, weather, etc.)
      Buyer context
      Seller context
      Offer framing context (including offer terms, conditions, pricing guidance, etc.)
      Usage context
   Buyer-seller dialog history
      Interactions/Dispute history
      Seller assessments of interactions
      Buyer counterclaims on interactions
Objective Usage Data (at Item level and/or Item Group/Bundle/Usage-period level, etc.)
   Usage/Performance/Duty cycle
      Timestamp
      Usage types
      Usage quantities
      Usage intensities
      Usage performance (metrics, values)
      Usage conditions/contexts
      Improper operation/use data (delayed maintenance/excess load, etc.)
      Other available data (on summarized/reduced basis, links to details)
   Maintenance data
      Timestamp
      Scheduled maintenance triggers and completions
      Warning and failure event data
      Repair action details (work done, components replaced, consumables, developing problems, certification level, etc.)
      Failure/damage reports
   Cost of ownership data
      Timestamp
      Cost category
      Cost element
      Cost amount
      Linkage to performance of maintenance events
   Value of use data (Secondary indicators of value, results, benefits, savings, etc.)
      Timestamp
      Value category
      Value element
      Value amount
      Linkage to performance/usage/operational events
Subjective User Feedback/Rating Data (at Item level and/or Item Group/Bundle/Usage-period level)
   Timestamp
   Overall rating
   Performance (metrics, values)
   Usage conditions/contexts
   Reliability
   Maintainability
   Durability
   Economy of use
   Service/support
   Cost of ownership
   Ease of use/ergonomics
   Effectiveness
   Quality
   Appearance/style
   Amenities
   Enjoyment
   Other value metrics
   Would buy again?/Would buy a different category instead?
   Human inputs of data alternative to Objective Usage Data (from User or Service Agent)
   Other
Comparable User Feedback/Rating Data
   (Comparable data as reported by other buyers, including items above for current user)
Other Sources of Product/Service Rating Data
   (Equivalent/Supplementary data from other sources, including post-sale market data)
Other Transaction Data

### Other Support Databases

ERP/CRM/CMS, etc.
   (including production data, cost data, competitive data, CRM data, etc.)
Merchandising and Offer Management
   (including offer options, offer criteria, offer parameters, product/service selection data, product/service tiers, etc.)
Other

### APPENDIX B

### A Sample FairPay Offer

The following is an example of how a FairPay offer can be framed to a buyer.
For this example we consider a newspaper that has decided to go to a freemium pay wall model such as planned by The New York Times, and by others considering the Journalism Online Press+ platform. Call it The Times Journal. A sample FAQ is also included.

### Dear Reader,

As you know, The Times Journal Web site has been free, but we cannot continue to offer it without some subscriber payment and still provide the quality content you count on. Providing the journalism you expect from us is very costly, and more and more readers now get it online.
We are offering a conventional subscription plan, but also are experimenting with a new way to give our readers an unusual degree of freedom, largely on a “pay what you think fair” basis, as an alternative to more rigid conventional pricing methods.

### Standard Subscription Plan:

As with many Web services, we now offer a simple pricing plan with two levels of service: a basic level of up to 10 articles per month free, with a subscription level that is required for more intensive reading (more than 10 articles per month). The standard subscription costs $4.95 per month. You can elect that subscription plan now, or at any time that you decide you want more than 10 articles in any month.

### Special “FairPay” Plan:

As a preferred, more flexible alternative, we are selectively offering to you and other regular readers what we call our FairPay Plan. This monthly service works on the basis that you “pay what you think fair”—you are free to set the price each month to whatever level you believe to be fair, considering your level of use and the value of The Times Journal to you, at the end of each month.

The FairPay aspect of this plan comes in from the fact that we will review what you elect to pay each month (and your usage for that month, plus any feedback you provide in your pricing form), and will determine if you have been paying at a level that we can accept as fair. If so, we will continue to offer monthly renewals to you on this FairPay basis. If not, you will be offered a regular subscription at $4.95 per month, or can simply revert to just the 10 articles per month that are offered free, with no subscription.

### Special Introductory FairPay Bonus . . . and Continuing Special FairPay Bonuses:

If you try our FairPay Plan and continue it at satisfactory pricing levels for three months, we will provide a special bonus, a Times Journal “FairPay Patron” tote bag, in fine canvas. This $15 value item is available only to FairPay subscribers in good standing. As you continue on the FairPay plan, we will provide other special bonuses from time to time, as a reward for your cooperation and continuing readership and support.
[***include photo of tote bag with prominent “FairPay Patron” label***]
   We view FairPay as a way for us to jointly learn how to exchange the value you get from us for the money you agree to pay us for our newspaper. Over time we hope to add more nuanced offers, so that we learn to understand our subscribers better. Those who pay well will get premium service levels and various special benefits, and those who pay less well get more basic service levels. Of course those who pay much less, at a level we cannot accept as fair, will be offered only the standard subscription plan.
   Also, after a few months we plan to allow readers who pay at acceptable levels to set prices less often, going from monthly to quarterly, and later to yearly pricing reviews (unless you prefer more frequent reviews), so that the process becomes even easier.
   We hope this FairPay Plan will work well for you and for us. However, if after a period of experimentation we find that it does not result in good pricing behavior from a sufficient number of readers, we will be forced to discontinue the plan. We hope you find this plan attractive, and that we will be able to continue it and expand it. (We will also maintain the conventional subscription plan, so you can opt for that at any time, should you so desire.)
   Additional information is in the FairPay FAQ below.

### Thank you.

Consumer FairPay FAQ [sample]
Why are you offering this FairPay Plan?
We want to give you the maximum flexibility to set a price that is fair with respect to how you use The Times Journal, and how you value our journalism. We are counting on your fairness, and we want to build a cooperative relationship with you, as one of our valued readers. If you play fairly with us, we will do our best to give you maximum freedom, and to find other ways to reward you.
The FairPay Plan is intended to let you tailor a plan that fits you exactly—and to continue to make adjustments as your usage warrants. You may feel you will not read enough articles often enough to make the standard subscription fee of $4.95 worthwhile. Maybe you will only read a few more than the 10 free articles. We know that standard subscription plans have many disadvantages. Obviously, we have to set our regular subscription price at a level that covers the usage of our average subscriber. We have to balance a price that will not discourage occasional readers, but will also not be so low that regular readers do not carry their weight. One single subscription price does not really fit all.
What if I view only a few articles in one month?
If you view less than the 10 articles that would otherwise be free, or even a few more, you are free to pay nothing, without fear that we will revoke your FairPay privileges. However, as a regular reader you might also feel that those articles were valuable, and that some payment is appropriate.
What if I am a heavy reader of many articles almost every day?
We hope you find greater value than the average subscriber and will feel it appropriate to pay proportionately more than the $4.95 rate (which is aimed at average subscribers). If you do so, we may offer special services to show our appreciation. But a payment that is not well below the standard rate would not lead us to revoke your basic FairPay participation.
What information will you use to decide what is fair?
We will provide a usage report with a simple Web form that you can use if needed to describe why you paid what you did. You can use this to clarify your usage of services, your view of the value received, the context of your use (such as business or pleasure or student), and to note any service problems you encountered, and the like. If your pricing is above or below average, this will help us understand why you think that to be fair. We will also ask if you are willing to share some basic data on your demographics and income (but will not require that). We may also check commercially available databases to better understand your situation relative to our other readers.
What if I am on a limited budget?
We understand that people have varying means, and are willing to adapt our expectations accordingly, based on what you tell us and what we know from other sources.
What if few readers pay as much as you would like?
Our hope is that readers will understand that we need to cover the costs of our journalism. If too few readers do, we will be forced to eliminate the FairPay option, and require all readers to subscribe if they want to read more than 10 articles per month.
Do your really expect people to pay more than the standard rate
Much as public television and museums have premium subscribers and benefactors, we hope those who are regular readers—and those who value the quality of our content, and can afford to pay more, will see fit to do so. We hope you will see that as a way of helping us to serve you—as well as to compensate for those who cannot afford to pay full price. We will seek ways to show our appreciation to those who pay at premium or benefactor levels.
Can my payments vary widely from month to month?
Sure, if your usage varies, or your value-received varies, it would be fair to reflect that in what you decide to pay. For periods you use a lot, and get high value, a higher price might be fair. If there are periods you are away or otherwise not reading often, a lower price might not be inappropriate. And if we help you achieve financial success, perhaps you will see fit to thank us with a higher price.
Can I pay nothing at all?
Yes, any time you really think that is fair. If you give a reason why you think that is fair, and it is a reason we can accept as reasonable (such as being away, or having reported technical problems or some other reason why you got little or no value), we will try to be accepting of that. But if there is not a reasonable explanation, we will not continue your FairPay plan.
Isn't this monthly price setting going to be a burden?
We will do all we can to streamline the process.
Once we see that you are pricing at acceptable levels, we will extend more FairPay “credit,” allowing pricing to be done quarterly, or even yearly. We expect to start that after three months.
Your monthly pricing form will have simple buttons to let you select the standard subscription price of $4.95, or the price you had set for the previous month, or to let you enter any other rate you wish.
The form will also have a simple multiple choice form for feedback on any issues that affect why you set that rate (and a space for entering any comments).

1. A computer-assisted method for selling through a distributed marketplace system, comprising:
on an ongoing basis, indicating items available to be exchanged for value which is at least partly indeterminate;
looking up prospective buyers in an information base which includes, for previous transactions based on at least partly indeterminate value, the seller's assessment of the fairness of the value actually exchanged or set to be exchanged for that item by that buyer, and the buyer's assessment of the fairness of the value set to be exchanged by the buyer; and
conditionally performing an indeterminate-value transaction with that prospective buyer, in at least partial dependence on the results of the looking up step.

2. The method of claim 1, wherein, in said conditionally performing step, the existence of an indeterminate-value transaction is at least partially dependent on the results of the looking up step.

3. The method of claim 1, wherein, in said conditionally performing step, the offered terms of an indeterminate-value transaction are at least partially dependent on the results of the looking up step.

4. The method of claim 1, wherein, in said conditionally performing step, both the decision on whether to engage in an indeterminate-value transaction, and the terms offered to a particular buyer for the indeterminate-value transaction if any, are at least partially dependent on the results of the looking up step.

5. The method of claim 1, further comprising the additional step of adding information to the information base, after completion of an indeterminate-value transaction, based on the value exchanged by the buyer.

6. The method of claim 1, wherein said item is intangible.

7. The method of claim 1, further comprising the additional step of providing feedback to the information base, after completion of an indeterminate-value transaction, regarding the value exchanged by the buyer, and the fairness of the transaction.

8. The method of claim 1, wherein said indeterminate-value transactions normally involve the receipt of money.

9. The method of claim 1, wherein at least some of the items are physically perishable.

10. The method of claim 1, wherein at least some of the items lose most or all of their value if not used by a particular identifiable point in time.

11. The method of claim 1, wherein at least some of the items are media content.

12. The method of claim 1, wherein at least some of the items are information.

13. The method of claim 1, wherein at least some of the items are digital content with embedded identification.

14. The method of claim 1, wherein, if the value set to be exchanged by the buyer is more than prevailing standards, a warning to the buyer is automatically generated.

15. The method of claim 1, wherein at least some of the items are software.

16. The method of claim 1, wherein at least some of the items are an ongoing feed or series of information or content items.

17. A method for buying remotely through a distributed marketplace system, comprising:
reviewing items which are offered in exchange for value which is at least partly indeterminate;
under at least some circumstances, using a machine-assisted process to determine:
(1) what value a seller is expected to accept as satisfactory
(2) what value the buyer predicts to be an acceptable value exchange for the buyer
(3) any explanations the buyer expects to provide to justify any difference between (1) and (2); and
conditionally performing an indeterminate-value transaction with that prospective seller, in at least partial dependence on the results of the determining step, and in at least partial dependence on possible damage to the buyers reputation which can be expected from the difference between (2) and (1) in light of (3).

18. The method of claim 17, wherein, in said conditionally performing step, both the decision on whether to engage in an indeterminate-value transaction, and the agreed terms of an indeterminate-value transaction if any, are at least partially dependent on the results of the machine-assisted process.

19. The method of claim 17, further comprising the additional step of adding information to the information base, after completion of an indeterminate-value transaction, based on the value exchanged by the buyer in that transaction.

20-33. (canceled)

34. A method for buying through a distributed marketplace system, comprising:
reviewing items which are offered in exchange for value which is at least partly indeterminate;
under at least some circumstances, looking up the prospective seller of an item which is offered in exchange for indeterminate value, to see what assessments of the fairness of value set to be exchanged by buyers have been posted by that seller, as well as at least some buyers' inputs on the fairness of the assessments posted by that seller; and
conditionally performing an indeterminate-value transaction with that prospective seller, in at least partial dependence on the results of the looking up step, for at least one said item.

35-155. (canceled)
